(19) United States
(12) Patent Application Publication
(10) Pub. No.: US 2002/0199187 A1
(43) Pub. Date: Dec. 26, 2002

(54) Modular interactive application generation system

(75) Inventors: Yaron Gissin, Tel Aviv (IL); Erez Gissin, Ramat Hasharon (IL); Yuval Elgavish, Givataim (IL); Johnny Noam, Tel Aviv (IL)

Correspondence Address: DARBY & DARBY P.C., 805 Third Avenue, New York, NY, 10022, US

(73) Assignee: IP PLANET NETWORKS LTD.

(21) Appl. No.: 10/101,479

(22) Filed: Mar. 18, 2002

Related U.S. Application Data
(63) Continuation of application No. PCT/IL02/00144, filed on Feb. 25, 2002.
(60) Provisional application No. 60/272,512, filed on Feb. 26, 2001.

(51) Int. Cl. H04N 7/025; H04N 7/10; H04N 7/173

(52) U.S. Cl. 725/32; 725/93

(57) ABSTRACT

A system for generating interactive television programs including an interactive item scheduler operative to generate an interactive item schedule for incorporation into at least one television program, the interactive item schedule comprising a first plurality of interactive items each associated with a time-stamp, and an interactive television program integrator operative to incorporate the first plurality of interactive items into at least one television program in accordance with the schedule.

### REFERENCE TO COMPUTER PROGRAM LISTING APPENDIX

Computer program listing appendices are submitted herewith on four compact discs and four duplicate compact discs. The total number of compact discs including duplicates is eight. The files on the compact discs labeled 1 of 4 and 2 of 4 hereinafter referred to as Appendix A are software object code for carrying out a preferred embodiment of the invention. The files on the compact disc labeled 3 of 4 and 4 of 4 hereinafter referred to as Appendix B can be used to derive source code of a preferred software implementation of the present invention.

The names, dates of creation, directory locations, and sizes in bytes of the compact disc labeled “1 of 4” (CD-ROM No. 1) are:

Root Directory containing file 41655ob1.hex of Feb. 20, 2002 and of length 674,723,056 bytes.

The names, dates of creation, directory locations, and sizes in bytes of the compact disc labeled “2 of 4” (CD-ROM No. 2) are:

Root Directory containing file 41655ob2.hex of Feb. 20, 2002 and of length 349,193,152 bytes.

The names, dates of creation, directory locations, and sizes in bytes of the compact disc labeled “3 of 4” (CD-ROM No. 3) are:

Root Directory containing file 41655sr1.hex of Feb. 20, 2002 and of length 351,982,200 bytes.

Root Directory containing file 41655sr2.hex of Feb. 20, 2002 and of length 352,073,827 bytes.

The names, dates of creation, directory locations, and sizes in bytes of the compact disc labeled “4 of 4” (CD-ROM No. 4) are:

Root Directory containing file 41655sr3.hex of Feb. 20, 2002 and of length 352,119,670 bytes.

Root Directory containing file 41655sr4.hex of Feb. 20, 2002 and of length 351,936,357 bytes. The material on the compact discs is incorporated by reference herein.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

It is appreciated that the particular embodiment described in the Appendices is intended only to provide an extremely detailed disclosure of the present invention and is not intended to be limiting.

### FIELD OF THE INVENTION

The present invention relates to apparatus and methods for presenting interactive applications.

### BACKGROUND OF THE INVENTION

Conventional interactive application generation is described in the following U.S. Pat. Nos. 5,861,881; 6,215,484; 6,018,768; 5,861,881; 5,778,181; 5,774,664; 5,632,007; 5,585,858; 4,847,699; 5,537,141; 4,847,698; 5,682,196; 4,847,700; 4,918,516; RE34,340; 5,929,850; 5,682,196; 5,724,091; and 5,848,352.

The disclosures of all publications mentioned in the specification and of the publications cited therein are hereby incorporated by reference.

### SUMMARY OF THE INVENTION

The present invention seeks to provide a modular interactive application generation system.

There is thus provided in accordance with a preferred embodiment of the present invention a system for generating interactive television programs including an interactive item scheduler operative to generate an interactive item schedule for incorporation into at least one television program, the interactive item schedule including a first plurality of interactive items each associated with a time-stamp, and an interactive television program integrator operative to incorporate the first plurality of interactive items into at least one television program in accordance with the schedule.

Further in accordance with a preferred embodiment of the present invention, the interactive television program integrator is operative to receive, for each individual one of at least one television programs, an on-air signal indicating, in real-time, the time at which broadcast of the individual television program began.

Still further in accordance with a preferred embodiment of the present invention, the interactive television program integrator is also operative to receive, in advance of broadcast, from an external source, a playlist including a second plurality of television programs to be broadcast and to generate, off-line, an output instruction to a broadcasting facility describing how to incorporate the first plurality of interactive items into the second plurality of television programs in accordance with the schedule.

Additionally in accordance with a preferred embodiment of the present invention, the system also includes an interactive television GUI operative to generate a graphic display of the playlist and of a library of interactive items and to accept an editor-user's input associating an individual interactive item from the library with a temporal location on the playlist.

Still further in accordance with a preferred embodiment of the present invention, the graphic display also includes a video window which, responsive to a user's indication of a temporal location on the playlist, presents a portion of a program associated with the temporal location.

Additionally in accordance with a preferred embodiment of the present invention, the video window, responsive to an editor-user's input associating an individual interactive item from the library with a temporal location on the playlist, presents a portion of a program associated with the temporal location and, concurrently, the portion of the individual interactive item associated with the temporal location.

Further in accordance with a preferred embodiment of the present invention, the interactive television program integrator is operative to display the first plurality of interactive items concurrently with a corresponding first plurality of portions of at least one television program in accordance with the schedule.

Still further in accordance with a preferred embodiment of the present invention, the interactive television program integrator is operative to superimpose at least one of the first plurality of interactive items onto at least one of the corresponding first plurality of portions of at least one television program in accordance with the schedule.

Further in accordance with a preferred embodiment of the present invention, the interactive item scheduler includes an interactive item generator operative to generate at least one interactive item for inclusion in the interactive item schedule.

Additionally in accordance with a preferred embodiment of the present invention, the interactive item generator includes a library of empty interactive item templates and a template filling user interface operative to accept, from an editor-user, interactive content to fill an editor-user-selected one of the interactive item templates.

Further in accordance with a preferred embodiment of the present invention, the system includes a repository for filled interactive item templates thereby to enable an editor-user to fill templates off-line for real time incorporation into at least one television program.

Still further in accordance with a preferred embodiment of the present invention, at least one time-stamp for at least one individual interactive item includes an absolute time for broadcast of the individual interactive item.

Additionally in accordance with a preferred embodiment of the present invention, at least one time-stamp for at least one individual interactive item includes a time for broadcast of the individual interactive item, relative to an on-air signal to be received which will indicate the time at which broadcast of an individual television program began.

Also provided, in accordance with another preferred embodiment of the present invention, is a methodology for providing enhanced television type content to a plurality of disparate displays including providing television type content, enhancing the television type content in a display-independent manner to provide enhanced display-independent interactive television type content, and providing a plurality of display specific additions to said enhanced display-independent television type content.

Additionally in accordance with a preferred embodiment of the present invention, the methodology includes broadcasting the enhanced display-independent television type content with at least one display specific addition.

Additionally in accordance with a preferred embodiment of the present invention, the methodology also includes receiving and displaying, at a given one of the plurality of disparate displays, the enhanced display-independent television type content with at least one display specific addition.

Also provided, in accordance with a preferred embodiment of the present invention, is a system for authoring and broadcasting of interactive content, the system including creation of interactive content by non-programmers including at least one of the following editing functions: drag-and-drop function for incorporation of interactive content into a program schedule, wizard-based content creation for interactive content, and editing-level synchronization with broadcasting events including a synchronization information display for the non-programmer interactive content creator.

Additionally provided, in accordance with another preferred embodiment of the present invention, is an interactive content screen display apparatus including a first video area portion displaying a video broadcast, a second interactive portion displaying interactive content selected by a viewer, and a third pushed interrupt portion, which cannot be overridden by the viewer, displaying interrupting interactive content pushed by an interactive content provider, and wherein the second interactive portion cannot be overridden by the interactive content provider.

There is also provided, in accordance with another preferred embodiment of the present invention, a system for conveying interactive content to a plurality of user terminals having different characteristics, the system including a interactive content generator and a plurality of user-terminal specific compilers operative to compile interactive content generated by the interactive content generator so as to adapt the interactive content for use by a corresponding one of the user terminals, thereby to provide interactive content generated by the interactive content generator to all of the plurality of user terminals despite their different characteristics.

Further in accordance with a preferred embodiment of the present invention, the user terminals differ with respect to at least one of the following types of terminal characteristics: user terminal operating system characteristics, user terminal output characteristics, and user terminal input characteristics.

Still further in accordance with a preferred embodiment of the present invention, the interactive content generator includes a library of templates, each template being operative to prompt a content editor to fill the template with specific content, thereby to generate a template instance including an action.

Additionally in accordance with a preferred embodiment of the present invention, each template is operative to prompt the content editor to define a template instance trigger thereby to generate an assigned action.

There is also provided, in accordance with another preferred embodiment of the present invention, an interactive content generation system including an interactive content template repository storing a plurality of templates for interactive content items, and a template filling interface allowing a user to select, view and fill in a template from among the plurality of templates.

It is appreciated that the term “program” is used herein to refer both to entertainment programs (programs which viewers are inherently motivated to watch such as newsshows, sitcoms, quizzes, talkshows, ceremonies and sportscasts) and to commercial programs (“commercials” or programs paid for by external advertisers).

The term “television” or “televised programming” is used herein to refer to any broadcasted content intended for consumption by a remote population of users having receivers such as broadcasted video content for consumers having display screens (also termed herein viewsers) or such as broadcasted audio content for users having audio receivers.

The following terms are used to include the following meanings and can be but are not necessarily limited thereto:

Absolute Time: A time not related to any parameter.

Absolute triggers (time): The time of the trigger is related to the time line to a specific time regardless to any program ID.

Application Composer: A development environment that allows programmers to develop Interactive Application Templates that can then be embedded in the System BackEngine. The environment is XML based, uses IADL (see FIGS. 72-95) and features the Application Builder (See FIGS. 96 and 97)—a graphic tool for application construction.

Action: An interactive Application Template that an editor-user has filled with data and has not yet assigned a schedule. It is registered in the BackEngine as an action and is ready to be assigned to a time. A simplified graphic representation of an action is described in FIGS. 46-50.

Application Builder: A graphic software tool within the Application Composer environment, that utilizes IADL tags to allow computer programmers to construct Interactive Application Templates. It also provides the tools to automatically generate a population wizard. A simplified graphic representation can be found in FIGS. 96-97.

Application Loader: A system component that is generated in the DTV Packaging Subsystem (FIG. 13), and is responsible to load an interactive application. Can be referenced as “Notifier” or a graphic representation of a “call for action”.

BackEngine: A set of system components that serve as the foundation elements and the building blocks of the system. The BackEngine is best described in FIG. 4 and also features communication servers, internal management tools, and business logic.

Creative Brief: A document containing concept description, content specifications and requirements, as the initial step of the conceptualization of any interactive application towards implementation.

Current running Schedule Item ID: is embedded in the On-Air signal. The ID relates to a segment of a complete program (probably broken in time by commercials or other programming).

Data Carousel: A server-based software mechanism that broadcasts data to multiple recipients (usually Digital TV Set Top Box subscribers), without the need to employ an open communication line back from the client to the server

Designer: A graphic Designer that is responsible for the Look& Feel of an Interactive Application that runs on a given TV or PC screen.

DTV (Digital Television) Packaging Subsystem: A system component that utilizes the (evolving) Knowledgebase in order to convert and package a system application to a target platform code application before it is sent to the end users.

Editor-User: The person that uses the System Editor-GUI to manage and edit the content and make synchronization decisions on the playlist.

Fuser: A System component that is responsible for blending and integrating an Interactive Application (Created by Target Platform Code) or Interactive Template Application (Created by Application Composer in IADL)—to the System's BackEngine.

IADL: Interactive Application Definition Language: An XML based markup language that allows the construction of basic Interactive Applications, and tools to manage these applications.

Instance: (Also referred to as “Assigned Action”)An Interactive Application Template that an editor-user has filled with data and assigned a schedule. It is registered in the BackEngine as an instance and is waiting for its time signal in order to be sent.

Interactive Application: An application that allows end users (Viewsers) to interact, via PC or Digital TV with pre-defined activities.

Interactive Application Template: An application template that resides in the BackEngine database and is ready to be used by the editor-user with the Editor-GUI.

Interactive Application Template Files: XML/HTML or Platform target code and Media and Resource Files.

Interactive Message: In IP environment, the “call for action”—text based data that is embedded with the triggers in the video, and is displayed at the correct time to the eyes of the end user (Viewser).

Interactive scheduled Application: An instance that has been compiled, converted to the target platform code and sent to the Broadcasting Gateway. Interactive Scheduled Application Usually equals Application Loader+Interactive Application.

Media Highway: A middleware platform for interactive broadcasting produced by Canal+Technologies.

Middleware: Software that runs on a Set Top Box and is responsible for the communications of interactive applications, the Box and the Remote control. Also hosts the software and resources to run the Conditional Access system and the return channel in the set top box.

Notifier: In a DTV environment, the “call for action”—data that is embedded with the triggers in the video, and is displayed at the correct time to the eyes of the end user (Viewser). (e.g. Sky Active Red Button display for interactive).

On-Air signal: Indicates the actual start time of a program in real time.

On Air message: System formatted On-Air signal containing Time of arrival—Relative time; and the Current running program's ID.

OpenTV: A company and its related middleware technology platform that enables Interactive broadcasting to digital TV customers.

Playlist: A concurrent list of programs and programs segments usually generated by broadcasting scheduling systems Population Wizard: An interface that allows editor-users to incorporate new data, or update existing data in an interactive application template.

Programmer: A software developer.

Relative triggers (time): The time of the trigger is related to the start time of program ID in the time line.

Return channel (back path): A general term for communications from the Digital TV (SetTop Box) subscriber to the broadcasting operators systems (headend).

SetTop Box: A computing device installed at digital TV subscribers that enables the reception and presentation of digital video, audio and interactive applications on a TV screen. Usually interfaces with the household TV Remote Control.

Editor-GUI: A set of programs that present a usable man-machine interfaces to allow editors-users to manage, store and edit the data that runs through the system.

System Parameters: Pre-defined (could be changed) system parameters for various components in the system. Simple text file containing the name of the field and its value.

Target Platform Code: A development language related to a specific third-party broadcasting technology. (e.g. OpenTV, MediaHighway).

Thin Client: A wrapper application that is attached to an Interactive Scheduled Application that is sent to the Set Top Box.

Trigger ID: A unique number that relates to a specific action and all its related data.

TIM—Trigger Insertion Mechanism: A system Component that is responsible for the timed delivery of Scheduled interactive applications.

Trigger sliding window duration: the TIM Server collects future triggers according to this “window” of time.

Viewser: Viewer+User. End users using a TV or a PC device that are the recipients of the content generated by the system. A Viewser is a person that interacts with a given TV program.

Video Feed: A televised broadcasting signal containing video content.

### BRIEF DESCRIPTION OF THE DRAWINGS

The present invention will be understood and appreciated from the following detailed description, taken in conjunction with the drawings in which:

FIG. 1 is a simplified functional block diagram of a system for incorporating interactive applications into video programming, the interactive applications being adapted for display and interaction within a computer networked to the system, the system being constructed and operative in accordance with a first preferred embodiment of the present invention;

FIG. 2 is a simplified functional block diagram of a system for incorporating interactive applications into video programming, the interactive applications being adapted for display and interaction within a digital television set associated via a digital television network with the system, the system being constructed and operative in accordance with a first preferred embodiment of the present invention;

FIG. 3 is a simplified functional block diagram of a system for incorporating interactive applications into video programming, the interactive applications being adapted for display and interaction within one or more of the following: a computer networked to the system, and/or a digital television set associated via a digital television network with the system, the system being constructed and operative in accordance with a first preferred embodiment of the present invention;

FIG. 4 is a simplified functional block diagram of the BackEngine of FIGS. 1-3, constructed and operative in accordance with a preferred embodiment of the present invention;

FIG. 5 is a simplified functional block diagram of the application protocol interfaces block of FIGS. 1-3, constructed and operative in accordance with a preferred embodiment of the present invention;

FIG. 6 is a simplified functional block diagram of the application composer of FIGS. 1-3, constructed and operative in accordance with a preferred embodiment of the present invention;

FIG. 7 is a simplified functional block diagram of the IP broadcast gateway of FIGS. 1 and 3, constructed and operative in accordance with a preferred embodiment of the present invention;

FIG. 8 is a simplified functional block diagram of the DTV broadcast gateway of FIGS. 2 and 3, constructed and operative in accordance with a preferred embodiment of the present invention;

FIG. 9 is a simplified functional block diagram of the application fuser of FIGS. 1-3, constructed and operative in accordance with a preferred embodiment of the present invention;

FIG. 10 is a simplified functional block diagram of the interactive server of FIGS. 1-3, constructed and operative in accordance with a preferred embodiment of the present invention;

FIG. 11 is a simplified functional block diagram of the thin client of FIGS. 2-3, constructed and operative in accordance with a preferred embodiment of the present invention;

FIG. 12 is a simplified functional block diagram of the feedback system of FIGS. 1-3, constructed and operative in accordance with a preferred embodiment of the present invention;

FIG. 13 is a simplified functional block diagram of the DTV packager of FIG. 4, constructed and operative in accordance with a preferred embodiment of the present invention;

FIG. 14 is a simplified functional block diagram of the BackEngine database of FIG. 4, constructed and operative in accordance with a preferred embodiment of the present invention;

FIG. 15 is a simplified illustration of relationships between the tables of the source playlist of FIG. 14, constructed and operative in accordance with a preferred embodiment of the present invention;

FIG. 16 is a simplified illustration of relationships between the tables of the program categories block of FIG. 14, constructed and operative in accordance with a preferred embodiment of the present invention;

FIG. 17 is a simplified illustration of relationships between the tables of the personalization block of FIG. 14, constructed and operative in accordance with a preferred embodiment of the present invention;

FIG. 18 is a simplified illustration of relationships between the tables of the activities logs block of FIG. 14, constructed and operative in accordance with a preferred embodiment of the present invention;

FIG. 19 is a simplified illustration of relationships between the tables of the monitoring and control block of FIG. 14, constructed and operative in accordance with a preferred embodiment of the present invention;

FIG. 20 is a simplified illustration of relationships between the tables of the users table cluster of FIG. 14, constructed and operative in accordance with a preferred embodiment of the present invention;

FIG. 21 is a simplified illustration of relationships between the tables of the interactive message repository of FIG. 14, constructed and operative in accordance with a preferred embodiment of the present invention;

FIG. 22 is a simplified illustration of relationships between the tables of the application repository of FIG. 14, constructed and operative in accordance with a preferred embodiment of the present invention;

FIG. 23A is a diagram illustrating the data included in the program table of FIG. 15, in accordance with a preferred embodiment of the present invention;

FIG. 23B is a diagram illustrating the data included in the program category table of FIG. 15, in accordance with a preferred embodiment of the present invention;

FIG. 23C is a diagram illustrating the data included in the genre type table of FIG. 15, in accordance with a preferred embodiment of the present invention;

FIG. 23D is a diagram illustrating the data included in the program set table of FIG. 15, in accordance with a preferred embodiment of the present invention;

FIG. 23E is a diagram illustrating the data included in the schedule item table of FIG. 15, in accordance with a preferred embodiment of the present invention;

FIG. 23F is a diagram illustrating the data included in the schedule set table of FIG. 15, in accordance with a preferred embodiment of the present invention;

FIG. 23G is a diagram illustrating the data included in the channel table of FIG. 15, in accordance with a preferred embodiment of the present invention;

FIG. 23H is a diagram illustrating the data included in the channel type table of FIG. 15, in accordance with a preferred embodiment of the present invention;

FIG. 24A is a diagram illustrating the data included in the program categories binding table of FIG. 16, in accordance with a preferred embodiment of the present invention;

FIG. 24B is a diagram illustrating the data included in the subcategory definition (sub_category_def) table of FIG. 16, in accordance with a preferred embodiment of the present invention;

FIG. 24C is a diagram illustrating the data included in the program category definition table of FIG. 16, in accordance with a preferred embodiment of the present invention;

FIG. 25A is a diagram illustrating the data included in the viewsers table of FIG. 17, in accordance with a preferred embodiment of the present invention;

FIG. 25B is a diagram illustrating the data included in the occupation table of FIG. 17, in accordance with a preferred embodiment of the present invention;

FIG. 25C is a diagram illustrating the data included in the region table of FIG. 17, in accordance with a preferred embodiment of the present invention;

FIG. 25D is a diagram illustrating the data included in the age table of FIG. 17, in accordance with a preferred embodiment of the present invention;

FIG. 25E is a diagram illustrating the data included in the interest table of FIG. 17, in accordance with a preferred embodiment of the present invention;

FIG. 25F is a diagram illustrating the data included in the industry table of FIG. 17, in accordance with a preferred embodiment of the present invention;

FIG. 25G is a diagram illustrating the data included in the country table of FIG. 17, in accordance with a preferred embodiment of the present invention;

FIG. 25H is a diagram illustrating the data included in the comments-on-viewser table of FIG. 17, in accordance with a preferred embodiment of the present invention;

FIG. 25I is a diagram illustrating the data included in the pilot control center emails table of FIG. 17, in accordance with a preferred embodiment of the present invention;

FIG. 25J is a diagram illustrating the data included in the connection table of FIG. 17, in accordance with a preferred embodiment of the present invention;

FIG. 26A is a diagram illustrating the data included in the schedule items logs table of FIG. 18, in accordance with a preferred embodiment of the present invention;

FIG. 26B is a diagram illustrating the data included in the program log table of FIG. 18, in accordance with a preferred embodiment of the present invention;

FIG. 26C is a diagram illustrating the data included in the viewsers activities logs table of FIG. 18, in accordance with a preferred embodiment of the present invention;

FIG. 26D is a diagram illustrating the data included in the application result table of FIG. 18, in accordance with a preferred embodiment of the present invention;

FIG. 26E is a diagram illustrating the data included in the error table of FIG. 18, in accordance with a preferred embodiment of the present invention;

FIG. 27A is a diagram illustrating the data included in the system parameters table of FIG. 14, in accordance with a preferred embodiment of the present invention;

FIG. 27B is a diagram illustrating the data included in the module parameters table of FIG. 14, in accordance with a preferred embodiment of the present invention;

FIG. 28A is a diagram illustrating the data included in the trigger table of FIG. 14, in accordance with a preferred embodiment of the present invention;

FIG. 28B is a diagram illustrating the data included in the trigger template table of FIG. 14, in accordance with a preferred embodiment of the present invention;

FIG. 29A is a diagram illustrating the data included in the control center users table of FIG. 20, in accordance with a preferred embodiment of the present invention;

FIG. 29B is a diagram illustrating the data included in the system users table of FIG. 20, in accordance with a preferred embodiment of the present invention;

FIG. 29C is a diagram illustrating the data included in the permission level table of FIG. 20, in accordance with a preferred embodiment of the present invention;

FIG. 29D is a diagram illustrating the data included in the user password history table of FIG. 20, in accordance with a preferred embodiment of the present invention;

FIG. 30A is a diagram illustrating the data included in the interactive message template data table of FIG. 21, in accordance with a preferred embodiment of the present invention;

FIG. 30B is a diagram illustrating the data included in the interactive message type table of FIG. 21, in accordance with a preferred embodiment of the present invention;

FIG. 30C is a diagram illustrating the data included in the interactive message template table of FIG. 21, in accordance with a preferred embodiment of the present invention;

FIG. 30D is a diagram illustrating the data included in the interactive message instance data table of FIG. 21, in accordance with a preferred embodiment of the present invention;

FIG. 30E is a diagram illustrating the data included in the interactive message instance data table of FIG. 21, in accordance with a preferred embodiment of the present invention;

FIG. 31A is a diagram illustrating the data included in the application template table of FIG. 22, in accordance with a preferred embodiment of the present invention;

FIG. 31B is a diagram illustrating the data included in the application template data table of FIG. 22, in accordance with a preferred embodiment of the present invention;

FIG. 31C is a diagram illustrating the data included in the application type table of FIG. 22, in accordance with a preferred embodiment of the present invention;

FIG. 31D is a diagram illustrating the data included in the application instance table of FIG. 22, in accordance with a preferred embodiment of the present invention;

FIG. 31E is a diagram illustrating the data included in the application instance data table of FIG. 22, in accordance with a preferred embodiment of the present invention;

FIG. 31F is a diagram illustrating the data included in the graphic skin table of FIG. 22, in accordance with a preferred embodiment of the present invention;

FIG. 32 is a diagram illustrating the data included in the eplaylist table of FIG. 14, in accordance with a preferred embodiment of the present invention;

FIG. 33 is a simplified illustration of relationships between the tables of the knowledgebase of FIG. 4, constructed and operative in accordance with a preferred embodiment of the present invention;

FIGS. 34A-34B, taken together, form a table summarizing the input parameters, output parameters and preferred mode of operation for wizard processing procedures useful in manipulating wizard data within the BackEngine database of FIGS. 4 and 14;

FIGS. 35A-35B, taken together, form a table summarizing the input parameters, output parameters and preferred mode of operation for trigger processing procedures useful in manipulating trigger data within the BackEngine database of FIGS. 4 and 14;

FIG. 36 is a table summarizing the input parameters, output parameters and preferred mode of operation for repository maintenance procedures useful in manipulating repository data within the BackEngine database of FIGS. 4 and 14;

FIG. 37 is a table summarizing the input parameters, output parameters and preferred mode of operation for playlist processing procedures useful in manipulating playlist data within the BackEngine database of FIGS. 4 and 14;

FIG. 38 is a table summarizing the input parameters, output parameters and preferred mode of operation for digital television trigger insertion procedures useful in manipulating data within the BackEngine database of FIGS. 4 and 14 in accordance with the embodiments of FIGS. 2 and 3;

FIG. 39 is a table summarizing the input parameters, output parameters and preferred mode of operation for packager procedures performed by the DTV packager of FIGS. 4 and 12;

FIG. 40 is a table summarizing the input parameters, output parameters and preferred mode of operation for viewser log procedures useful in manipulating data within the backengine database of FIGS. 4 and 14;

FIG. 41 is a table summarizing the input parameters, output parameters and preferred mode of operation for fusing procedures performed by the fuser of FIGS. 4 and 9;

FIG. 42 is a table summarizing the input parameters, output parameters and preferred mode of operation for interactive serving procedures performed by the interactive server of FIGS. 4 and 10;

FIG. 43 is a table summarizing the input parameters, output parameters and preferred mode of operation for computer network trigger insertion procedures useful in manipulating data within the BackEngine database of FIGS. 4 and 14 in accordance with the embodiments of FIGS. 1 and 3;

FIG. 44 is a table summarizing the input parameters, output parameters and preferred mode of operation for procedures useful in manipulating application instance data within the application repository of FIG. 22;

FIGS. 45A-45B, taken together, form a table summarizing the input parameters, output parameters and preferred mode of operation for application protocol interfacing procedures useful in manipulating data within the backengine database of FIGS. 4 and 14;

FIG. 46 is a simplified pictorial illustration of a first screen display generated by the editor GUI (graphic user interface) of FIG. 4 when performing an example workflow;

FIG. 47 is a simplified pictorial illustration of a second screen display generated by the editor GUI (graphic user interface) of FIG. 4 when performing an example workflow;

FIG. 48 is a simplified pictorial illustration of a third screen display generated by the editor GUI (graphic user interface) of FIG. 4 when performing an example workflow;

FIG. 49 is a simplified pictorial illustration of a fourth screen display generated by the editor GUI (graphic user interface) of FIG. 4 when performing an example workflow;

FIG. 50 is a simplified pictorial illustration of a fifth screen display generated by the editor GUI (graphic user interface) of FIG. 4 when performing an example workflow;

FIG. 51 is a simplified flowchart illustration of a preferred method of operation for the system of FIG. 1.

FIG. 52 is a simplified flowchart illustration of a preferred method of operation for the system of FIG. 2.

FIGS. 53A-53B, taken together, form a simplified flowchart illustration of a preferred method of operation for the BackEngine of FIGS. 1, 2 and 4;

FIG. 54 is a diagram showing a typical life-cycle of a modular interactive application in accordance with a preferred embodiment of the present invention;

FIG. 55 is a simplified flowchart illustration of a preferred method by which application composer 170 of FIGS. 1 and 6 performs the interactive application file generation step 1010 of FIG. 51;

FIG. 56 is a simplified flowchart illustration of a preferred method by which fuser 110 of FIGS. 1 and 9 performs the interactive application template generation step 1030 of FIG. 51;

FIGS. 57A-57B, taken together, form an example of a main.XML file that describes the syntax of any interactive application file generated by the application composer 170;

FIG. 58 is a simplified flowchart illustration of a preferred method whereby the editor GUI 280 in BackEngine 100 of FIGS. 1 and 4 perform a first part of the interactive scheduled application generation step 1040 of FIG. 51, corresponding to content injection step 1190 in FIG. 53A;

FIG. 59 is a simplified flowchart illustration of a preferred method whereby the editor GUI 280 in BackEngine 100 of FIGS. 1 and 4 perform a second part of the interactive scheduled application generation step 1040 of FIG. 51, corresponding to assignment to timeline step 1210 in FIG. 53A;

FIG. 60 is a simplified flowchart illustration of a preferred method whereby the BackEngine of FIGS. 1 and 4 performs the interactive scheduled application step 1044 of FIG. 51;

FIG. 61 is a simplified flowchart illustration of a preferred method whereby the BackEngine 100 of FIGS. 1 and 4 performs the on-air signal receiving step 1046 of FIG. 51;

FIG. 62 is a simplified flowchart illustration of a preferred method whereby the IP broadcast gateway 201 of FIGS. 1 and 7 performs the interactive scheduled application broadcasting step 1050 of FIG. 51;

FIG. 63 is a simplified flowchart illustration of a preferred method whereby the viewser uses his PC to generate a viewser response which is subsequently processed by the system of the present invention in steps 1060 and 1070 of FIG. 51;

FIG. 64 is a simplified flowchart illustration of a preferred method whereby the BackEngine 100 of FIGS. 1 and 4 performs the viewser response processing step 1070 of FIG. 51;

FIG. 65 is a simplified flowchart illustration of a preferred method whereby the feedback system 160 of FIGS. 1 and 12 performs the viewser response statistics reporting step 1080 of FIG. 51;

FIG. 66A is a simplified flowchart illustration of a preferred method whereby the BackEngine of FIGS. 2 and 4 performs the interactive scheduled application sending step 1124 of FIG. 52;

FIGS. 66B-66C, taken together, form a simplified flowchart illustration of a preferred method whereby the DTV packaging subsystem 270 of FIGS. 4 and 13 performs the DTV packaging step in the method of FIG. 66A, thereby to generate a packaged instance;

FIG. 66D is a simplified flowchart illustration of a preferred method of operation for the IADL transformer 680 of FIG. 13;

FIG. 67 is a simplified flowchart illustration of a preferred method whereby the DTV broadcast gateway 200 of FIGS. 2 and 8 performs the interactive scheduled application broadcasting step 1130 of FIG. 51;

FIG. 68 is a simplified flowchart illustration of a preferred method whereby the DTV broadcast gateway 200 of FIGS. 2 and 8 performs the viewser response receiving step 1140 of FIG. 52;

FIG. 69 is a simplified flowchart illustration of a preferred method whereby the viewser uses interactive application digital TV interface software typically residing within his set-top box according to a preferred embodiment of the present invention, to generate a viewser response which is subsequently processed by the system of the present invention in steps 1140 and 1150 of FIG. 52;

FIG. 70 is a simplified flowchart illustration of a preferred method whereby the sync driver 220 of FIG. 4 performs the playlist processing step of FIG. 53A whereby the playlist is prepared for display by GUI 280 of FIG. 4;

FIGS. 71A-71B, taken together, form a simplified flowchart illustration of a preferred method whereby the trigger insertion mechanism server 210 of FIG. 4 performs the interactive scheduled application generation step of FIG. 53B;

FIG. 72A is a table describing two IADL application-level commands having a common syntax;

FIG. 72B is a syntax diagram describing the syntax of each of the commands in FIG. 72A;

FIG. 73A is a table describing four IADL stage-level commands having a common syntax;

FIG. 73B is a syntax diagram describing the syntax of each of the commands in FIG. 73A;

qc FIGS. 74A, 75A, 76A, 77A, 78A, 78A, 79A, 80A, 81A, 82A, 83A, 84A, 85A and 86A are tables, each row of which describes an element-level IADL command wherein the commands in each such table have a common syntax;

FIGS. 74B, 75B, 76B, 77B, 78B, 78B, 79B, 80B, 81B, 82B, 83B, 84B, 85B and 86B describe the syntaxes of the commands of FIGS. 74A, 75A, 76A, 77A, 78A, 78A, 79A, 80A, 81A, 82A, 83A, 84A, 85A and 86A respectively; and

FIGS. 87A, 88A, 89A, 90A, 91A, 92A, 93A, 94A and 95A are tables, each row of which describes an atom-level IADL command wherein the commands in each such table have a common syntax;

FIGS. 87B, 88B, 89B, 90B, 91B, 92B, 93B, 94B and 95B describe the syntaxes of the commands of FIGS. 87A, 88A, 89A, 90A, 91A, 92A, 93A, 94A and 95A respectively;

FIG. 96 is a simplified pictorial illustration of a first screen display generated by the Application Builder 320 and its GUI 330 (FIG. 6) when performing an example workflow as described in FIG. 55. The Application Builder is a preferred tool for the creation of Interactive Application templates; and

FIGS. 97A-97F are simplified pictorial illustrations of the stage(skeleton), project browser, elements inspector, saved elements, functions and atoms library windows, respectively, in the screen display of FIG. 96.

CD-ROM Appendix A represents software object code for carrying out a preferred embodiment of the invention; and

CD-ROM Appendix B can be used to derive software code of a preferred software embodiment of the present invention.

### DETAILED DESCRIPTION OF PREFERRED EMBODIMENTS

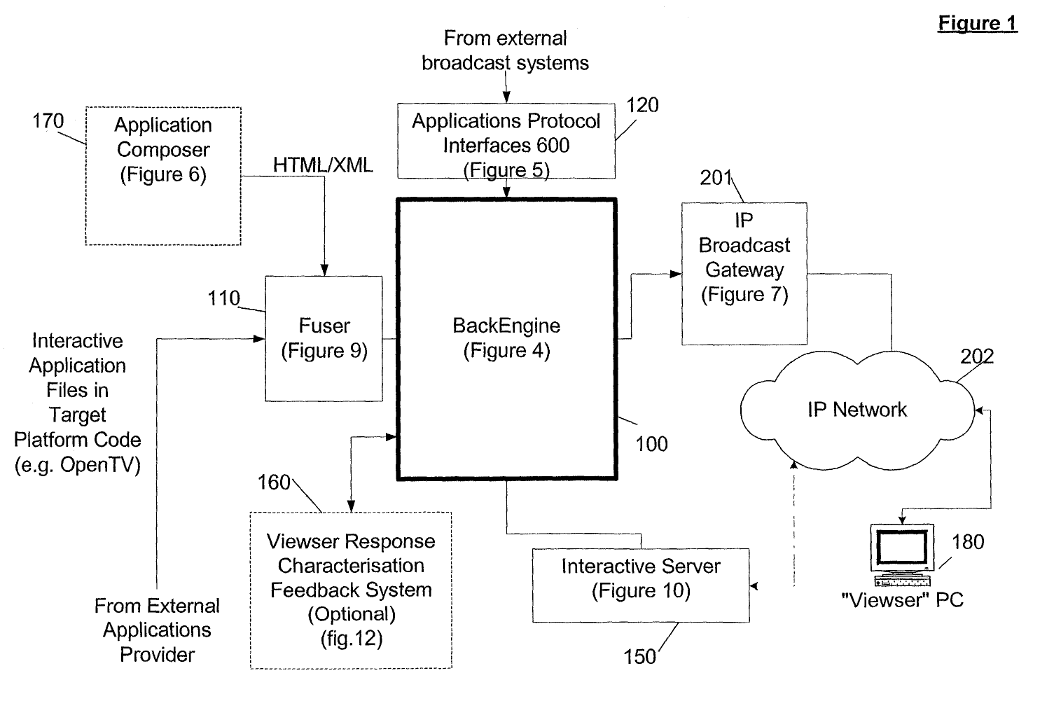

FIG. 1 is a simplified functional block diagram of a system for incorporating interactive applications into video programming, the interactive applications being adapted for display and interaction within a computer networked to the system, the system being constructed and operative in accordance with a first preferred embodiment of the present invention. A particular feature of a preferred embodiment of the present invention is that the content generation interface is simple enough such that content generation may be performed by human operators with little or no programming experience.

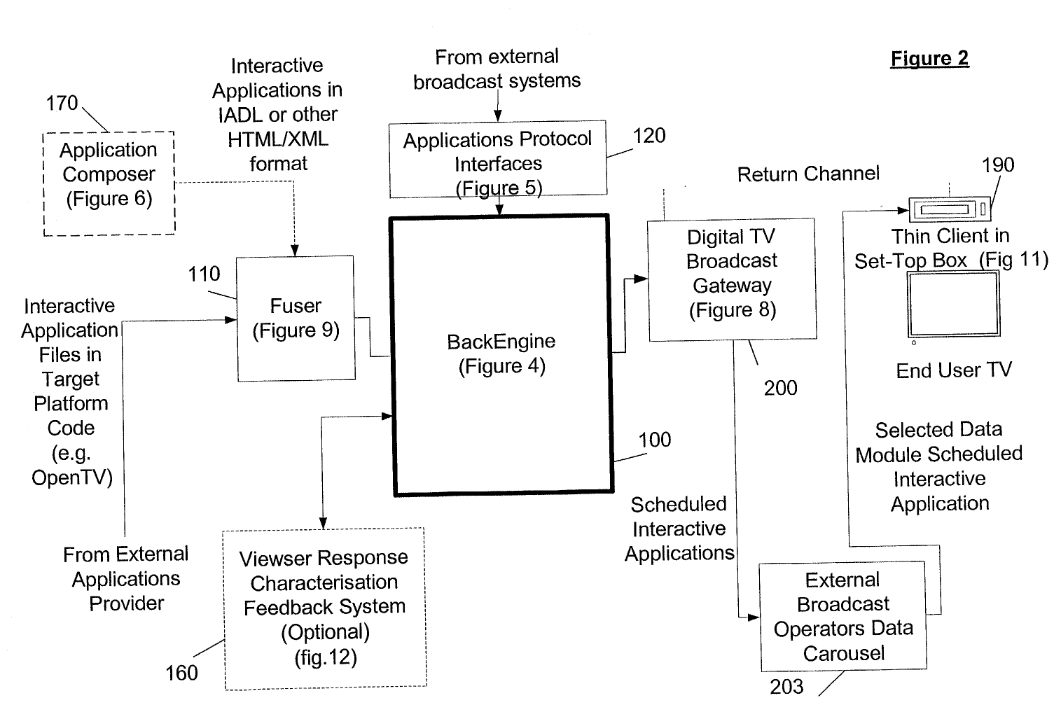

FIG. 2 is a simplified functional block diagram of a system for incorporating interactive applications into video programming, the interactive applications being adapted for display and interaction within a digital television set associated via a digital television network with the system, the system being constructed and operative in accordance with a first preferred embodiment of the present invention.

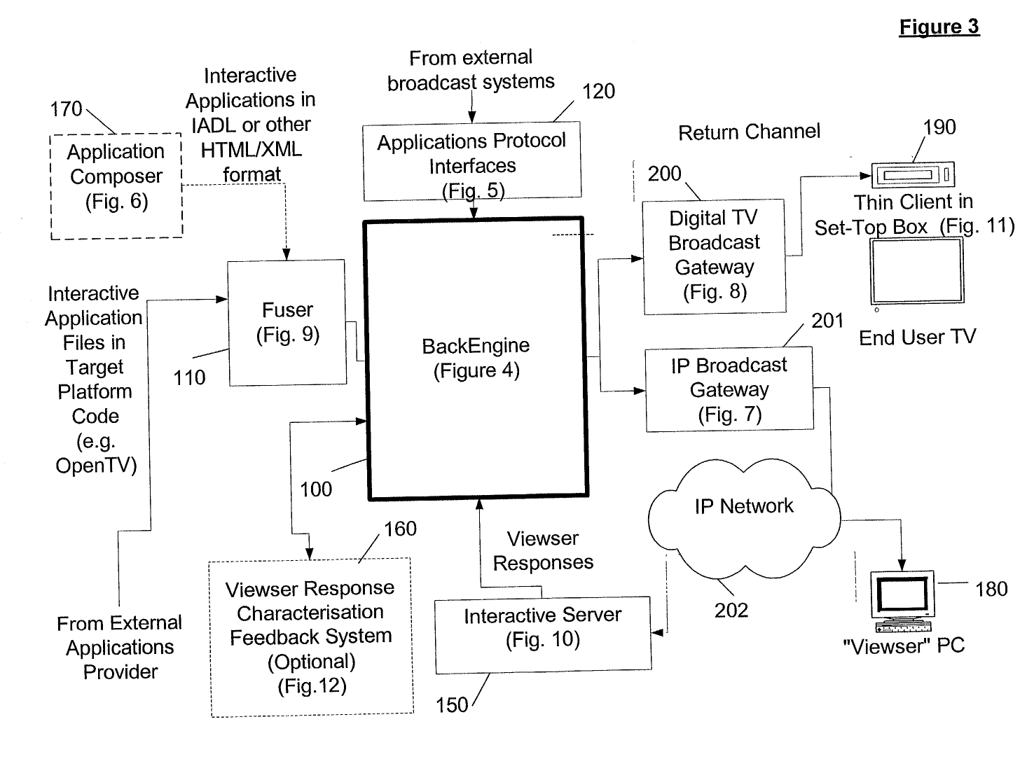

FIG. 3 is a simplified functional block diagram of a system for incorporating interactive applications into video programming, the interactive applications being adapted for display and interaction within one or more of the following: a computer networked to the system, and/or a digital television set associated via a digital television network with the system, the system being constructed and operative in accordance with a first preferred embodiment of the present invention.

As shown, the system of FIG. 3 is typically operative in conjunction with conventional home viewer equipment including a PC and a television device having a digital TV decoder also termed herein a “set-top box”.

An array of broadcast gateways 200 and 201 typically comprises a broadcast gateway for each of a plurality of interactive content display devices such as one or more television set-top-boxes each running a different operating system, and/or one or more computer devices each having its own computer display format.

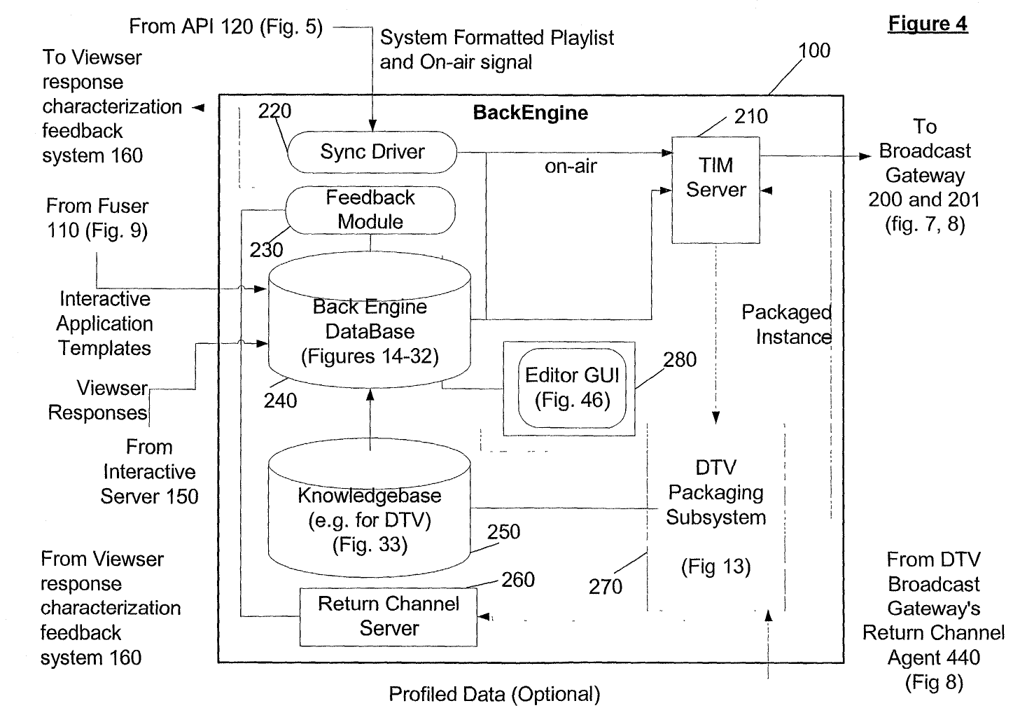

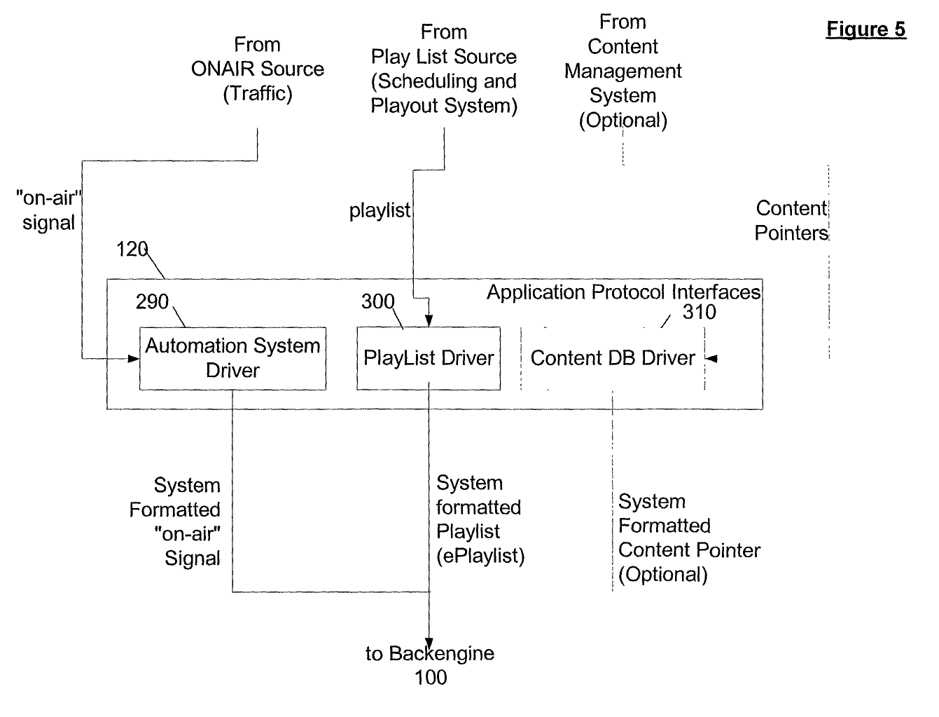

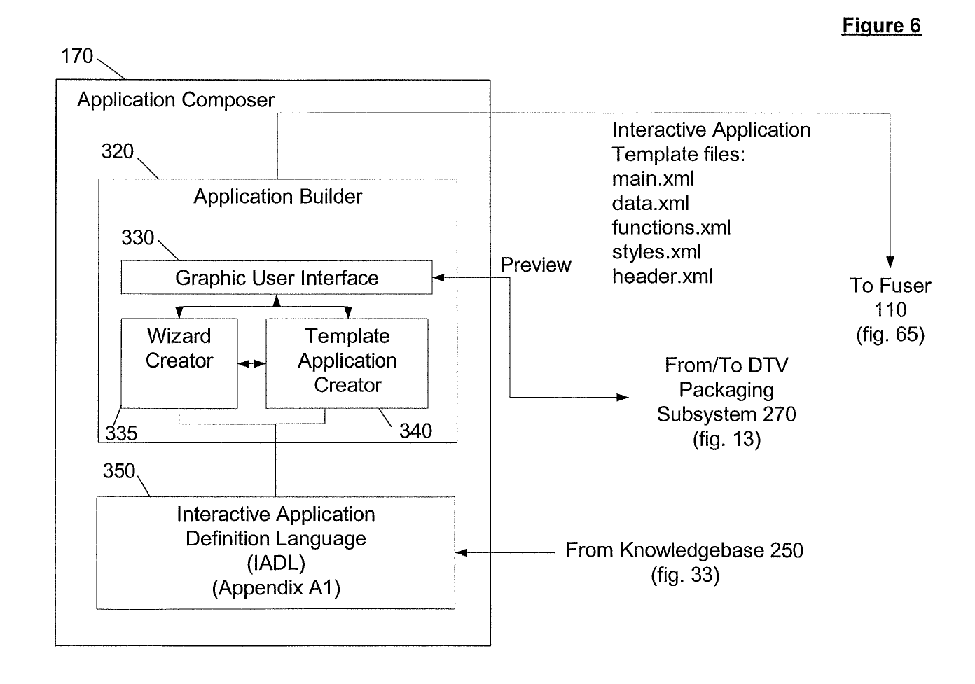

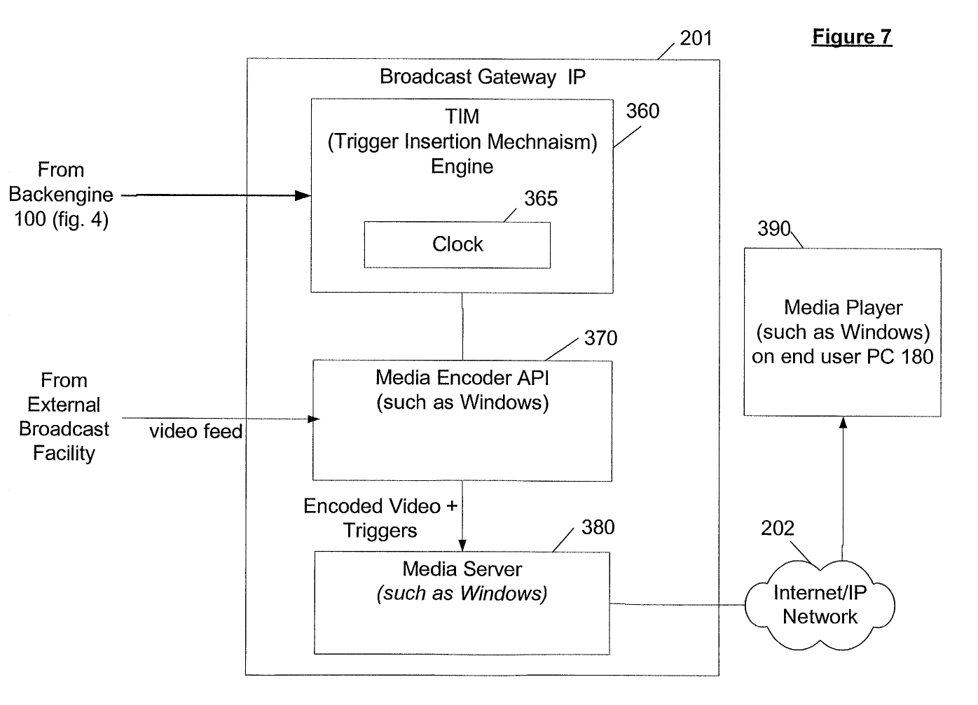

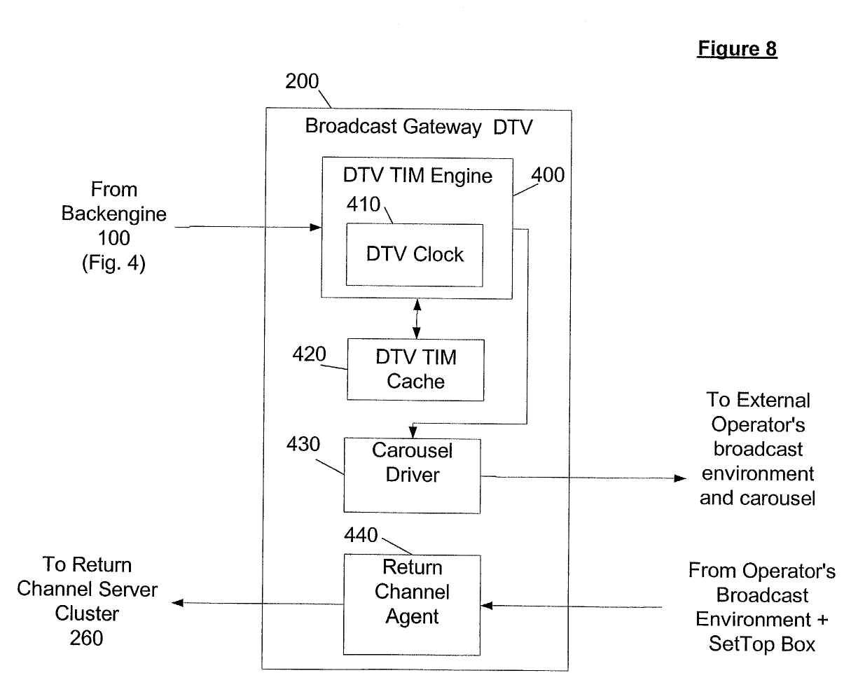

FIG. 4 is a simplified functional block diagram of the BackEngine of FIGS. 1-3, constructed and operative in accordance with a preferred embodiment of the present invention. It is appreciated that the interactive editor-GUI 280 is operative to perform an interactive content generation function and an interactive content incorporation function in which interactive content, once generated, is incorporated into an existing video schedule.

It is appreciated that generally, broadcasting queries to viewsers is less resource-consuming than receiving responses to the queries and processing them. Therefore, according to another preferred embodiment of the present invention, quizzes in which a prize is awarded to the earliest-generated correct response may be presented and the set-top boxes of the viewsers may be operative to store responses and the time at which they were generated using an internal set-top-box clock, synchronized across the population of set-top-boxes, and not send them, pending further instructions. Further instructions may comprise one or more of the following which typically are sent in order:

a. A message indicating that any set-top box storing an answer other than X, which is the correct answer, should destroy the answer and not send it in.

b. A message, typically sent only to a subset of the set-top boxes, indicating that set-top boxes which are storing an X-answer should send in their time of response. The system then typically identifies the earliest time of response.

c. A message, sent either to all set-top boxes or only to a subset thereof, indicating that set-top boxes which are storing an X-answer and a time earlier than the earliest time of response identified in (b), should send in their time of response. The system then typically, as in step (b), identifies the earliest time of response.

d. Step (c) is repeated until, responsive to a message sent to all set-top boxes, no set-top box responds, indicating that the earliest time of response identified by the system in the previous iteration, is the earliest time at which the correct answer was generated.

A particular advantage of a preferred embodiment of the present invention in which templates are used which have features identifiable by the viewser, is that the viewser learns to recognize the various templates and orient himself in the content universe. When the user encounters a template he has seen before, it is easier for the user to assimilate the new information since it is being presented in a familiar format.

A TIM (trigger insertion mechanism) Server 210 synchronizes interactive applications, typically at the sub-program level, to the video. For example, an input to the TIM Server 210 may indicate that an item of interactive content should be incorporated 3 minutes into a program which started 2 minutes ago (according to the on-air signal received from the SyncDriver 220). Therefore, in one minute, the TIM server 210 will generate a command to one or more of the broadcast gateways 200 and/or 201 that the item of interactive content should be introduced.

FIG. 5 is a simplified functional block diagram of the application protocol interfaces block of FIGS. 1-3, constructed and operative in accordance with a preferred embodiment of the present invention.

FIG. 6 is a simplified functional block diagram of the application composer of FIGS. 1-3, constructed and operative in accordance with a preferred embodiment of the present invention.

According to a preferred embodiment of the present invention, templates have a life-cycle typically including the following three stages of life:

a. blank; Also termed as “Interactive Application Template”

b. filled-in, also termed herein “Action”

c. assigned, also termed herein “Instance”

Examples of Interactive Application Templates include the following:

a. A buying template in which a viewser is asked to purchase a product;

b. A product information template in which product information is displayed to a viewser;

c. A survey template in which viewsers are invited to take part in a survey, typically by manually or orally keying in a response to one or more multiple choice questions;

d. A “did you know” template in which viewsers are invited to be exposed to additional information about a topic of presumed interest;

e. A “breaking news” template which displays breaking news;

f. An “internal html page” template, intended for viewsers using a PC screen rather than a television screen, in which an html page pops up interactively within a video program;

g. An “external html page”

h. A “trivia” template which invites a user to participate in a trivia quiz;

i. A “survey results” template, which displays results of a survey, typically an interactive survey which may have been presented using the above-described “survey” template;

j. A “decision simulation” template, prompting the viewser to put himself in the place of a newsmaker and determine what he would decide if he were in the newsmaker's position;

k. A “now showing” template inviting the viewser to view information about a current program;

l. A “promotion” template inviting the viewser to view information about a future program;

m. A “where you can find me” template inviting the viewser to enter particulars regarding his location and to receive in return the location of an outlet in which an advertised product is being sold;

n. A “show merchandise” template inviting the user to receive information regarding products pertinent to the program currently on air.

FIG. 7 is a simplified functional block diagram of the IP broadcast gateway of FIGS. 1 and 3, constructed and operative in accordance with a preferred embodiment of the present invention.

FIG. 8 is a simplified functional block diagram of the DTV broadcast gateway of FIGS. 2 and 3, constructed and operative in accordance with a preferred embodiment of the present invention.

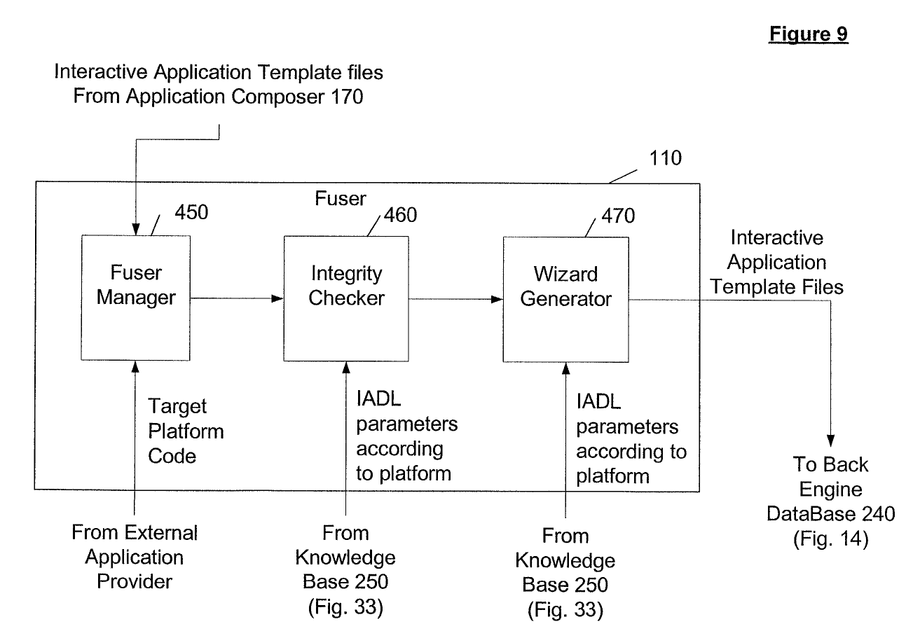

FIG. 9 is a simplified functional block diagram of the application fuser of FIGS. 1-3, constructed and operative in accordance with a preferred embodiment of the present invention.

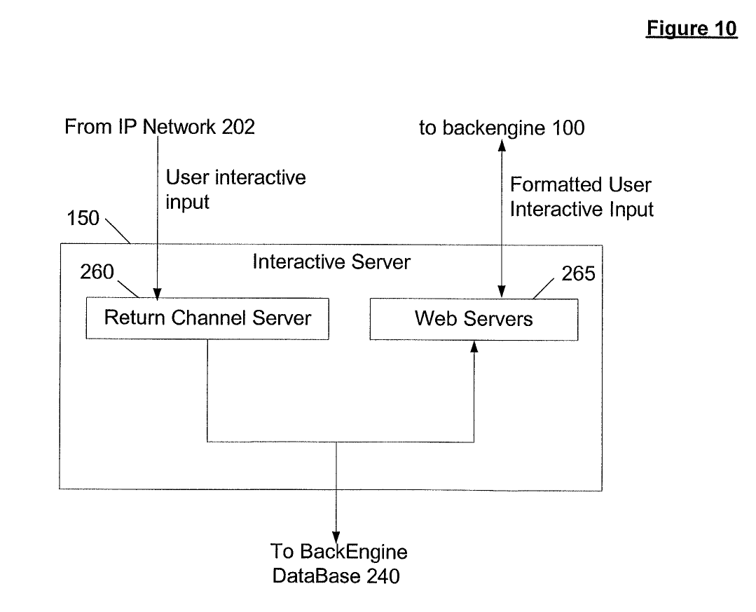

FIG. 10 is a simplified functional block diagram of the interactive server of FIGS. 1-3, constructed and operative in accordance with a preferred embodiment of the present invention.

FIG. 11 is a simplified functional block diagram of the thin client of FIGS. 2-3, constructed and operative in accordance with a preferred embodiment of the present invention.

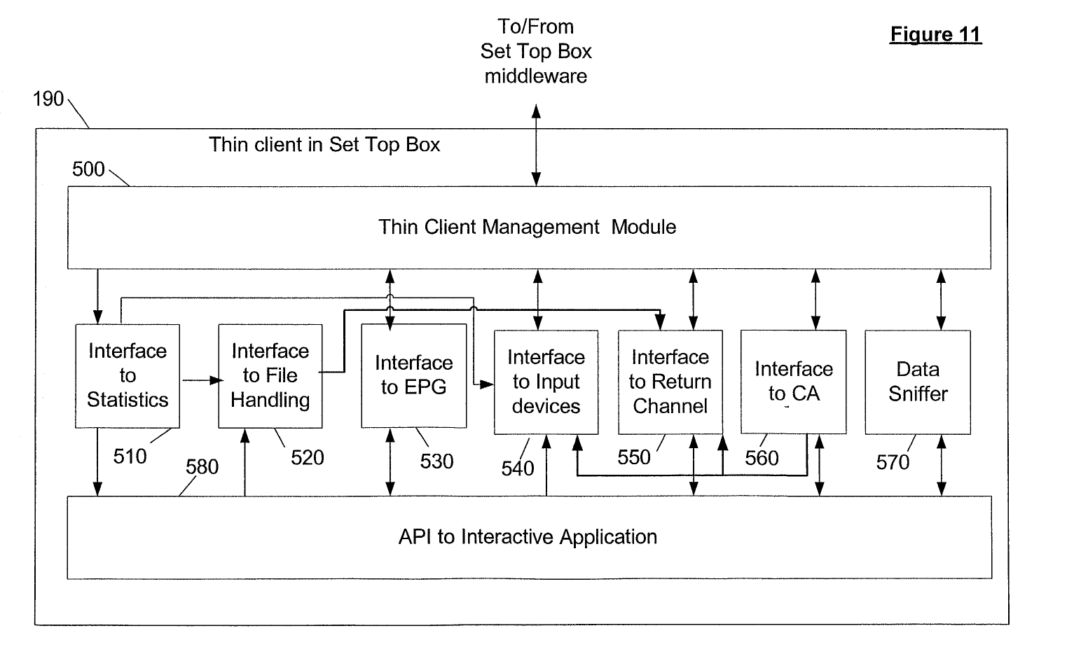

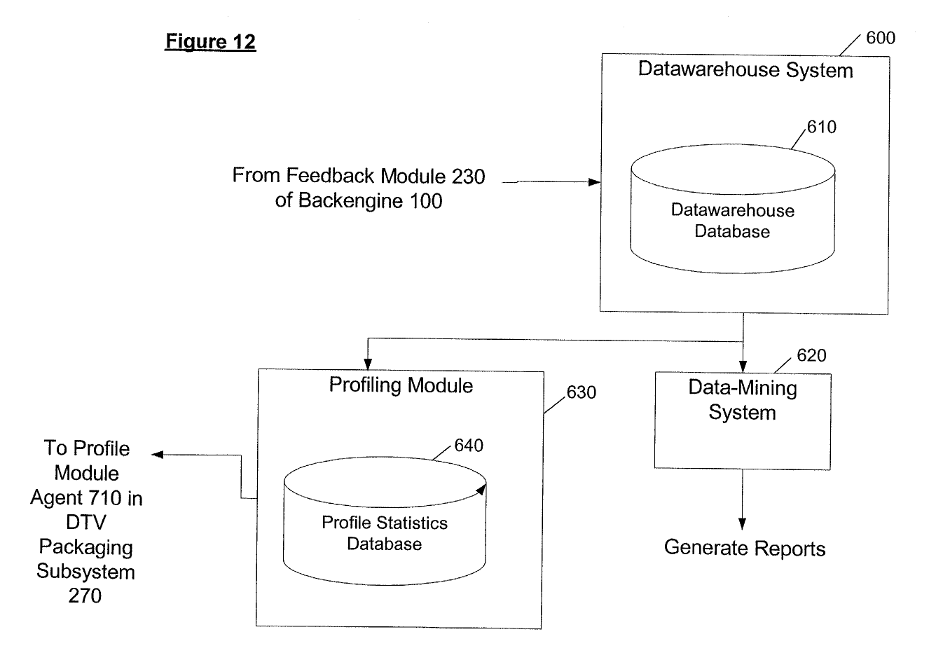

FIG. 12 is a simplified functional block diagram of the feedback system of FIGS. 1-3, constructed and operative in accordance with a preferred embodiment of the present invention.

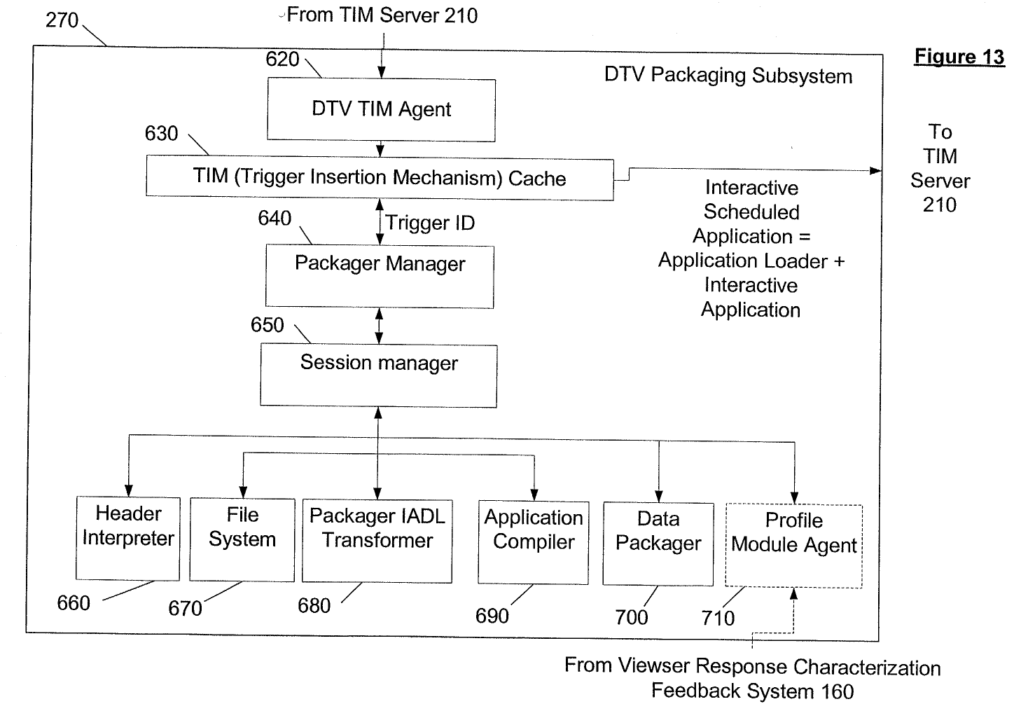

FIG. 13 is a simplified functional block diagram of the DTV packager of FIG. 4, constructed and operative in accordance with a preferred embodiment of the present invention.

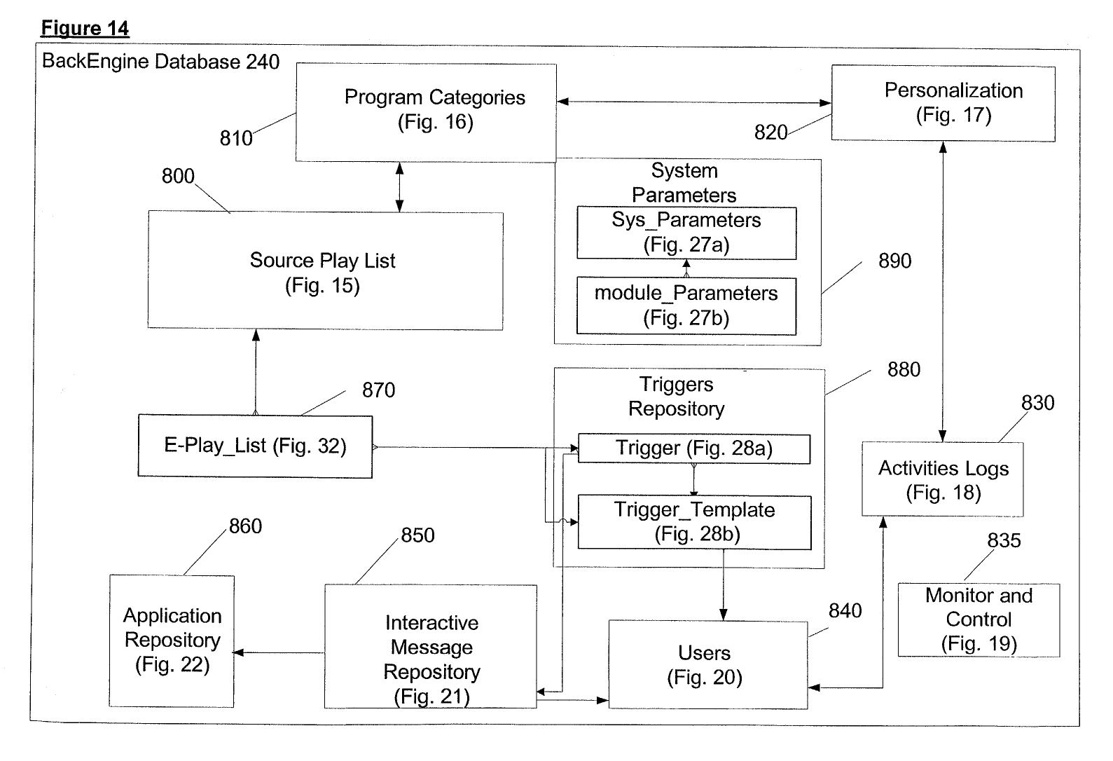

FIG. 14 is a simplified functional block diagram of the BackEngine database of FIG. 4, constructed and operative in accordance with a preferred embodiment of the present invention.

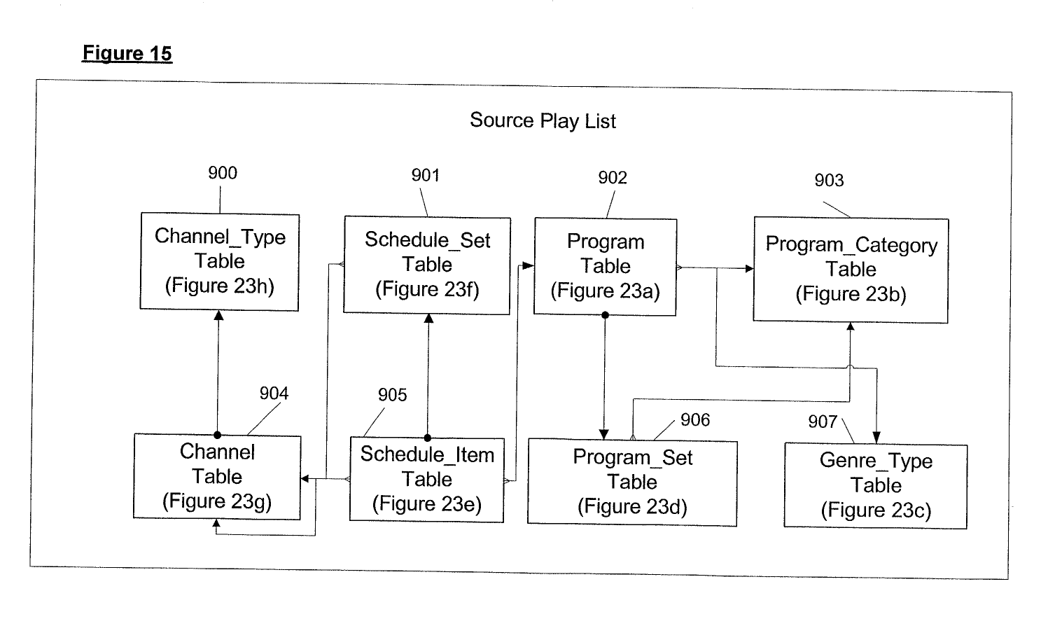

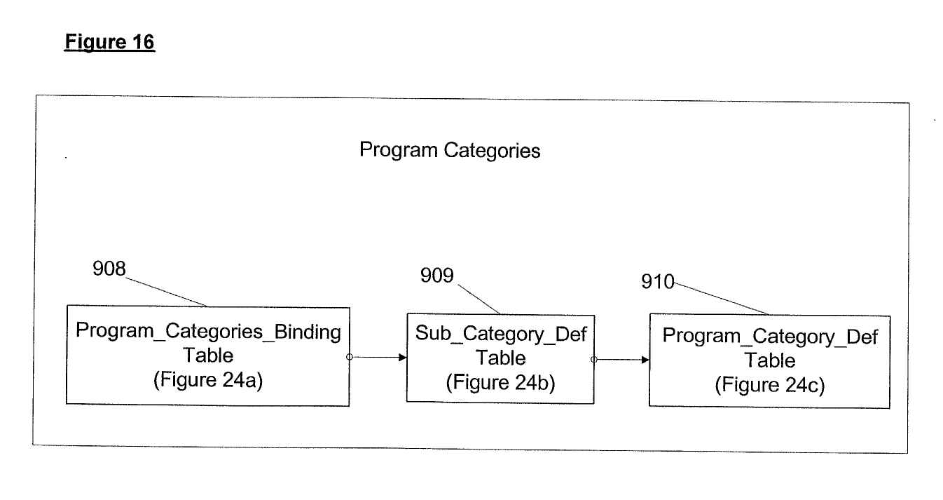

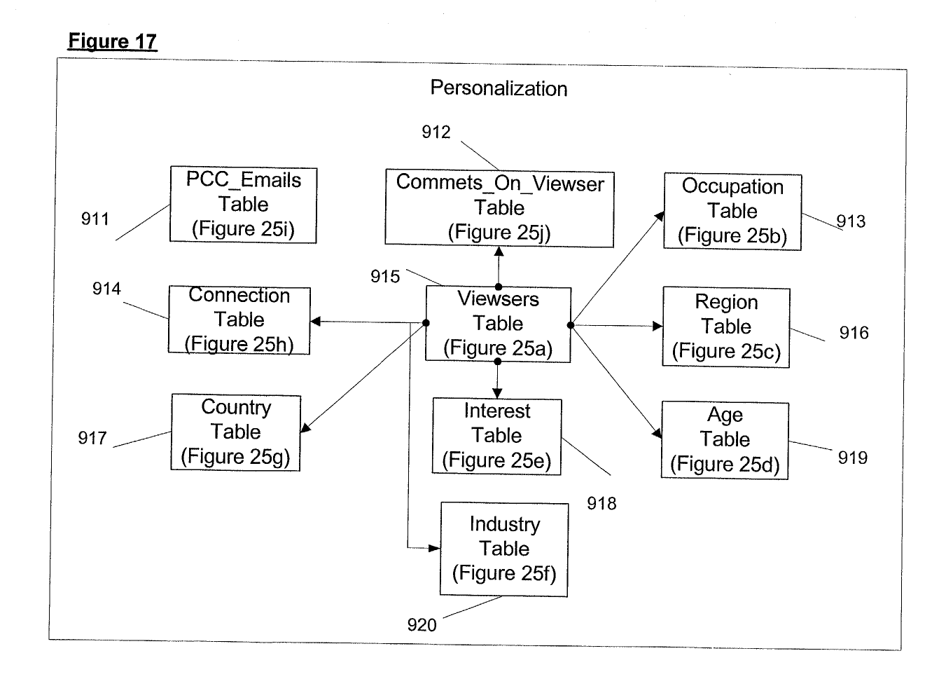

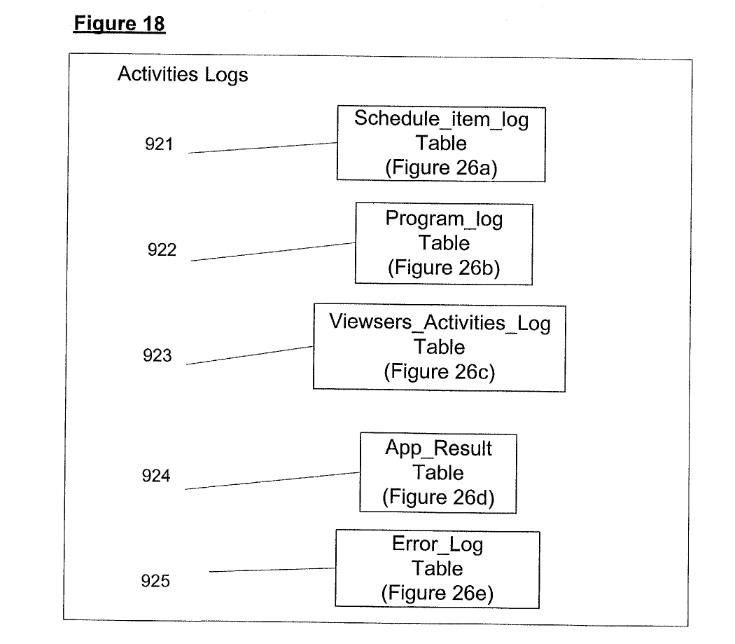

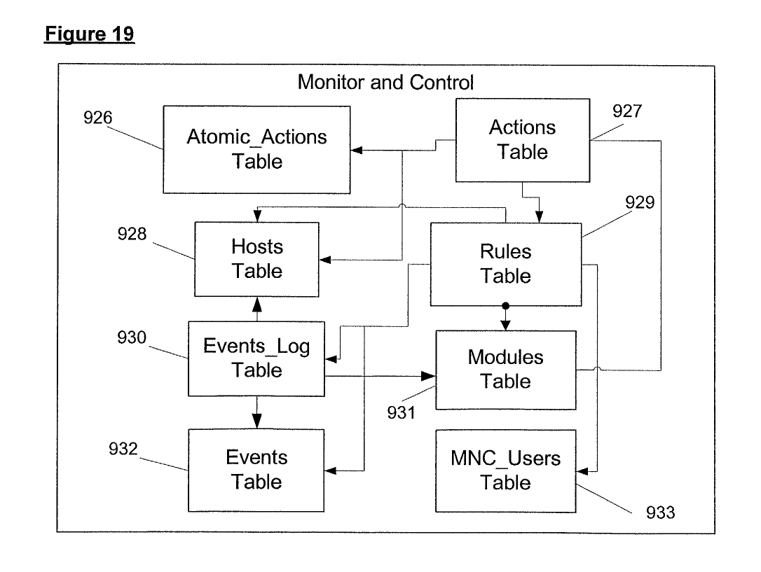

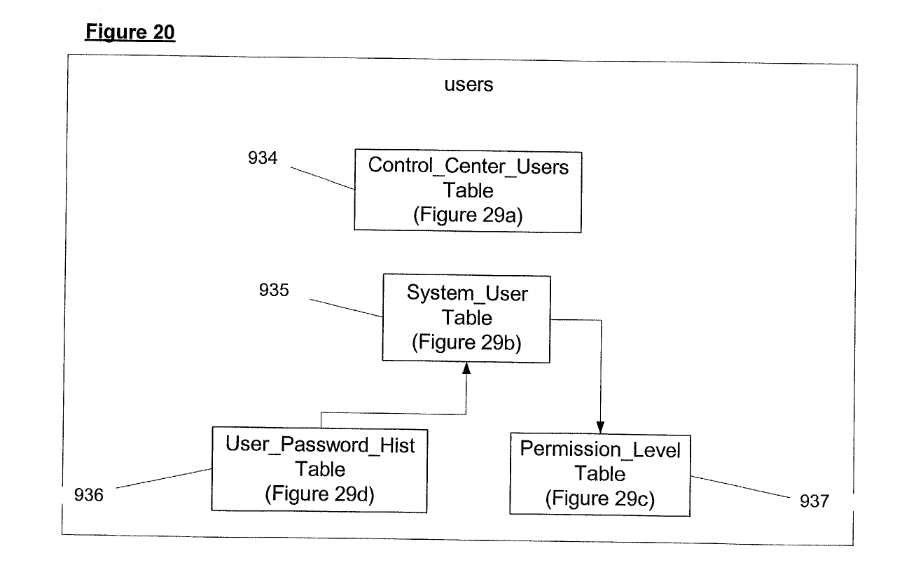

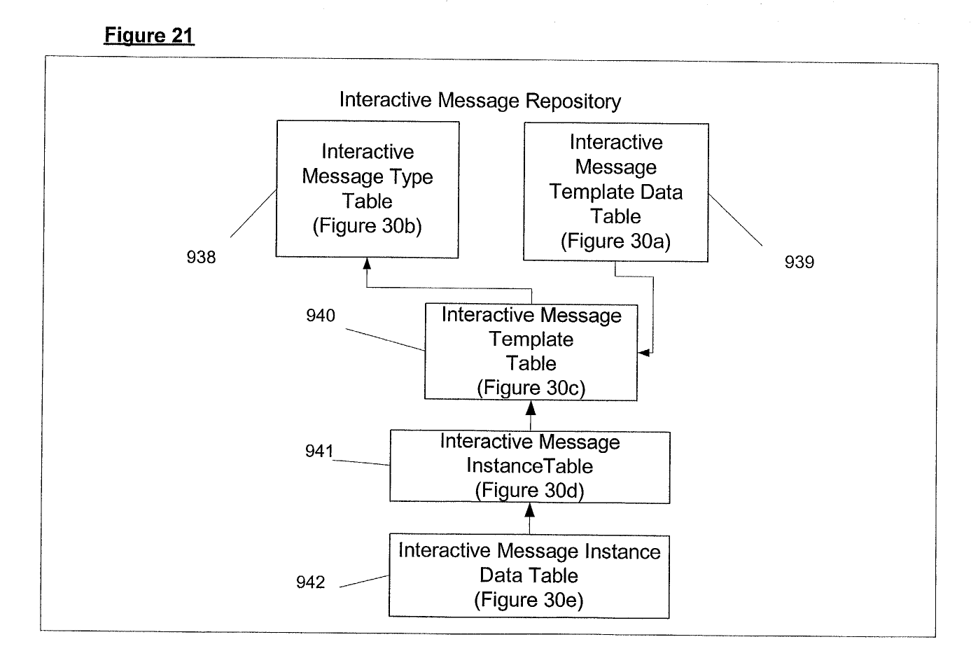

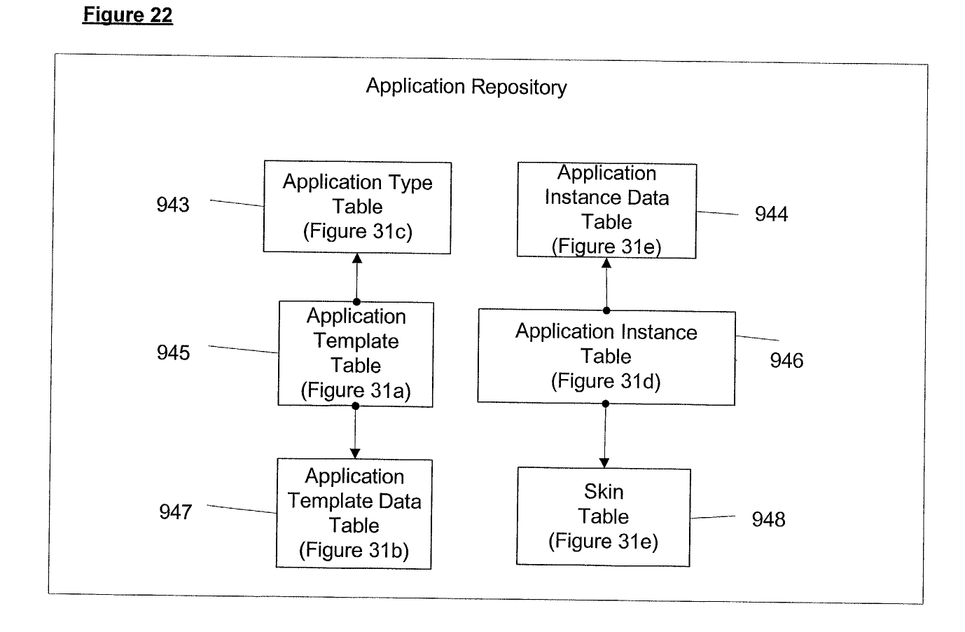

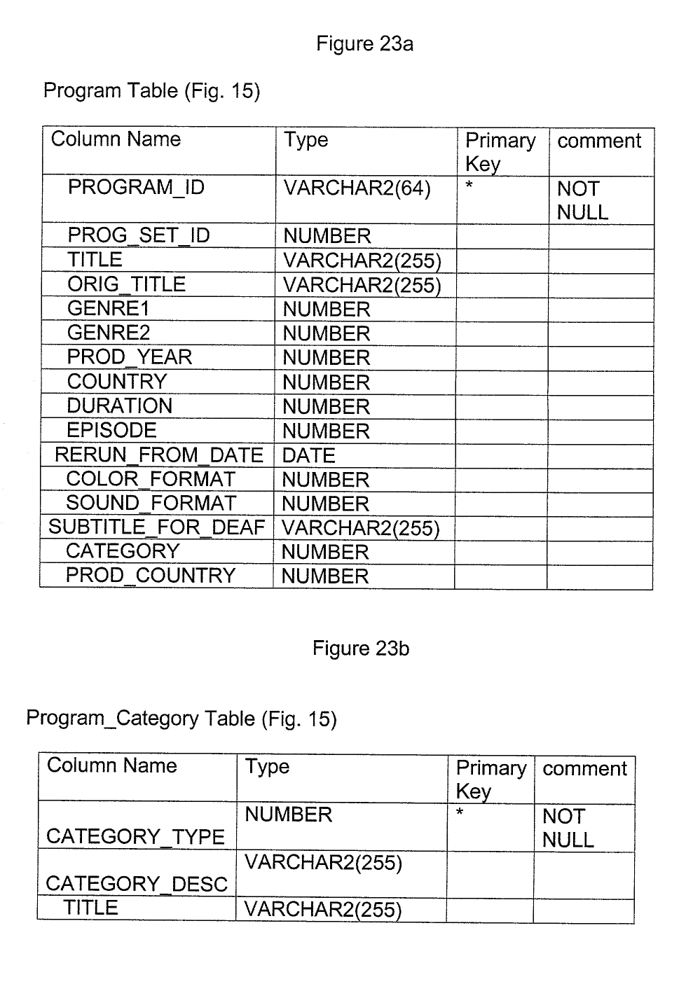

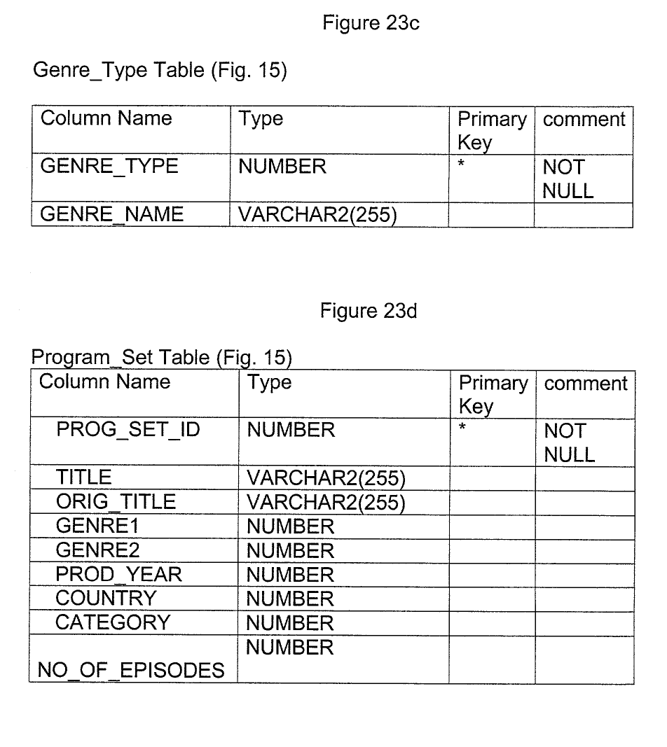

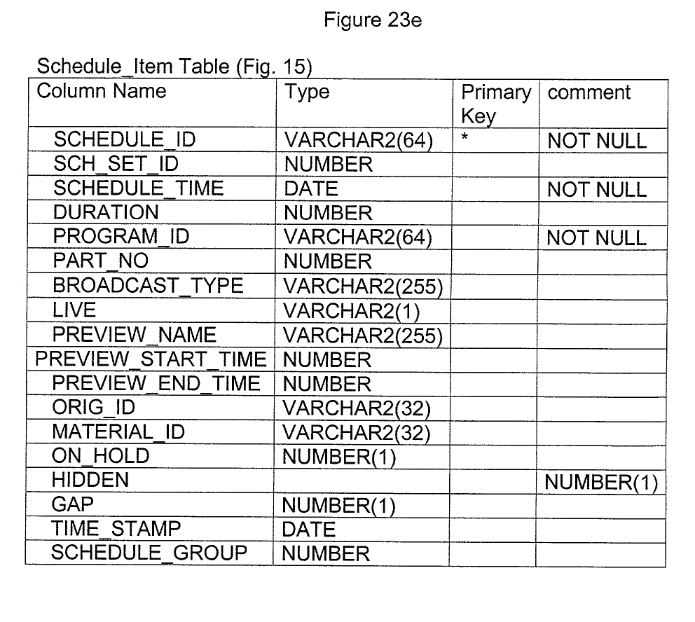

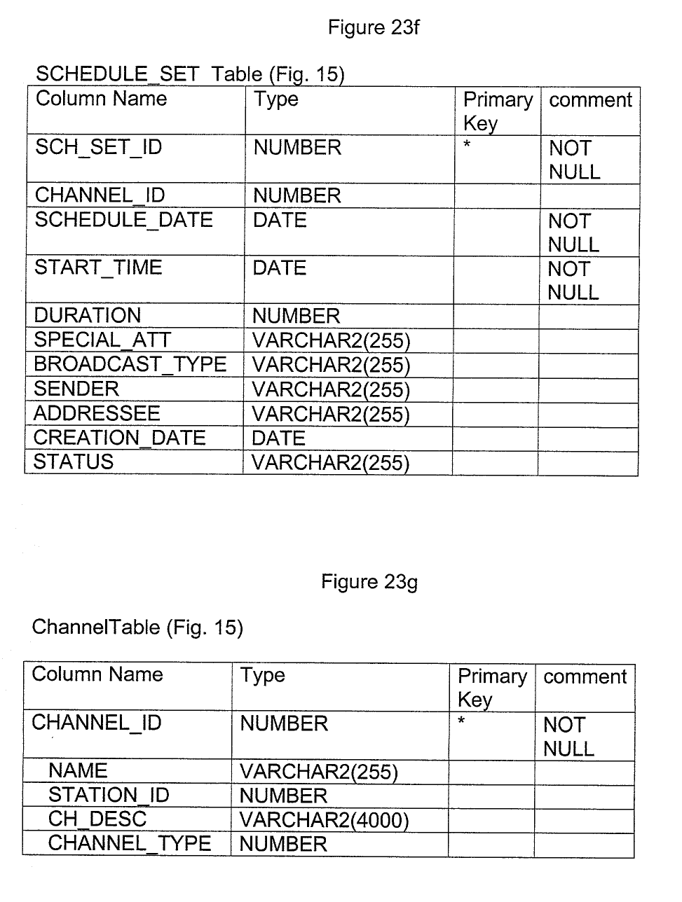

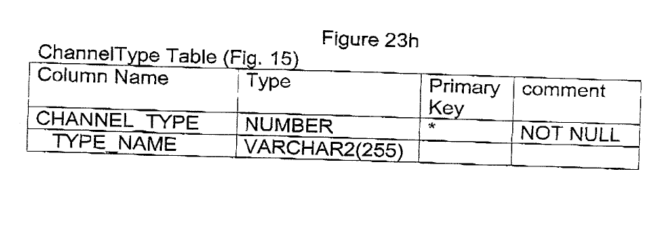

FIG. 15 is a simplified illustration of relationships between the tables of the source playlist of FIG. 14, constructed and operative in accordance with a preferred embodiment of the present invention.

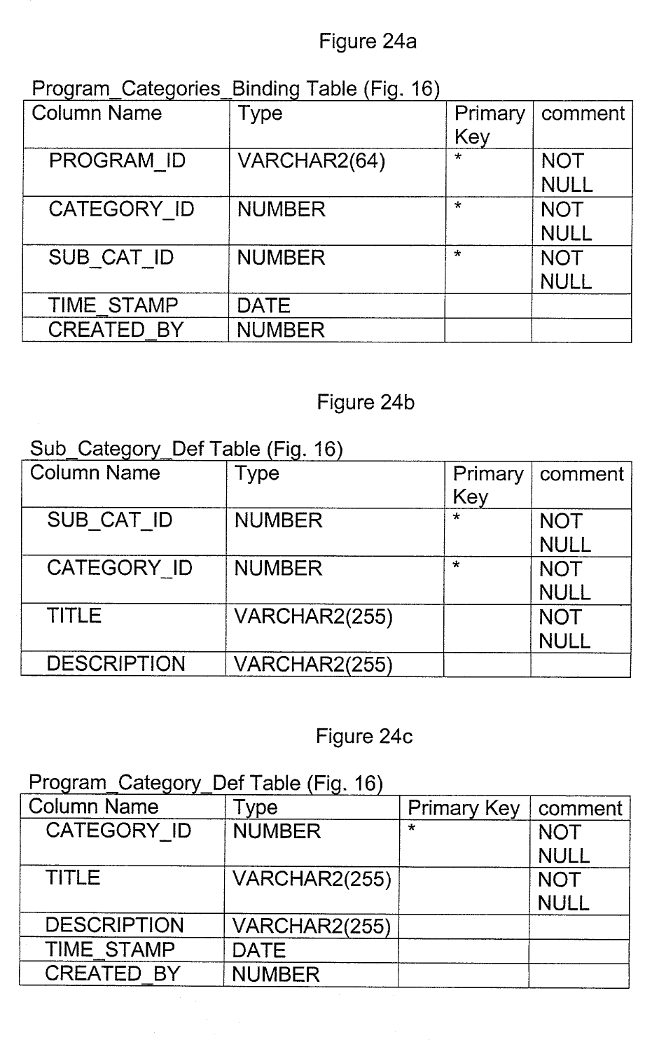

FIG. 16 is a simplified illustration of relationships between the tables of the program categories block of FIG. 14, constructed and operative in accordance with a preferred embodiment of the present invention.

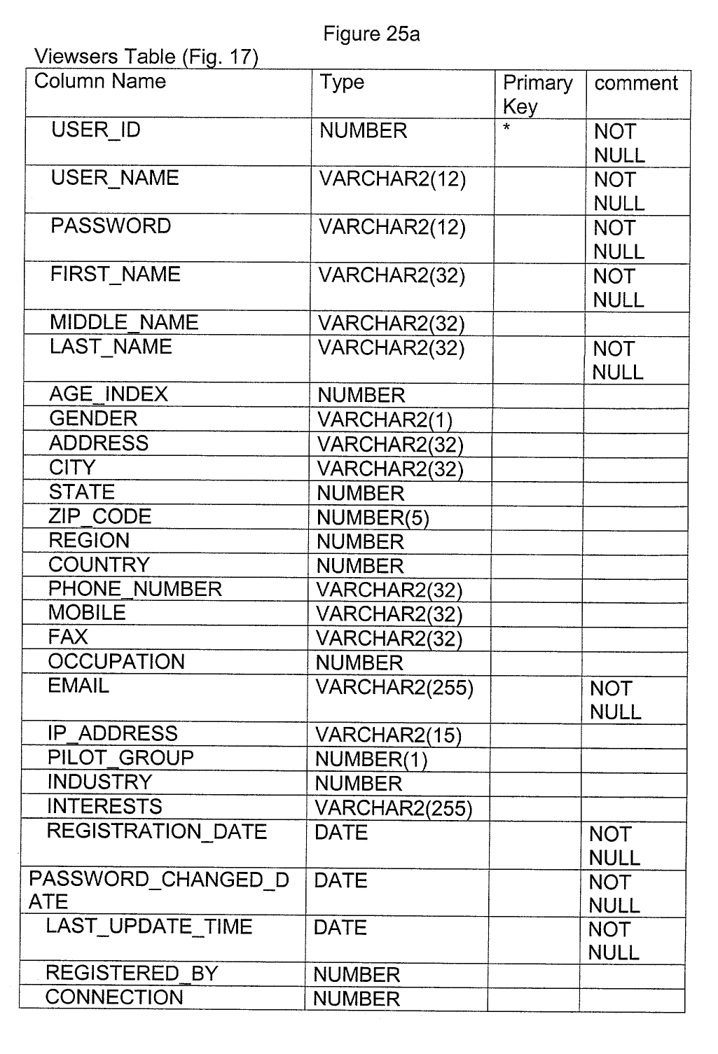

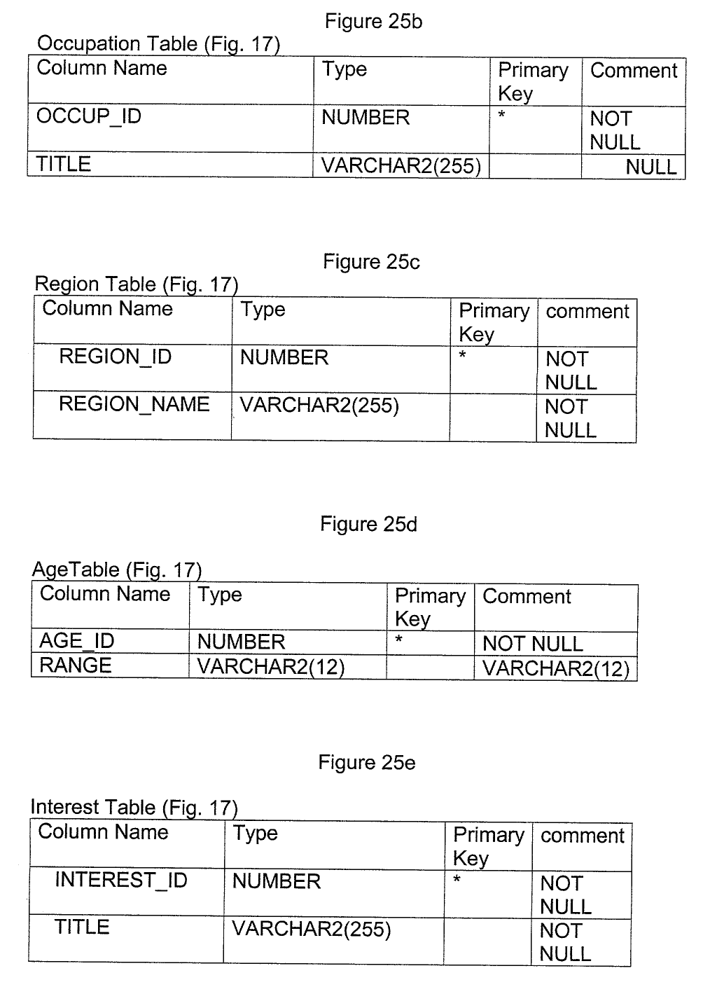

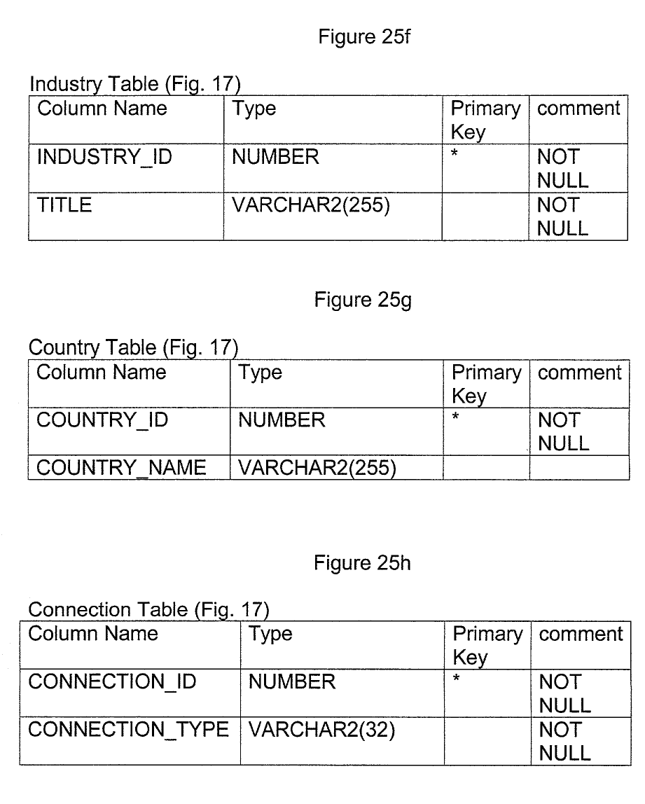

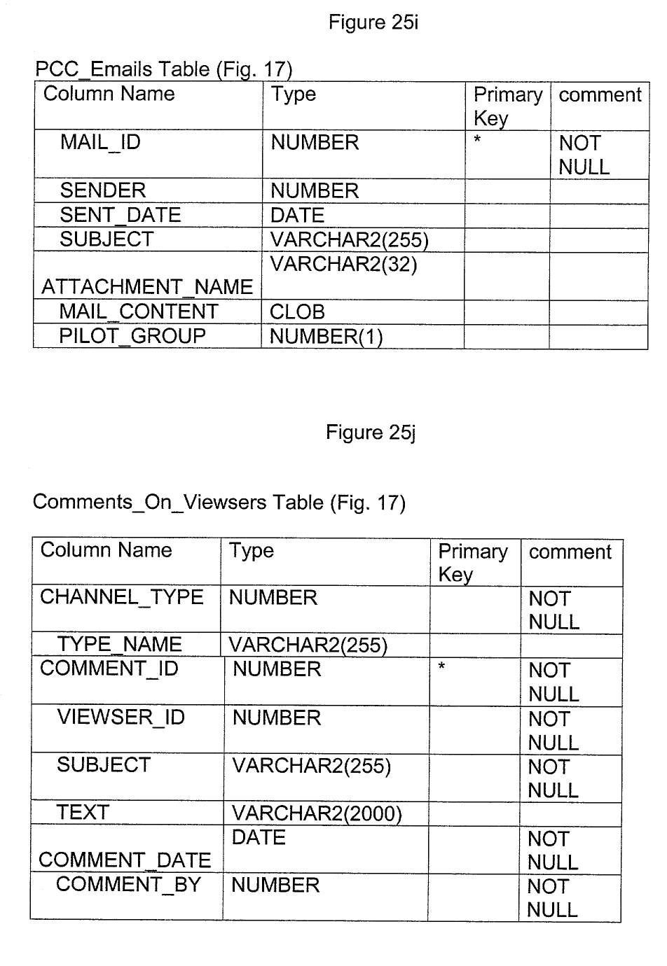

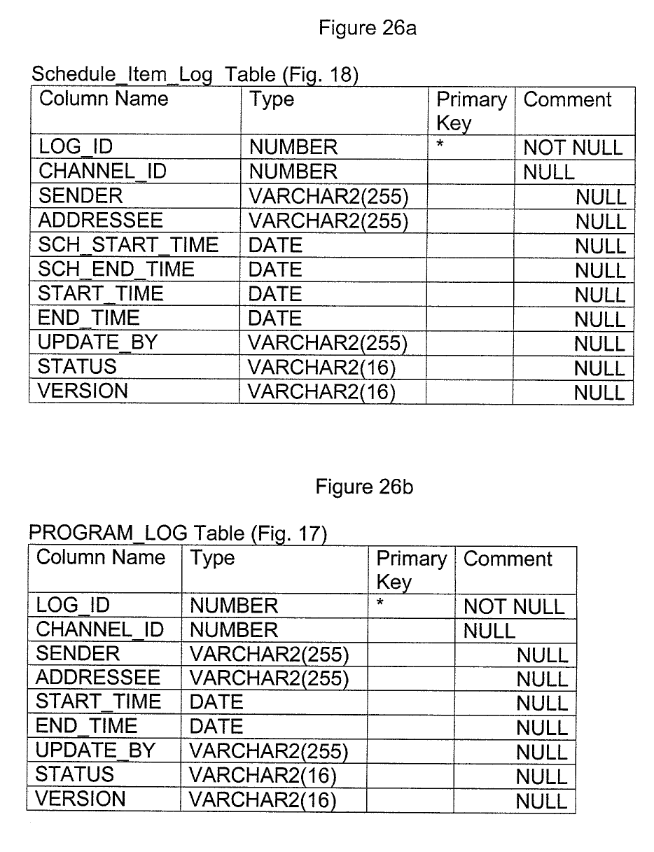

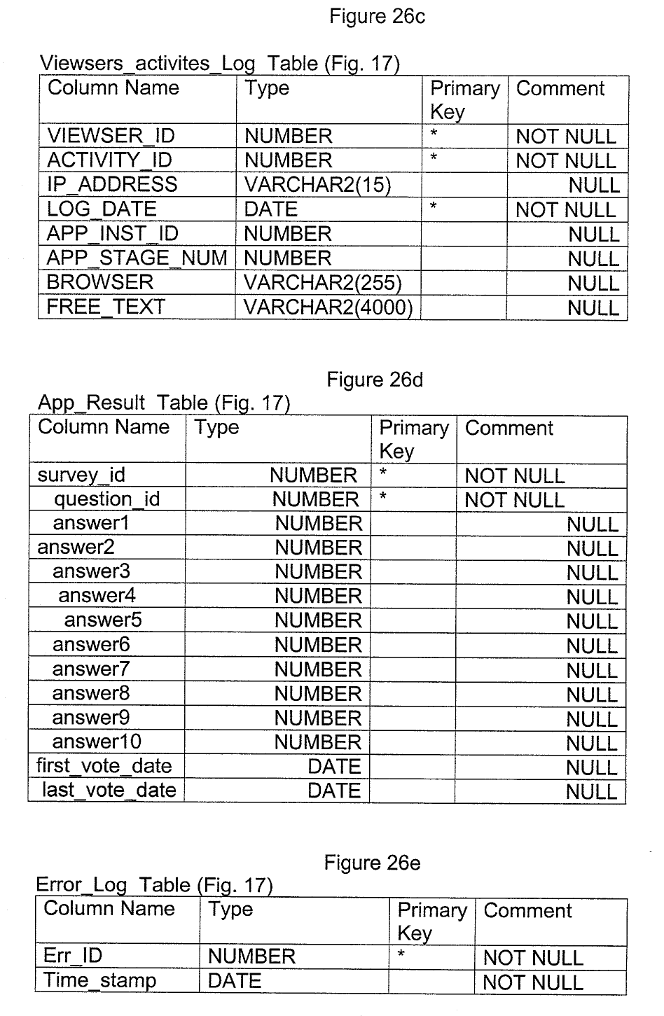

FIG. 17 is a simplified illustration of relationships between the tables of the personalization block of FIG. 14, constructed and operative in accordance with a preferred embodiment of the present invention.

FIG. 18 is a simplified illustration of relationships between the tables of the activities logs block of FIG. 14, constructed and operative in accordance with a preferred embodiment of the present invention.

FIG. 19 is a simplified illustration of relationships between the tables of the optional monitoring and control block of FIG. 14, constructed and operative in accordance with a preferred embodiment of the present invention.

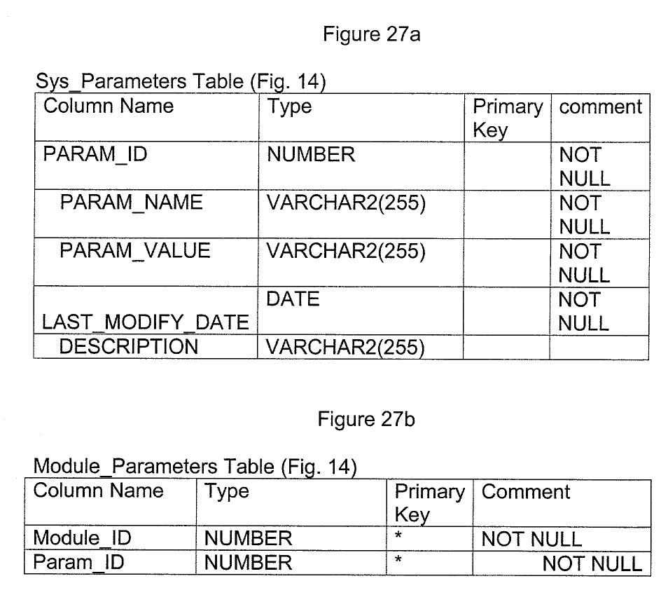

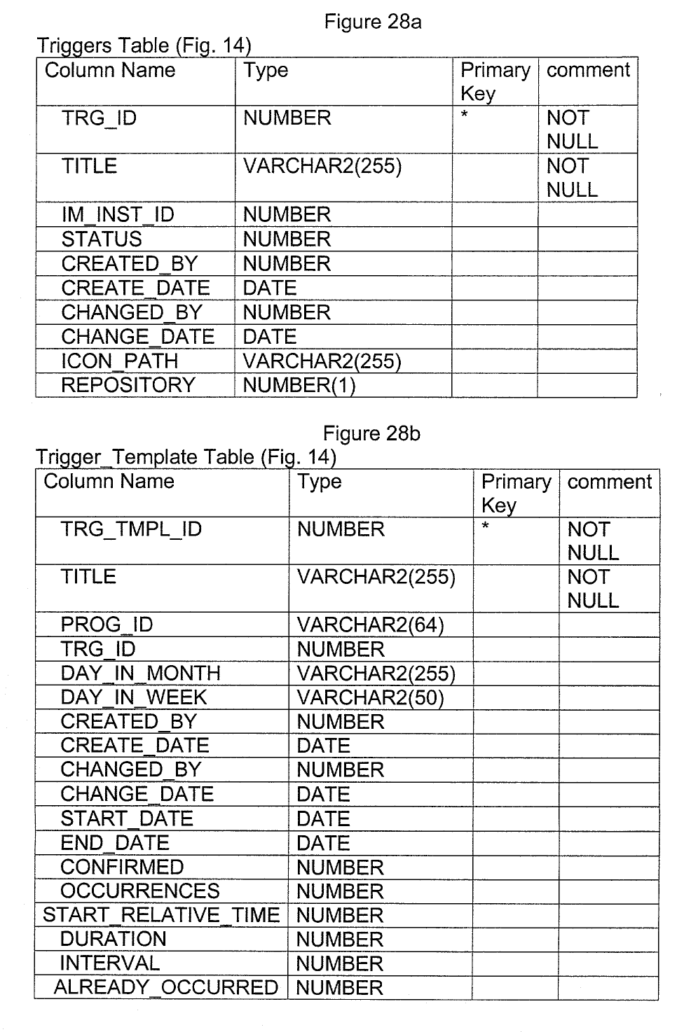

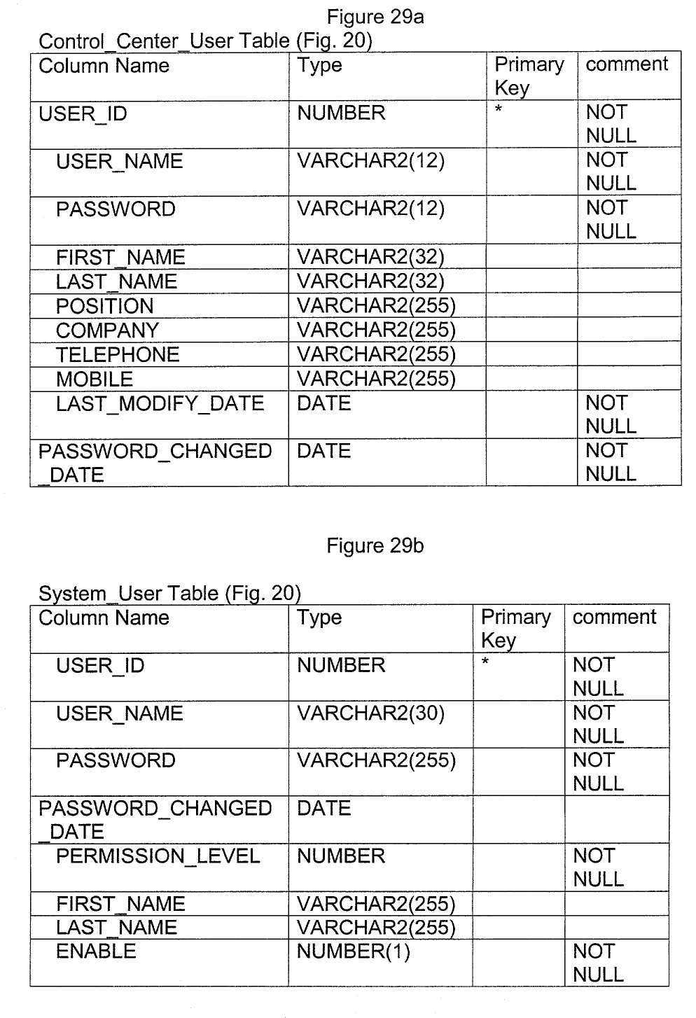

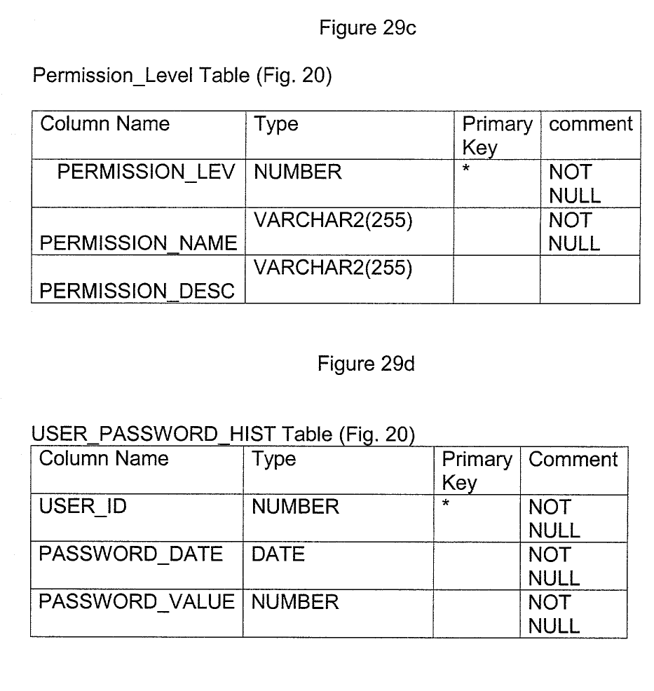

FIG. 20 is a simplified illustration of relationships between the tables of the users table cluster of FIG. 14, constructed and operative in accordance with a preferred embodiment of the present invention.

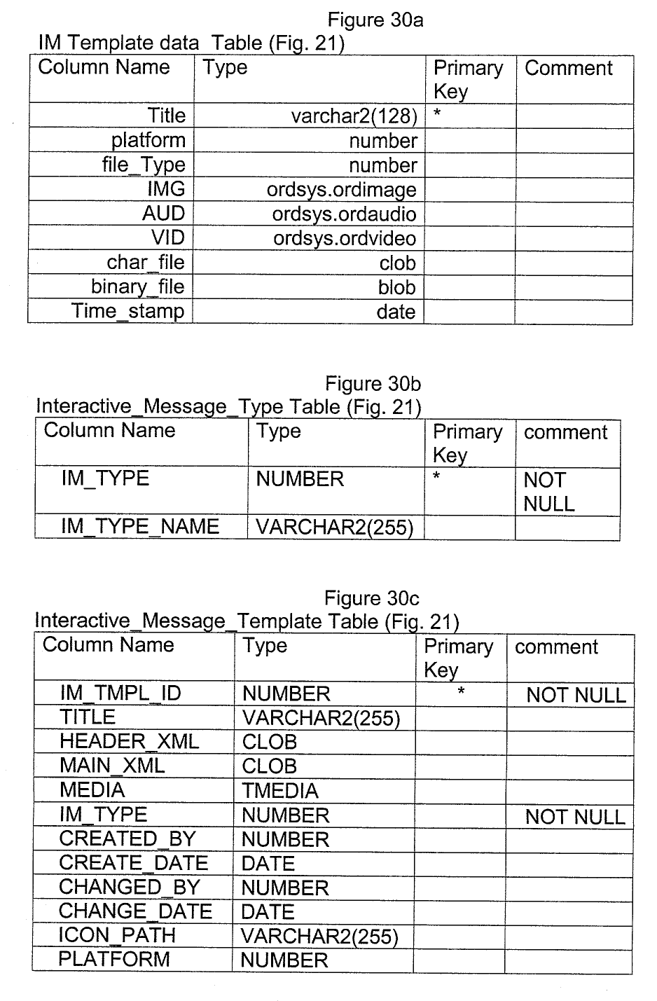

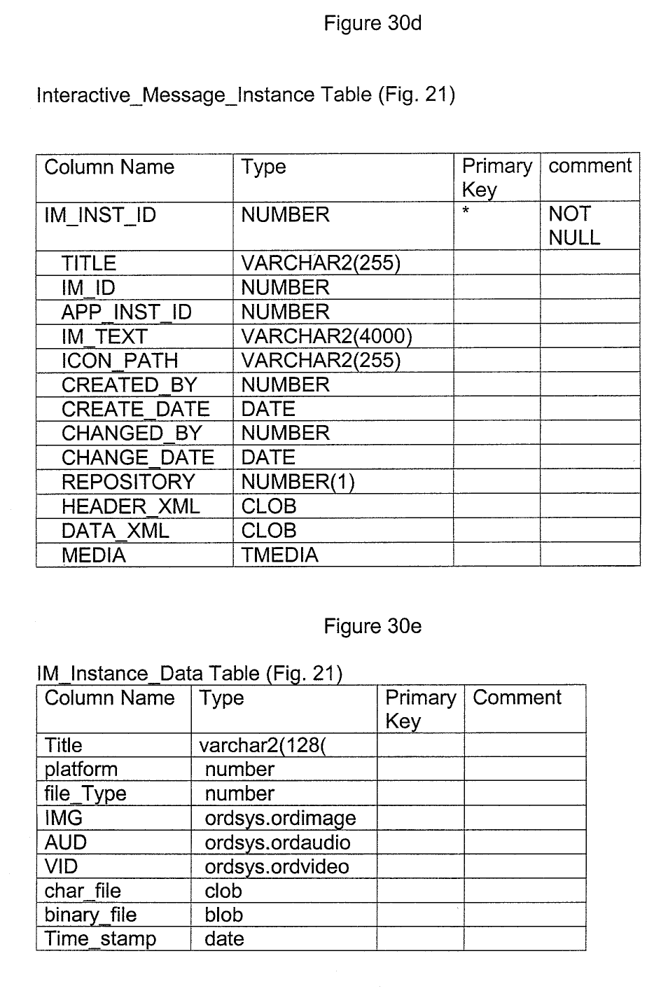

FIG. 21 is a simplified illustration of relationships between the tables of the interactive message repository of FIG. 14, constructed and operative in accordance with a preferred embodiment of the present invention.

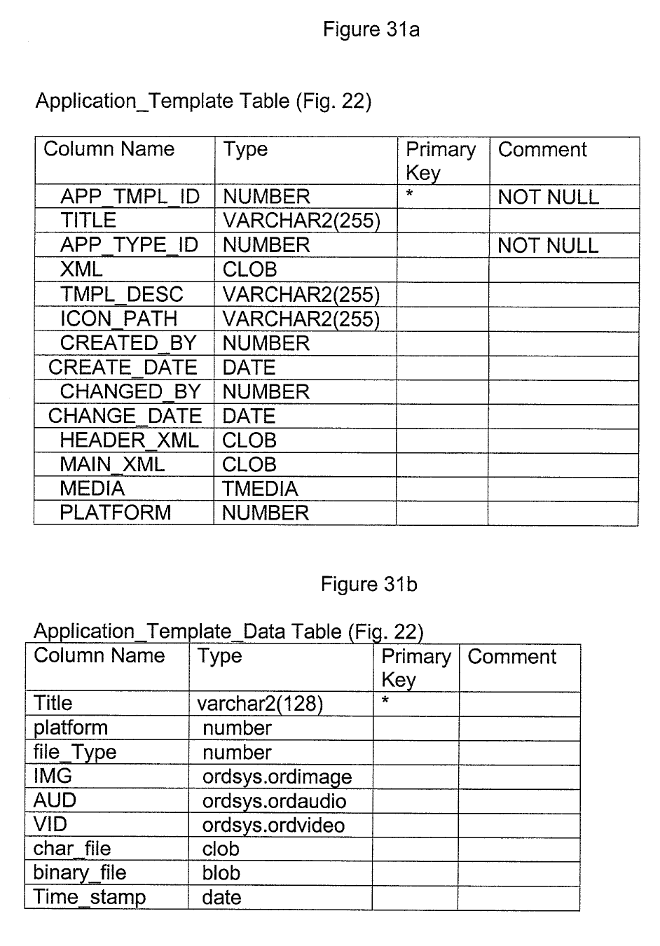

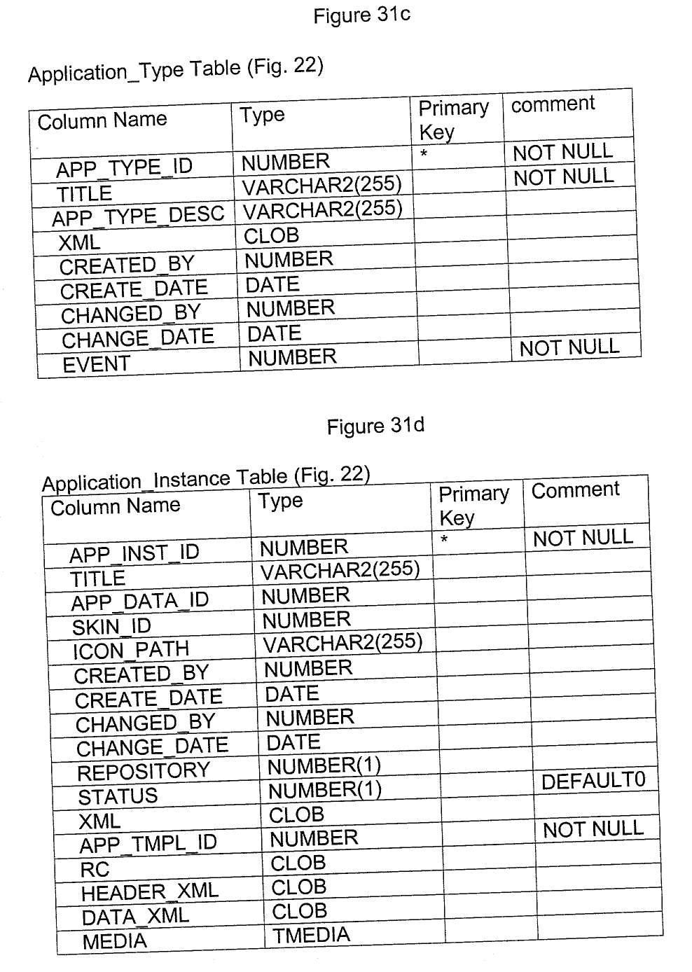

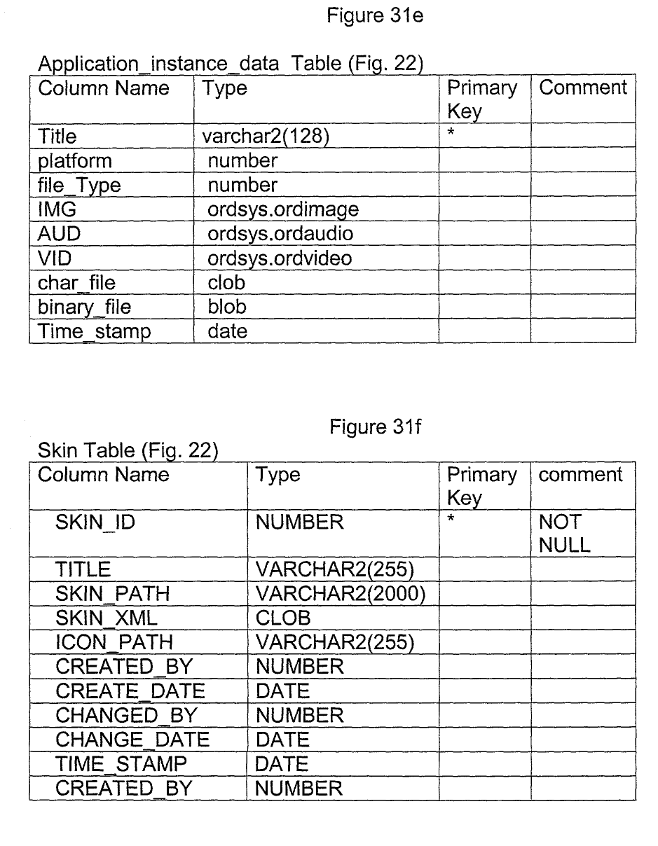

FIG. 22 is a simplified illustration of relationships between the tables of the application repository of FIG. 14, constructed and operative in accordance with a preferred embodiment of the present invention.

FIG. 23A is a diagram illustrating the data included in the program table of FIG. 15, in accordance with a preferred embodiment of the present invention.

FIG. 23B is a diagram illustrating the data included in the program category table of FIG. 15, in accordance with a preferred embodiment of the present invention.

FIG. 23C is a diagram illustrating the data included in the genre type table of FIG. 15, in accordance with a preferred embodiment of the present invention.

FIG. 23D is a diagram illustrating the data included in the program set table of FIG. 15, in accordance with a preferred embodiment of the present invention.

FIG. 23E is a diagram illustrating the data included in the schedule item table of FIG. 15, in accordance with a preferred embodiment of the present invention.

FIG. 23F is a diagram illustrating the data included in the schedule set table of FIG. 15, in accordance with a preferred embodiment of the present invention.

FIG. 23G is a diagram illustrating the data included in the channel table of FIG. 15, in accordance with a preferred embodiment of the present invention.

FIG. 23H is a diagram illustrating the data included in the channel type table of FIG. 15, in accordance with a preferred embodiment of the present invention.

FIG. 24A is a diagram illustrating the data included in the program categories binding table of FIG. 16, in accordance with a preferred embodiment of the present invention.

FIG. 24B is a diagram illustrating the data included in the subcategory definition (sub_category_def) table of FIG. 16, in accordance with a preferred embodiment of the present invention.

FIG. 24C is a diagram illustrating the data included in the program category definition table of FIG. 16, in accordance with a preferred embodiment of the present invention.

FIG. 25A is a diagram illustrating the data included in the viewsers table of FIG. 17, in accordance with a preferred embodiment of the present invention.

FIG. 25B is a diagram illustrating the data included in the occupation table of FIG. 17, in accordance with a preferred embodiment of the present invention.

FIG. 25C is a diagram illustrating the data included in the region table of FIG. 17, in accordance with a preferred embodiment of the present invention.

FIG. 25D is a diagram illustrating the data included in the age table of FIG. 17, in accordance with a preferred embodiment of the present invention.

FIG. 25E is a diagram illustrating the data included in the interest table of FIG. 17, in accordance with a preferred embodiment of the present invention.

FIG. 25F is a diagram illustrating the data included in the industry table of FIG. 17, in accordance with a preferred embodiment of the present invention.

FIG. 25G is a diagram illustrating the data included in the country table of FIG. 17, in accordance with a preferred embodiment of the present invention.

FIG. 25H is a diagram illustrating the data included in the comments-on-viewser table of FIG. 17, in accordance with a preferred embodiment of the present invention.

FIG. 25I is a diagram illustrating the data included in the pilot control center emails table of FIG. 17, in accordance with a preferred embodiment of the present invention.

FIG. 25J is a diagram illustrating the data included in the connection table of FIG. 17, in accordance with a preferred embodiment of the present invention.

FIG. 26A is a diagram illustrating the data included in the schedule items logs table of FIG. 18, in accordance with a preferred embodiment of the present invention.

FIG. 26B is a diagram illustrating the data included in the program log table of FIG. 18, in accordance with a preferred embodiment of the present invention.

FIG. 26C is a diagram illustrating the data included in the viewsers activities logs table of FIG. 18, in accordance with a preferred embodiment of the present invention.

FIG. 26D is a diagram illustrating the data included in the application result table of FIG. 18, in accordance with a preferred embodiment of the present invention.

FIG. 26E is a diagram illustrating the data included in the error table of FIG. 18, in accordance with a preferred embodiment of the present invention.

FIG. 27A is a diagram illustrating the data included in the system parameters table of FIG. 14, in accordance with a preferred embodiment of the present invention.

FIG. 27B is a diagram illustrating the data included in the module parameters table of FIG. 14, in accordance with a preferred embodiment of the present invention.

FIG. 28A is a diagram illustrating the data included in the trigger table of FIG. 14, in accordance with a preferred embodiment of the present invention.

FIG. 28B is a diagram illustrating the data included in the trigger template table of FIG. 14, in accordance with a preferred embodiment of the present invention.

FIG. 29A is a diagram illustrating the data included in the control center users table of FIG. 20, in accordance with a preferred embodiment of the present invention.

FIG. 29B is a diagram illustrating the data included in the system users table of FIG. 20, in accordance with a preferred embodiment of the present invention.

FIG. 29C is a diagram illustrating the data included in the permission level table of FIG. 20, in accordance with a preferred embodiment of the present invention.

FIG. 29D is a diagram illustrating the data included in the user password history table of FIG. 20, in accordance with a preferred embodiment of the present invention.

FIG. 30A is a diagram illustrating the data included in the interactive message template data table of FIG. 21, in accordance with a preferred embodiment of the present invention.

FIG. 30B is a diagram illustrating the data included in the interactive message type table of FIG. 21, in accordance with a preferred embodiment of the present invention.

FIG. 30C is a diagram illustrating the data included in the interactive message template table of FIG. 21, in accordance with a preferred embodiment of the present invention.

FIG. 30D is a diagram illustrating the data included in the interactive message instance data table of FIG. 21, in accordance with a preferred embodiment of the present invention.

FIG. 30E is a diagram illustrating the data included in the interactive message instance data table of FIG. 21, in accordance with a preferred embodiment of the present invention.

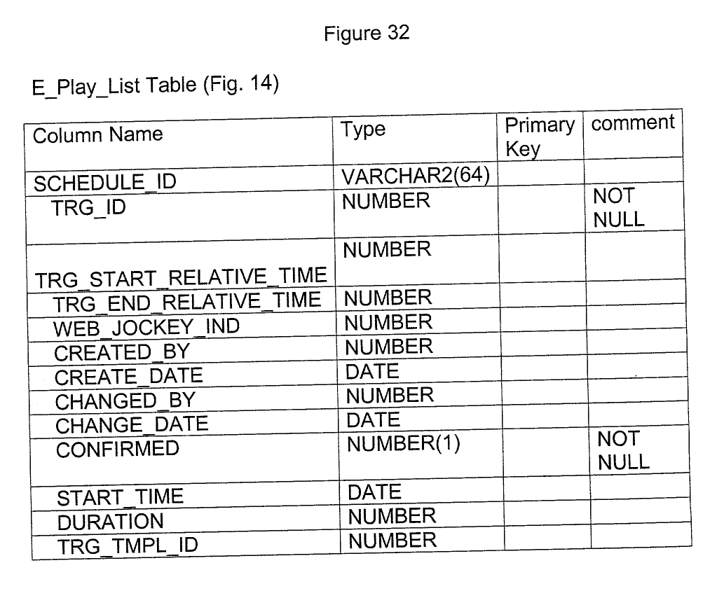

FIG. 31A is a diagram illustrating the data included in the application template table of FIG. 22, in accordance with a preferred embodiment of the present invention.

FIG. 31B is a diagram illustrating the data included in the application template data table of FIG. 22, in accordance with a preferred embodiment of the present invention.

FIG. 31C is a diagram illustrating the data included in the application type table of FIG. 22, in accordance with a preferred embodiment of the present invention.

FIG. 31D is a diagram illustrating the data included in the application instance table of FIG. 22, in accordance with a preferred embodiment of the present invention.

FIG. 31E is a diagram illustrating the data included in the application instance data table of FIG. 22, in accordance with a preferred embodiment of the present invention.

FIG. 31F is a diagram illustrating the data included in the graphic skin table of FIG. 22, in accordance with a preferred embodiment of the present invention.

FIG. 32 is a diagram illustrating the data included in the eplaylist table of FIG. 14, in accordance with a preferred embodiment of the present invention.

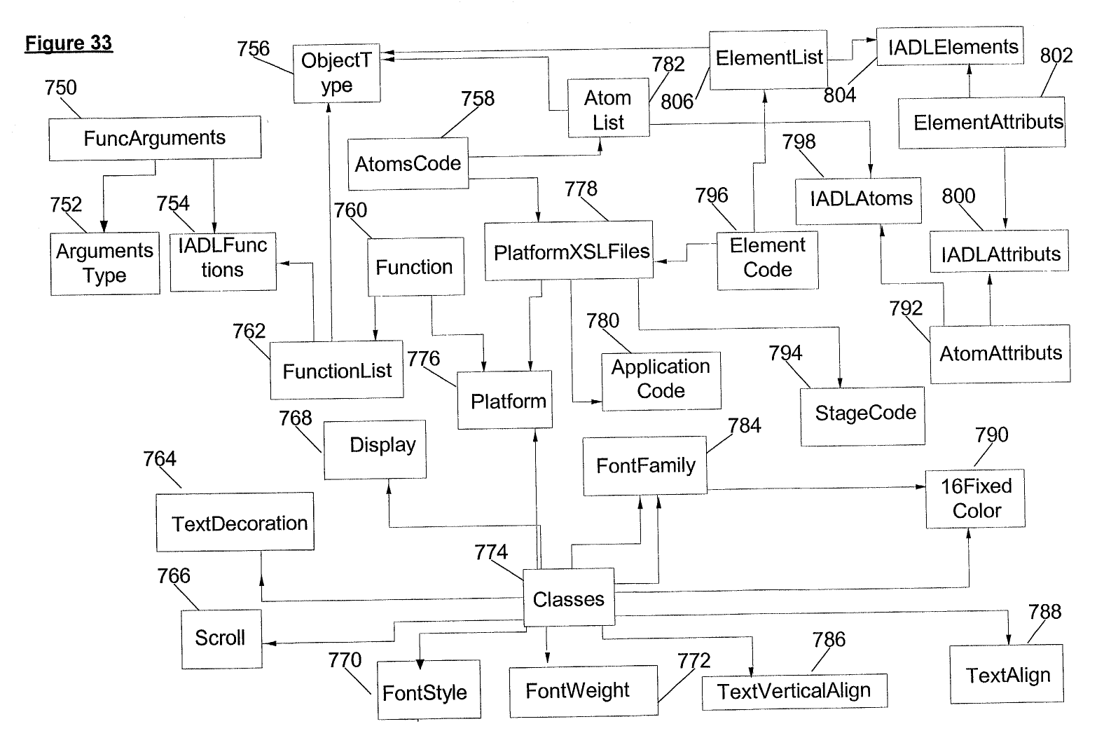

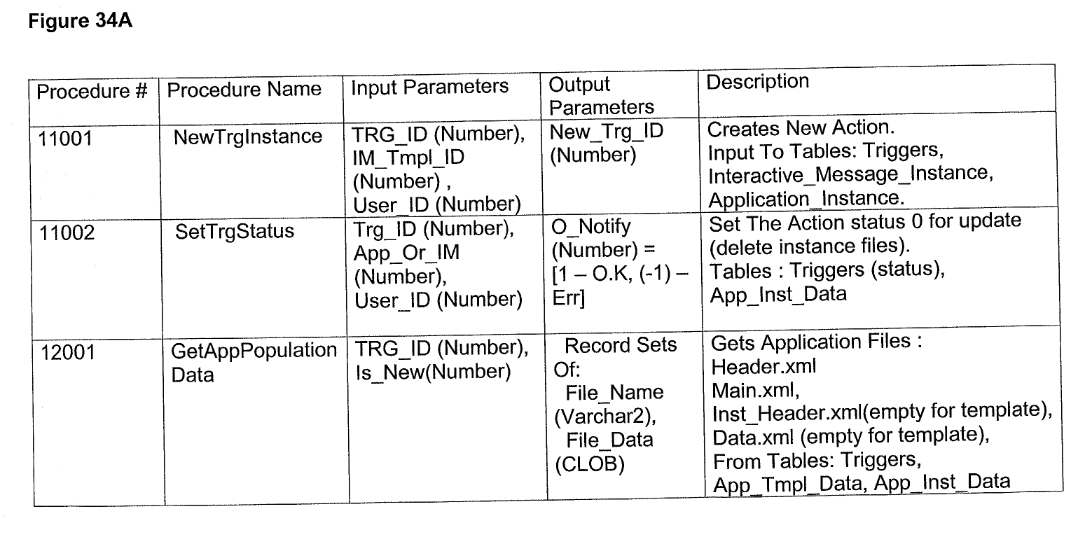

FIG. 33 is a simplified illustration of relationships between the tables of the knowledgebase of FIG. 4, constructed and operative in accordance with a preferred embodiment of the present invention.

The tables of the knowledge base illustrated in FIG. 33 may, for example, store the following parameters:

table TextAlign
TextAlign
TextAlignPos
table TextVerticalAlign
TextVerticalAlign
TextVerticalAlignPos
table FontWeight
FontWeight
FontWeightName
table FontStyle
FontStyle
FontStyleName
table TextDecoration
TextDecoration
TextDecorationName
table Display
Display
DisplayName
table ObjectType
Type
TypeName
table Scroll
Scroll
ScrollName
table StageCode
XSLFileName
XSLCode
table ApplicationCode
XSLFileName
XSLCode
table FontFamily
FontFamily
FontFamilyName
table IADLAtoms
AtomID
AtomXML
PC Web
OpenTV
table IADLElements
ElementID
ElementXML
PC Web
OpenTV
table IADLAttributs
AttributeID
AttributeName
IADLSyntax
PC Web
OpenTV
table IADLFunctions
FuncID
FuncSyntax
table ArgumentsType
ArgumentType
Type
table 16FixedColor
CIndex
CName
CPCWeb
COpenTV
table Platform
PlatformID
PlatformName
table AtomList
AtomID
AtomName
PC Web
OpenTV
Type
table ElementList
ElementID
ElementName
PC Web
OpenTV
Type
table FunctionList
FuncID
Type
FuncName
PC Web
OpenTV
table PlatformXSLFiles
PlatformID
XSLFileName
table AtomsCode
AtomID
XSLFileName
XSLCode
table ElementCode
ElementID
XSLFileName
XSLCode
table Function
FuncID
PlatformID
FunctionCode
table Classes
ClassName
PlatformID
BGColor
TextColor
FontFamily
FontSize
TextAlign
TextVerticalAlign
FontWeight
FontStyle
TextDecoration
Top
Left
Height
Width
Display
BorderWidth
BorderColor
TextShedow
Scroll
table AtomAttributs
AttributeID
AtomID
table ElementAttributs
AttributeID
ElementID
table FuncArguments
FuncID
ArgumentID
ArgumentType
argIADLSyntax

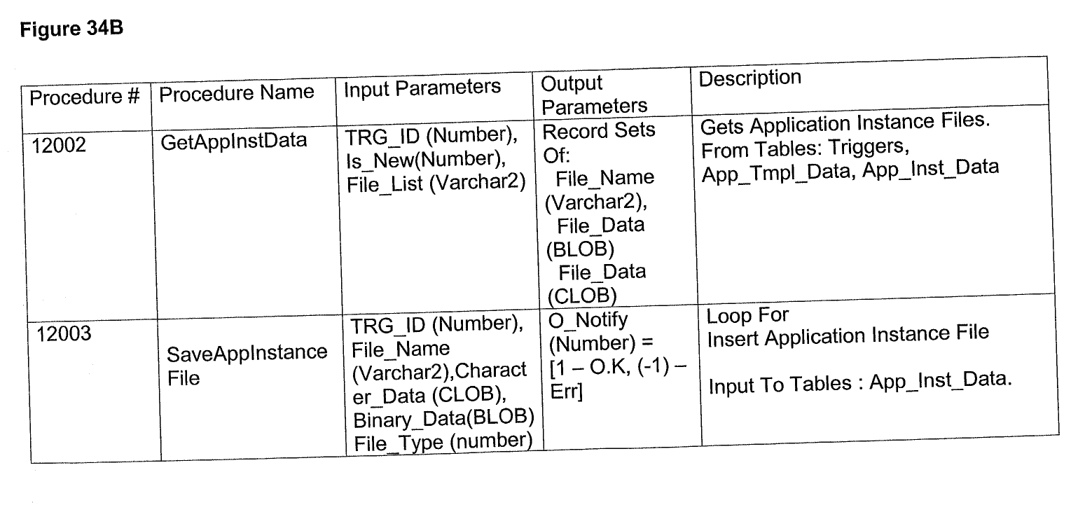

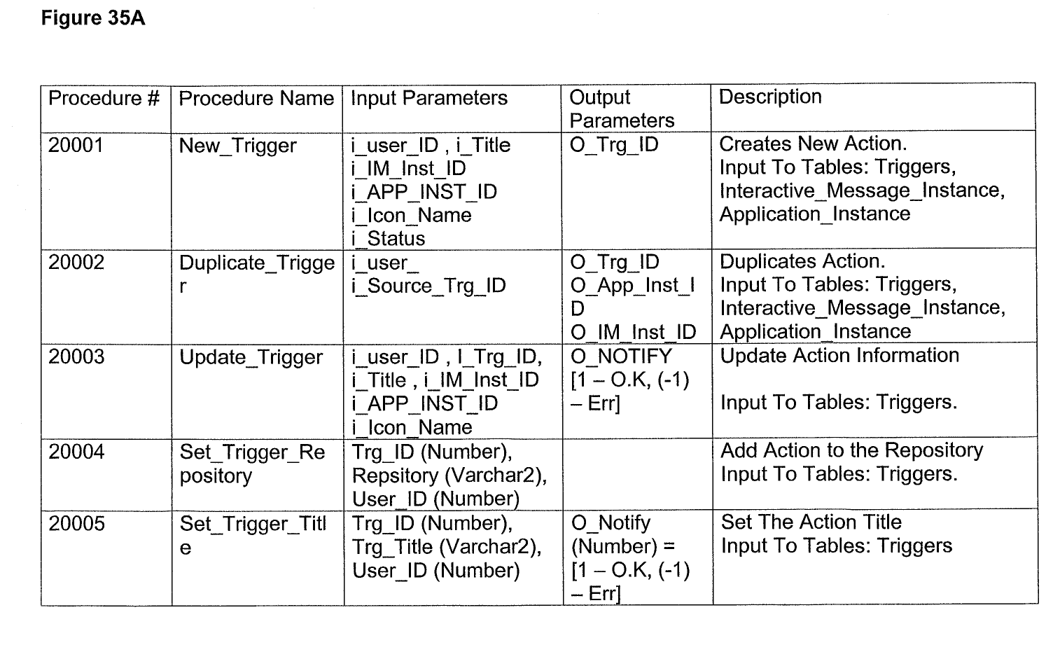

FIGS. 34A-34B, taken together, form a table summarizing the input parameters, output parameters and preferred mode of operation for wizard processing procedures useful in manipulating wizard data within the BackEngine database of FIGS. 4 and 14.

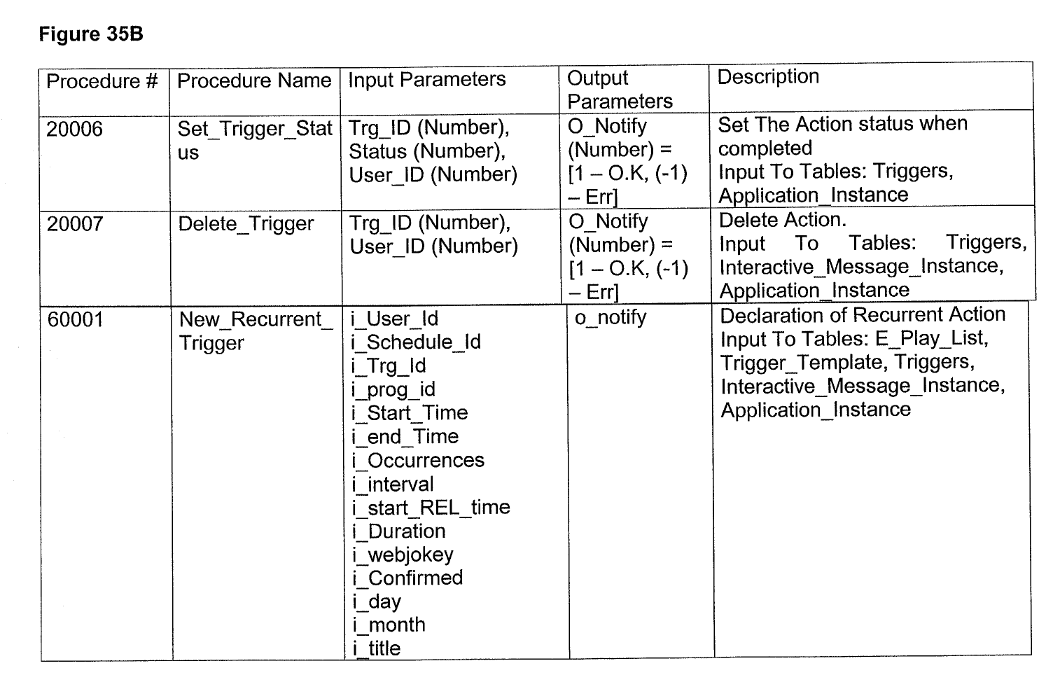

FIGS. 35A-35B, taken together, form a table summarizing the input parameters, output parameters and preferred mode of operation for trigger processing procedures useful in manipulating trigger data within the BackEngine database of FIGS. 4 and 14.

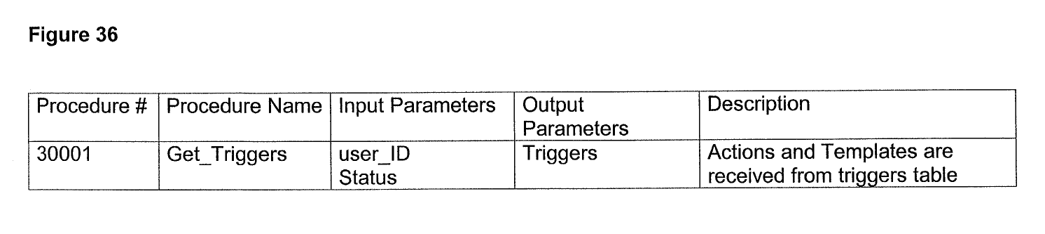

FIG. 36 is a table summarizing the input parameters, output parameters and preferred mode of operation for repository maintenance procedures useful in manipulating repository data within the BackEngine database of FIGS. 4 and 14.

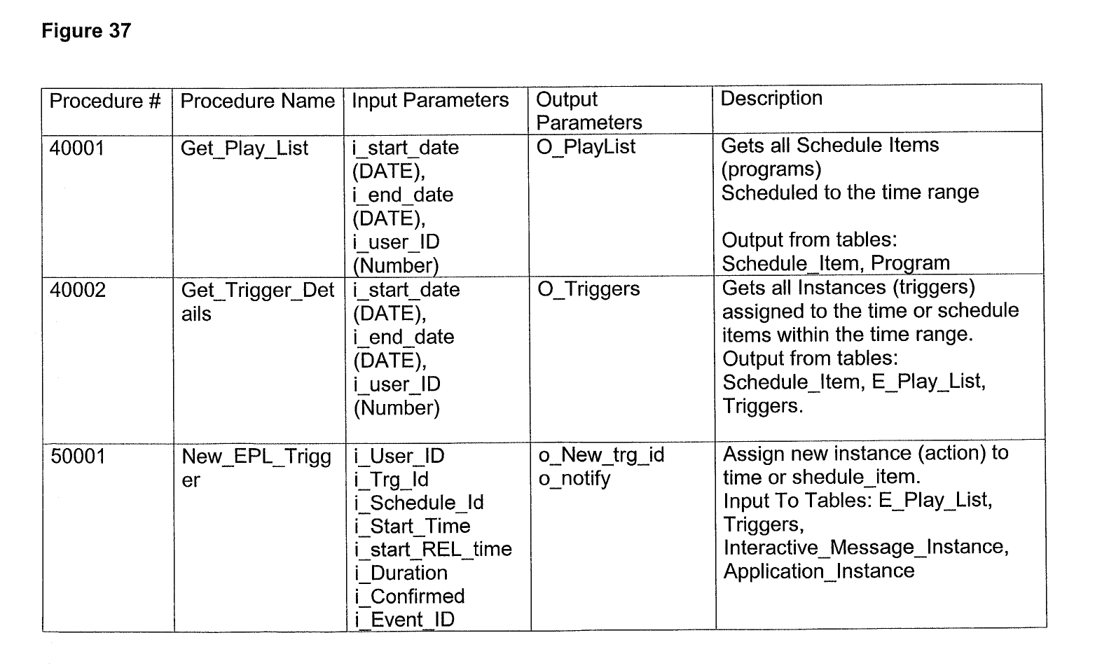

FIG. 37 is a table summarizing the input parameters, output parameters and preferred mode of operation for playlist processing procedures useful in manipulating playlist data within the BackEngine database of FIGS. 4 and 14.

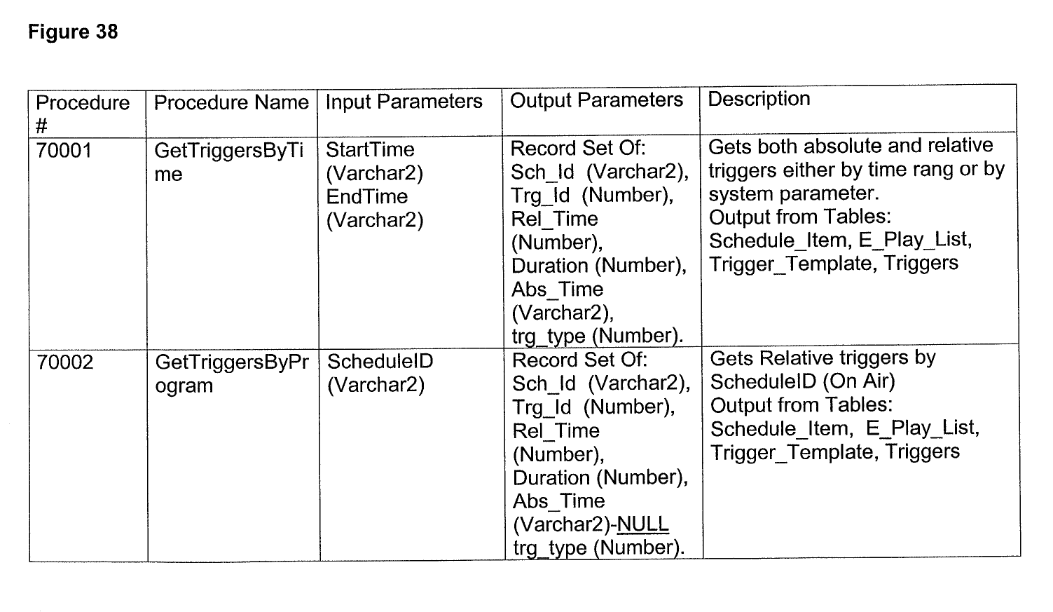

FIG. 38 is a table summarizing the input parameters, output parameters and preferred mode of operation for digital television trigger insertion procedures useful in manipulating data within the BackEngine database of FIGS. 4 and 14 in accordance with the embodiments of FIGS. 2 and 3.

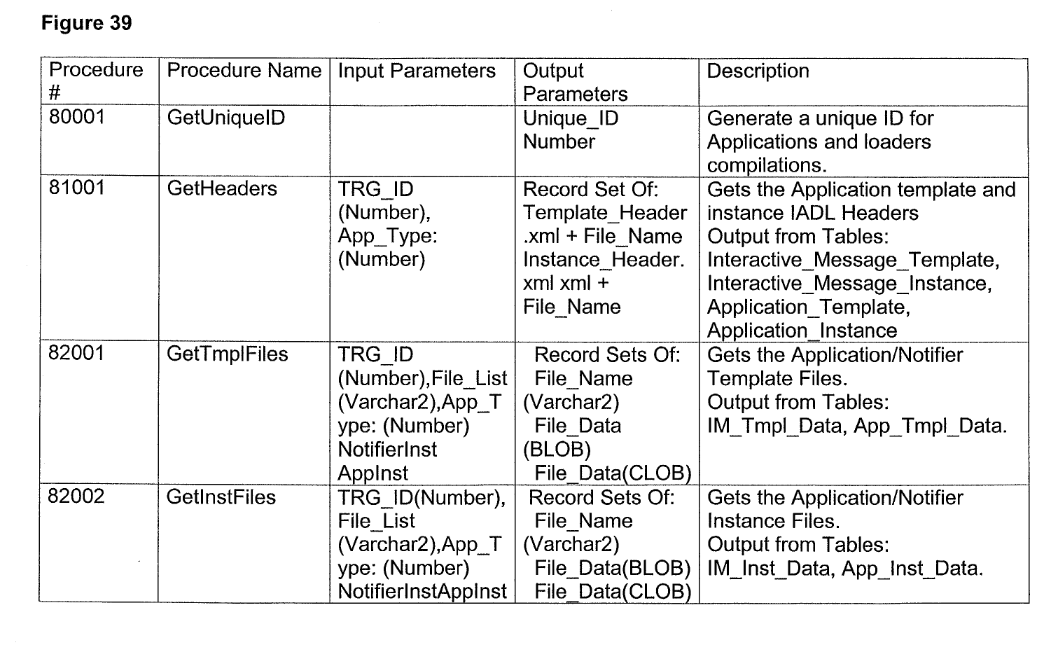

FIG. 39 is a table summarizing the input parameters, output parameters and preferred mode of operation for packager procedures performed by the DTV packager of FIGS. 4 and 12.

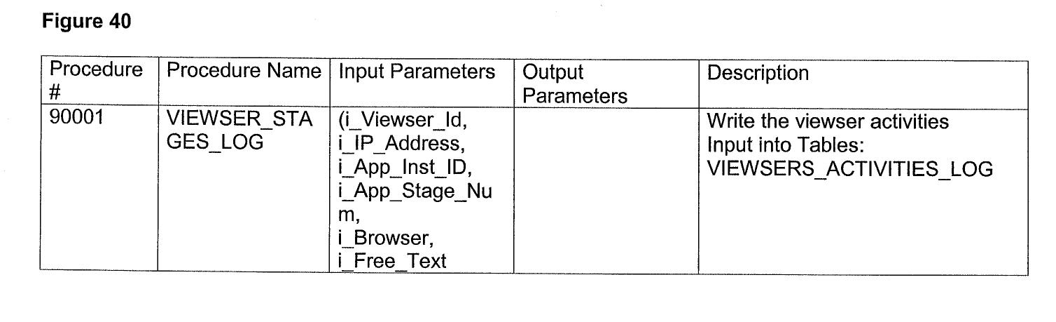

FIG. 40 is a table summarizing the input parameters, output parameters and preferred mode of operation for viewser log procedures useful in manipulating data within the BackEngine database of FIGS. 4 and 14.

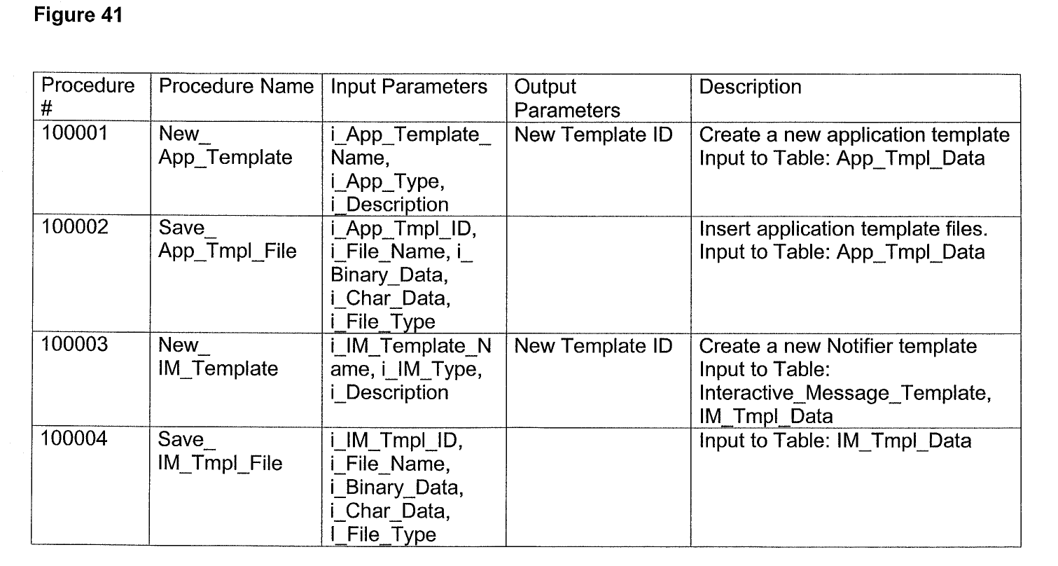

FIG. 41 is a table summarizing the input parameters, output parameters and preferred mode of operation for fusing procedures performed by the fuser of FIGS. 4 and 9.

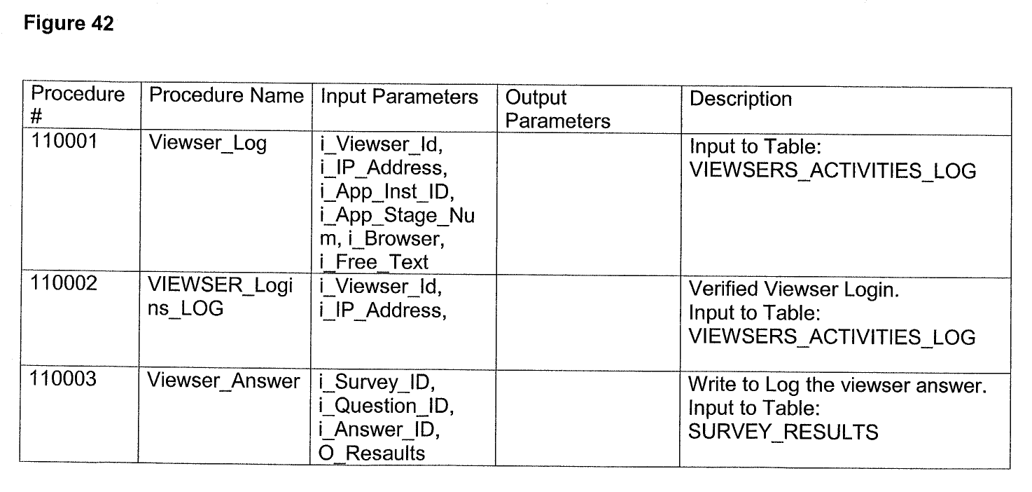

FIG. 42 is a table summarizing the input parameters, output parameters and preferred mode of operation for interactive serving procedures performed by the interactive server of FIGS. 4 and 10.

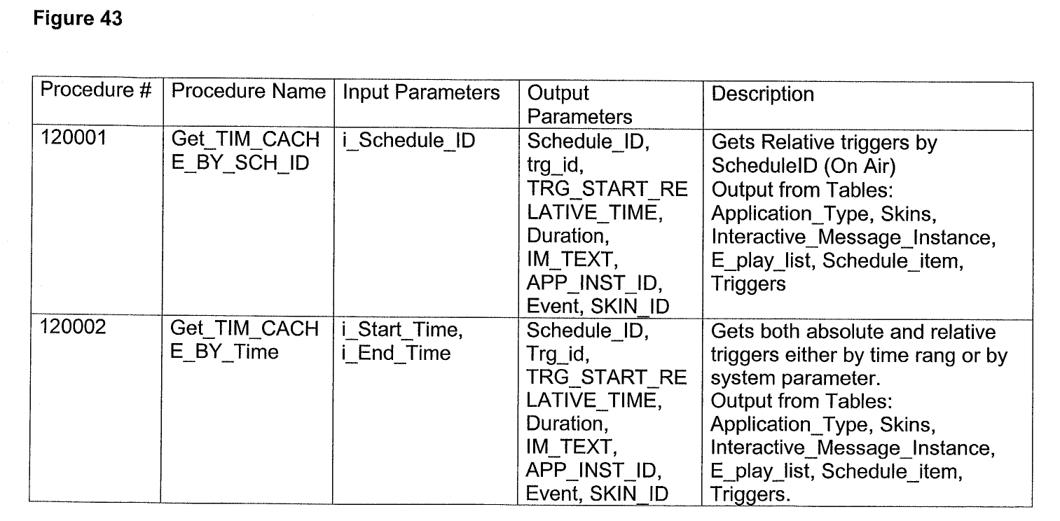

FIG. 43 is a table summarizing the input parameters, output parameters and preferred mode of operation for computer network trigger insertion procedures useful in manipulating data within the BackEngine database of FIGS. 4 and 14 in accordance with the embodiments of FIGS. 1 and 3.

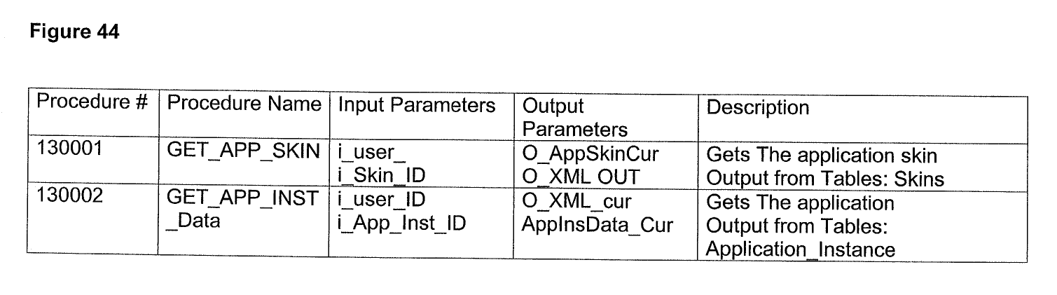

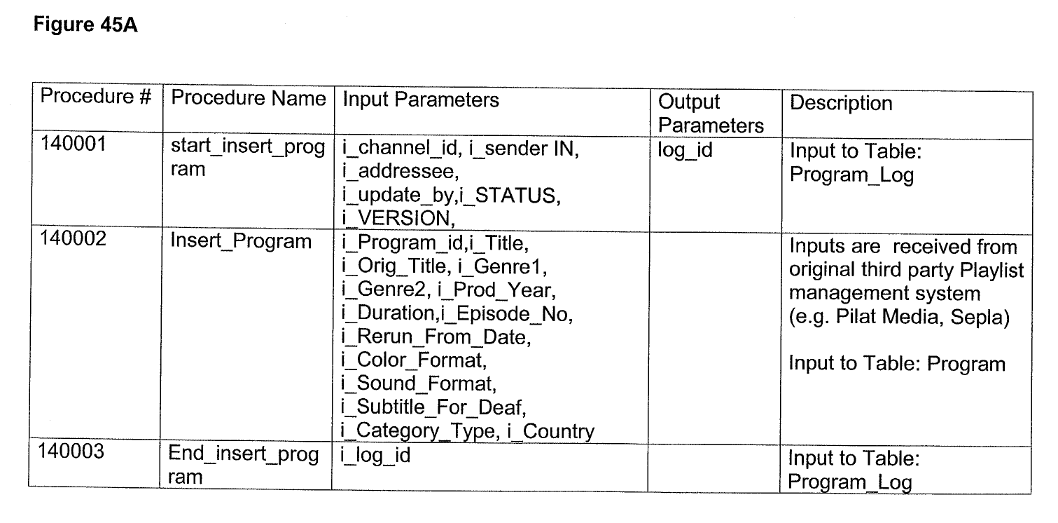

FIG. 44 is a table summarizing the input parameters, output parameters and preferred mode of operation for procedures useful in manipulating application instance data within the application repository of FIG. 22.

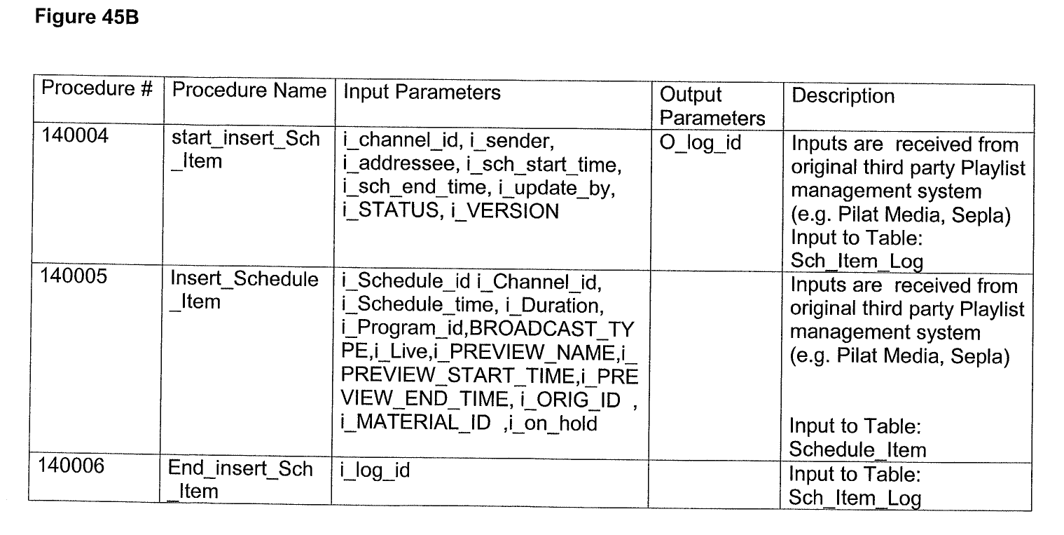

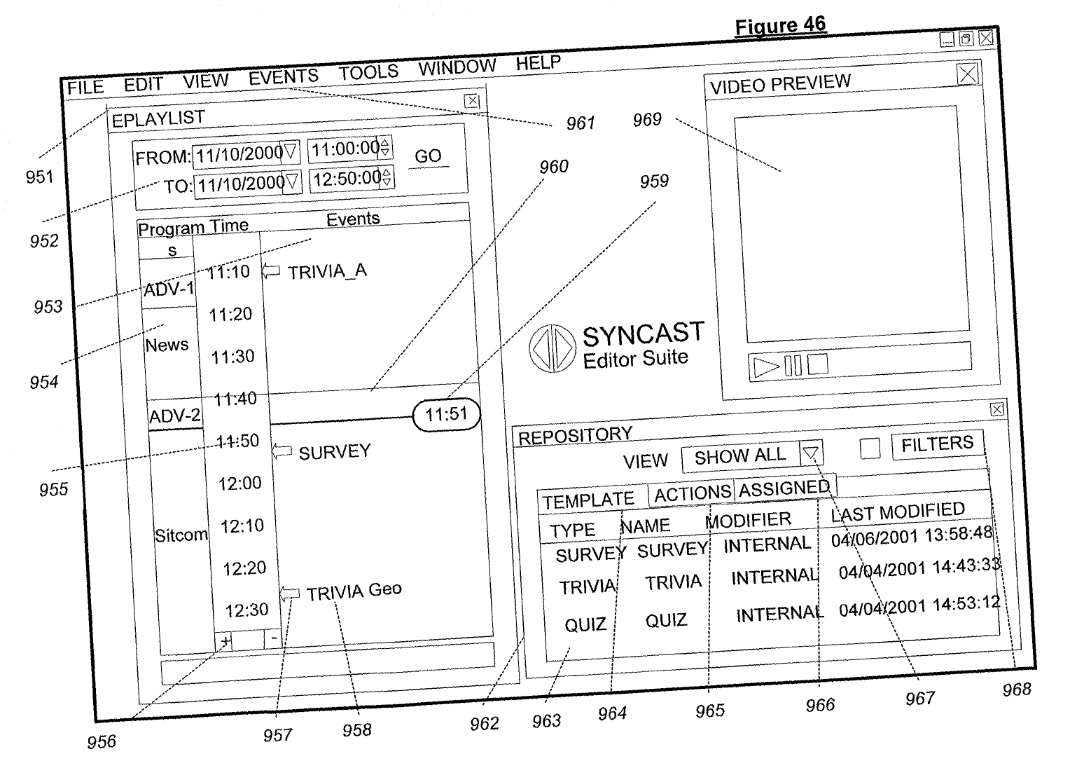

FIG. 45 is a table summarizing the input parameters, output parameters and preferred mode of operation for application protocol interfacing procedures useful in manipulating data within the BackEngine database of FIGS. 4 and 14.

FIG. 46 is a simplified pictorial illustration of a first screen display generated by the editor GUI (graphic user interface) of FIG. 4 when performing an example workflow.

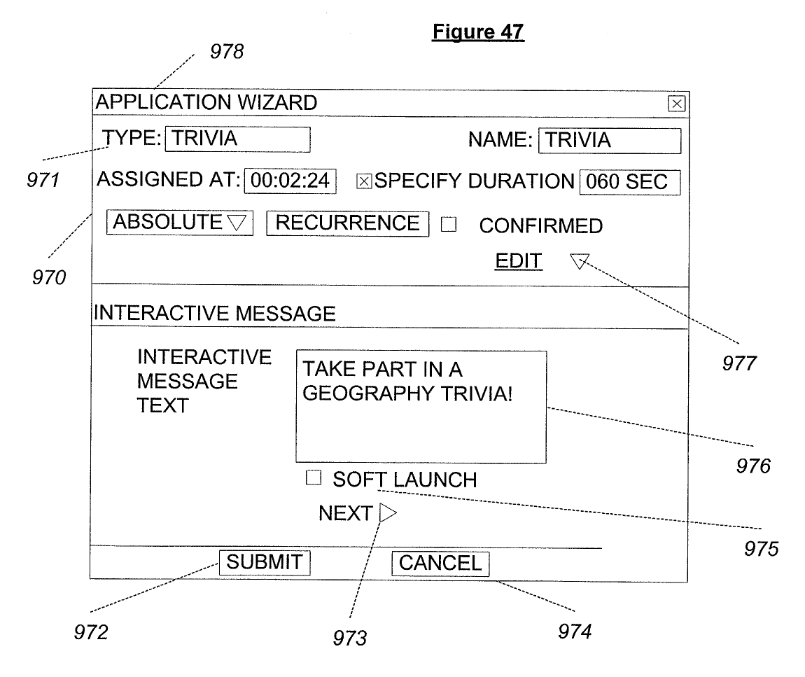

FIG. 47 is a simplified pictorial illustration of a second screen display generated by the editor GUI (graphic user interface) of FIG. 4 when performing an example workflow.

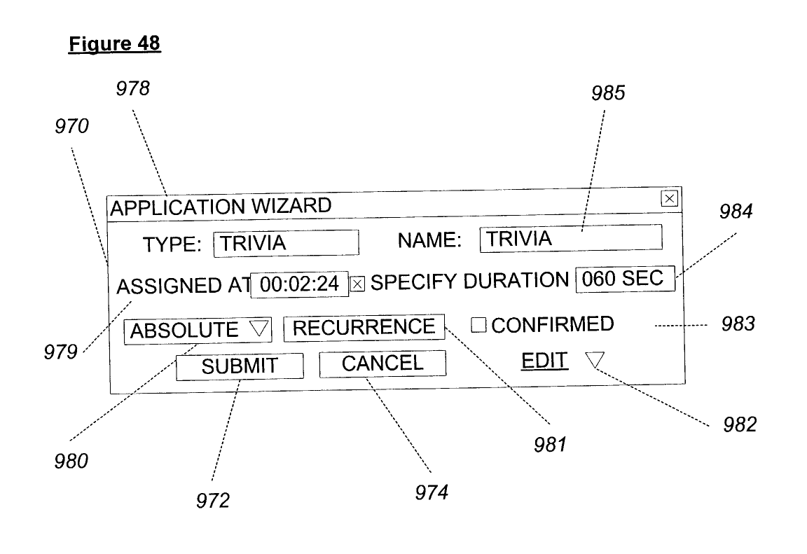

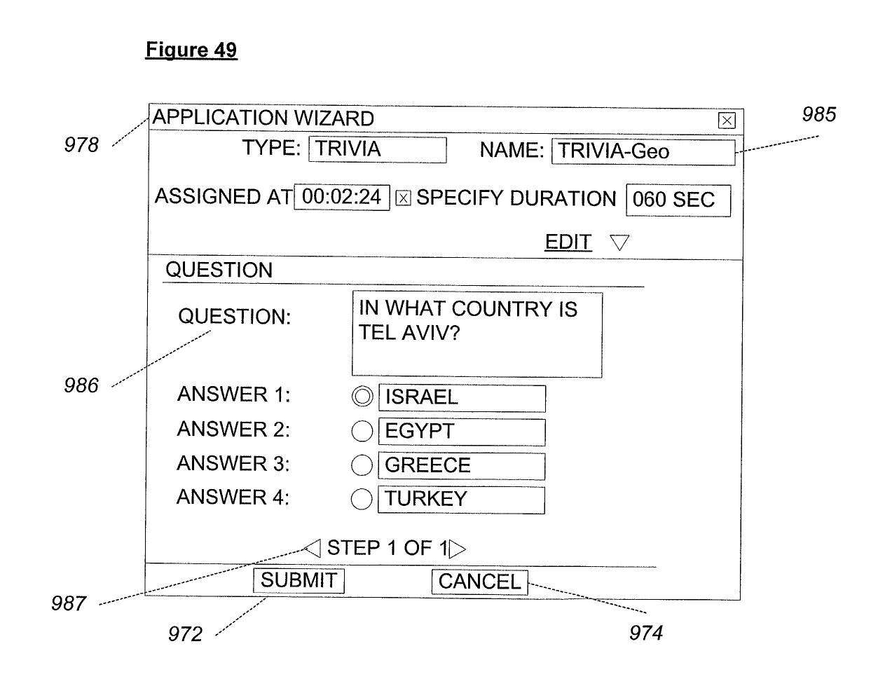

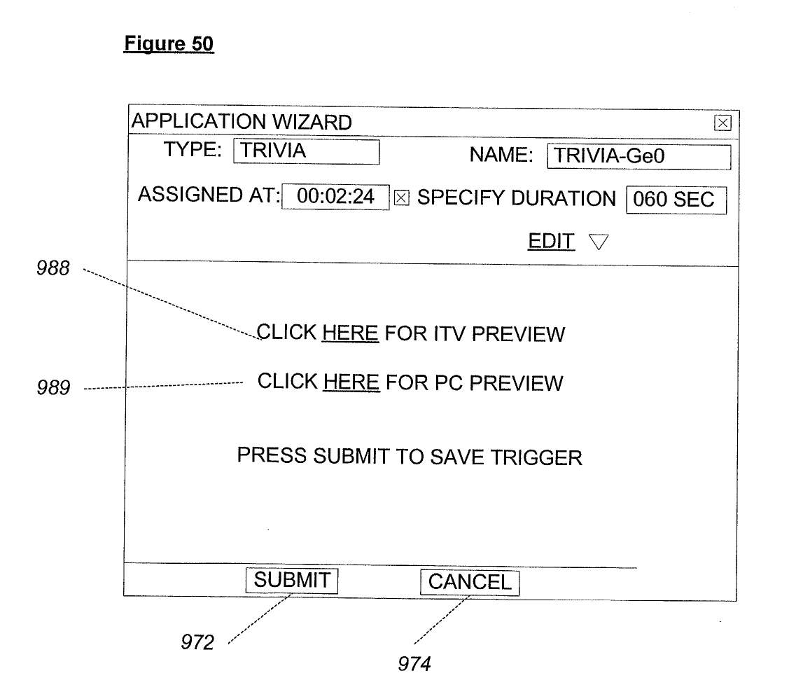

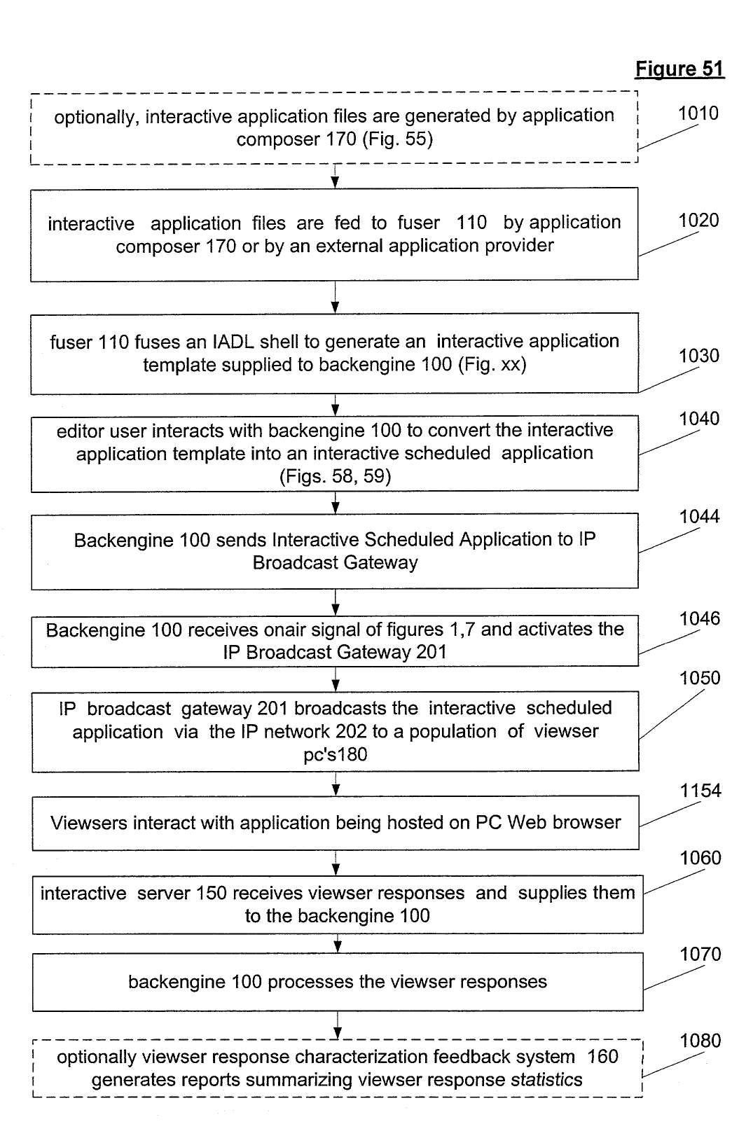

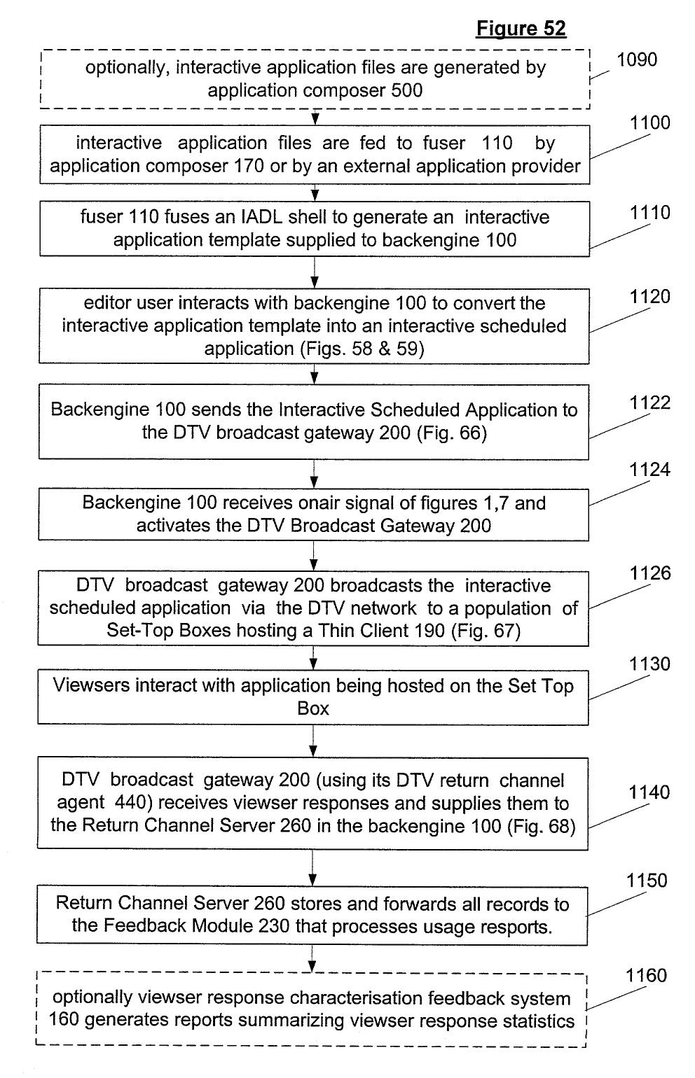

FIG. 48 is a simplified pictorial illustration of a third screen display generated by the editor GUI (graphic user interface) of FIG. 4 when performing an example workflow.

FIG. 49 is a simplified pictorial illustration of a fourth screen display generated by the editor GUI (graphic user interface) of FIG. 4 when performing an example workflow.

FIG. 50 is a simplified pictorial illustration of a fifth screen display generated by the editor GUI (graphic user interface) of FIG. 4 when performing an example workflow.

A typical workflow for the Editor GUI 280 is now described.

For general usage of the Editor GUI 280: Editor-User launches the Editor-GUI 280 software application and defines the ePlaylist window 951's time range 952 (FIG. 46). The editor-user chooses the From/To date and time and clicks Go for submission.

The playlist 951 (FIG. 46) of the chosen date and time range appears, containing the scheduled programs in the program column 954. Increasing or decreasing the level of detail (also termed herein “Zooming in and out”) can be effected using the + and − zoom buttons 956. This action changes the number of min/sec each unit on the time column 955 represents.

The slider 959 allows scrolling along the selected time range and forwards/rewinds the video in the video preview window 969. The broadcast line 960 represents the current time and moves downwards as time passes.

The events column 953 presents the Triggers of interactive applications which were scheduled along the selected time range of the play list, each composed of two parts: an icon 957 which represents the type of the Trigger (e.g. confirmed, recurring, absolute, relative) and the name tag 958 (FIG. 48) of the application which is given by the Editor—User.

An example of how an Editor-User may form an Interactive Scheduled Application from an Interactive Application Template is now described:

The Editor User launches the Editor-GUI 280 software application, defines the ePlaylist window 951's time range 952, chooses the From/To date and time and clicks Go for submission. The Editor User selects a New template from the Template tab 964. The Editor User drags (as in “Drag and Drop” from Microsoft Windows Software) the selection onto an exact time along the Time column 955. The Application wizard (element 978 in FIG. 47) opens automatically.

The Editor User enters application general information and specifically he may Fill out the Name 985 (FIG. 48), Assigned element 979 (date and time that indicate beginning time of the event), and check the “specify duration” checkbox element 984 to limit the application duration (length of time it is available for the Viewser 180) and choose the duration time.

The Confirmed check box 983 is used for authentication purposes and privilege management. A relatively junior Editor-User can assign a non-confirmed application to the ePlaylist in FIG. 46 and a senior Editor-User can confirm it. Only confirmed instances are sent to the Broadcast Gateway 200 and 2001. The Absolute menu 980 (FIG. 48) enables the synchronization of Triggers to the ePlaylist 951 (FIG. 46) in a selectable one of the following two different modes:

1. Relative Time—Triggers that are attached to a program and automatically adjusted to be broadcast at a predetermined time, according to the relative time within the actual program.

2. Absolute Time—Triggers that are assigned to the timeline, regardless of the program being broadcasted.

The Recurrence button (element 981 in FIG. 48) is enabled in both Absolute and Relative time modes.

Absolute Recurrence allows assignment of a Trigger to the Time line based on a recurrence pattern. The recurrence pattern may include seconds, minutes, hours, days and/or weeks. A range may be assigned as well, which can be one of three options: No end date; End after XXX occurrences; or End by DD/MM/YYYY (i.e. assigning a trigger every day at 16:00 that broadcasts a Promo for the Evening News.

Relative Recurrence Triggers may be attached to a program in a relative trigger mode (may be attached to a relative time within the actual program) and are typically automatically reassigned each time the program is re-broadcasted. Recurrent relative Triggers may be limited by a number of recurrences or by a range of dates.

Other Editor-User functions displayed in FIGS. 46-50 include:

For entering an Interactive message: Editor User fills out the interactive message text 976 (FIG. 47), checks the Soft Launch checkbox 975 to determine if the application should initially appear on the TV screen as a small icon (clicking it invokes the interactive message), and leaves it unchecked if the application should send the full Interactive Application directly.

For Entering application relevant data fields: “step X of X” element 987 (FIG. 49) gives the Editor User an indication of the phases left for the completion of the editing process (i.e. step 1 of 1 in trivia application). The Editor User typically types the text for the question of the example—trivia (element 986 in FIG. 49), fills in the text of the possible answers and checks the radio button of the right answer.

For preview of a created Action or Instance: Click “Preview iTV” (element 988 in FIG. 50) to preview the application as it will be shown on the TV set. Click “Preview PC” (element 989 in FIG. 50) to preview the application as it will be shown on a PC screen.

For submitting an application to broadcast—Creating an Instance: In the application wizard 978 in FIG. 47, click Submit element 972 in FIG. 47) to save the created Action in the BackEngine database 240 or if was assigned to the eplaylist 951 in FIG. 46, or click Cancel (element 974 in FIG. 47) to exit the application wizard in which case typically all data entered will be lost.

For storing an application in the database—Creating a Action: Editor User double clicks an Application Template 963 (FIG. 46) in the Templates tab 964 (FIG. 46) and completes the authoring process in the same manner as described above. Saving it creates an Action which is saved in the BackEngine database 240 and displayed in the Action tab element 965 in FIG. 46 for future use.

An example of how an Editor-User may form an Interactive Scheduled Application from an existing Action stored on the BackEngine Database 240 is now described:

The Editor User launches Editor-GUI 280 software application and defines the ePlaylist window 951 (FIG. 46) time range 952, chooses the From/To date and time and clicks Go for submission.

The Editor User selects an existing Action from the Actions tab 965. The Editor User checks the Filters Box 968 tin to effect a refined search for specific Actions in the Actions tab 965. The View menu 967 in FIG. 46 enables the view of specific types of interactive applications in the actions tab 965 in FIG. 46.

The Editor User drags the selection into an exact time along the Time column 955 (FIG. 46). The Application wizard 951 automatically opens up in a partial mode.

The Editor User may edit the Name 985 (FIG. 48), Assigned at date and time that indicates beginning time of the application (element 979, and checks the Specify duration checkbox 984 to limit the application's duration and choose the duration time. A confirmed trigger 983 and an absolute trigger 980 are shown in FIG. 48 and recurrence is shown in element 981 in FIG. 48.

The rest of the process may be as described above, in the Interactive Application Template section.

An alternative way for the Editor-User to create and instance is now described. The Editor User may elect an alternative way of assigning a Template Interactive Application to time by placing the slider 959 (FIG. 46) at the desired time of synchronization on the ePlaylist timeline 951 and choosing Insert Event from the Events menu 961. This invokes the opening of an application wizard 978 (FIG. 48. The Editor can then drag a new template from the templates tab 964 (FIG. 46) or an existing template from the Actions tab 965 and complete the editing process as described above. Once the editing process is completed, clicking Submit (element 972 in FIG. 50) assigns the application to the point indicated by the slider 959 (FIG. 46) along the ePlaylist timeline 955 (FIG. 46) and thus creates an instance in the BackEngine Database 240. the Editor-User creates an instance in real-time of broadcast (Online mode).

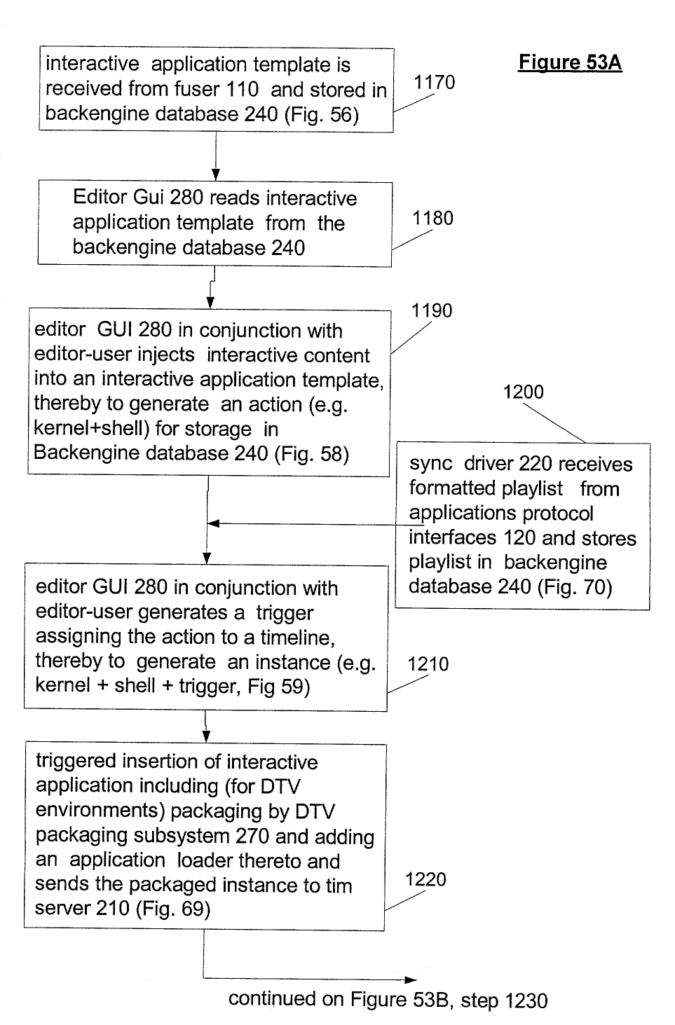

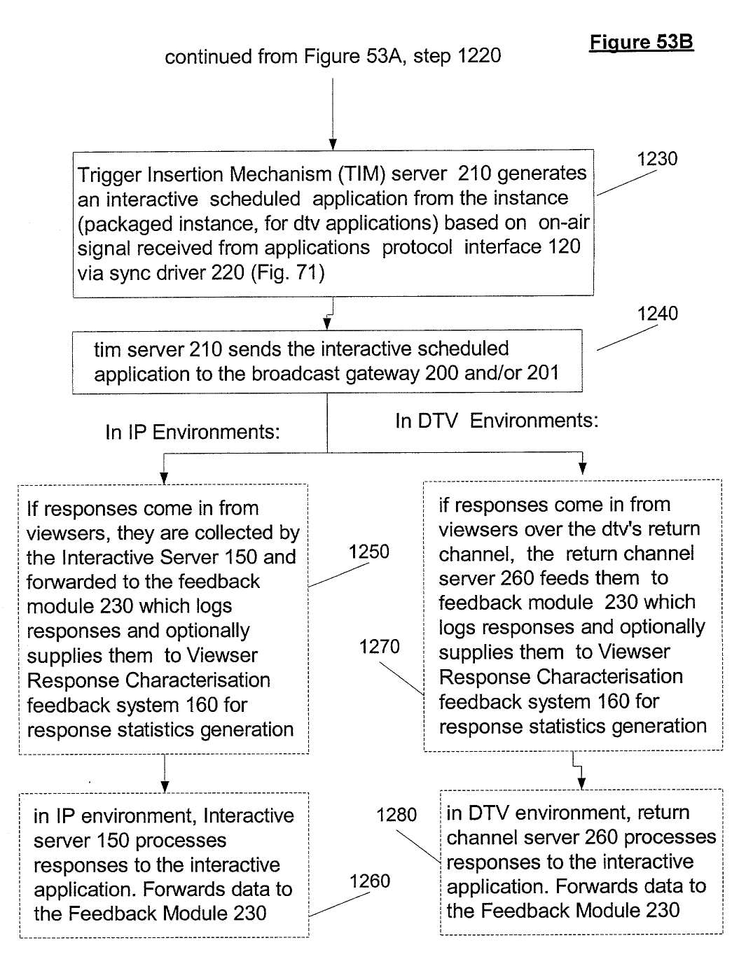

The Editor User chooses “Insert Immediate Event” from the Events menu 961 (FIG. 46). This invokes the opening of an application wizard 978 in FIG. 48. The Editor User then drags a new template from the templates tab 964 (FIG. 46) of the repository 968 or an existing template from the Actions tab 965 of the repository 968 and then completes the editing process as described above. Once the editing process is completed, clicking Submit (element 972 in FIG. 50) assigns the application to the point indicated by the slider 959 (FIG. 46) along the ePlaylist timeline 955 and thus create an instance in the BackEngine Database 240. The TIM server 210 receives a notification of an “immediate event” and sends the instance to the broadcasting process 1230 in FIG. 53B.

FIG. 51 is a simplified flowchart illustration of a preferred method of operation for the system of FIG. 1.

FIG. 52 is a simplified flowchart illustration of a preferred method of operation for the system of FIG. 2.

FIGS. 53A-53B, taken together, form a simplified flowchart illustration of a preferred method of operation for the BackEngine of FIGS. 1, 2 and 4.

Knowledgebase 250 of FIG. 4 is used by DTV Packaging Subsystem 270 to translate interactive template applications from IADL into target platform code. Conventionally, external application providers particularly in DTV environments such as an OpenTV environment, provide applications in a target platform code i.e. code understandable by a target platform such as the external broadcast operator's data carousel of FIG. 2. According to a preferred embodiment of the present invention, interactive template applications may be received from an external applications provider in target platform code, are typically wrapped, by fuser 110 of FIG. 2, in an IADL shell for processing by the BackEngine 100.

FIG. 54 is a diagram showing a typical life-cycle of a modular interactive application in accordance with a preferred embodiment of the present invention.

FIG. 55 is a simplified flowchart illustration of a preferred method by which application composer 170 of FIGS. 1 and 6 performs the interactive application file generation step 1010 of FIG. 51;

FIG. 56 is a simplified flowchart illustration of a preferred method by which fuser 110 of FIGS. 1 and 9 performs the interactive application template generation step 1030 of FIG. 51.

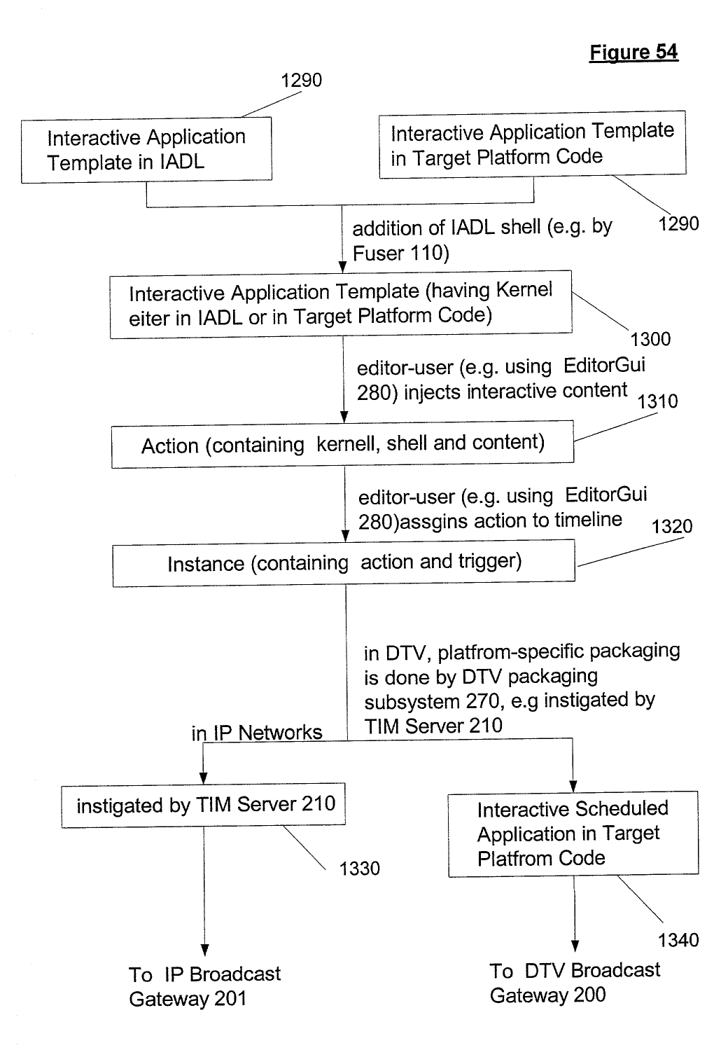

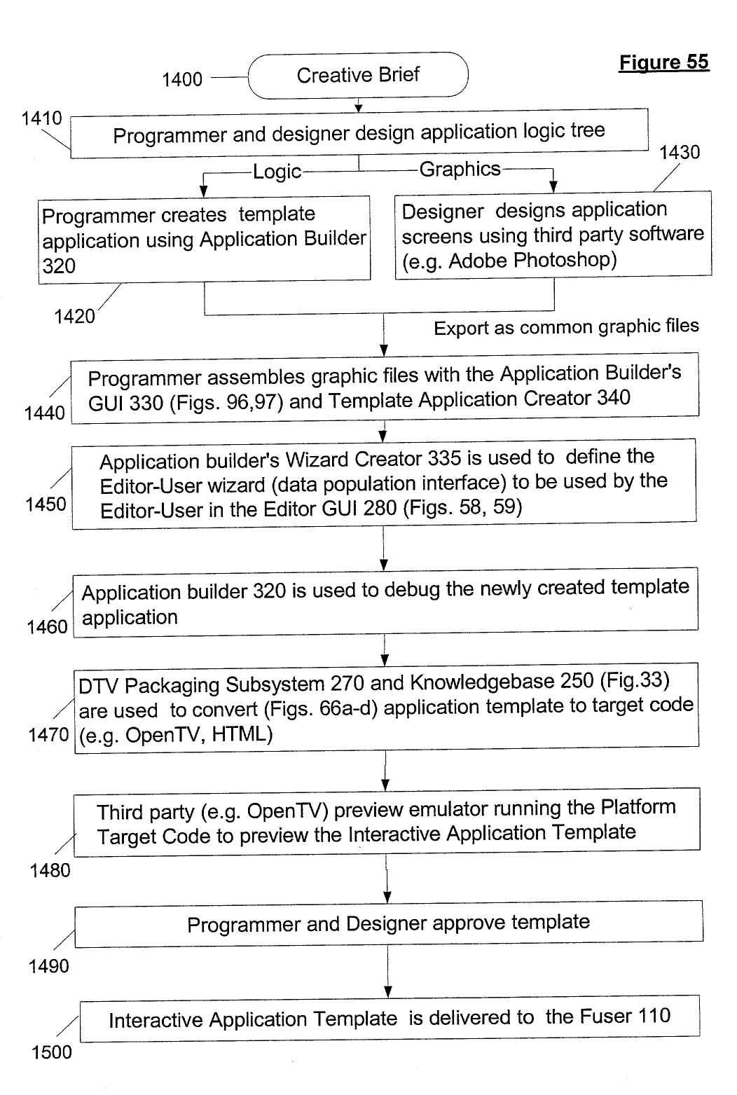

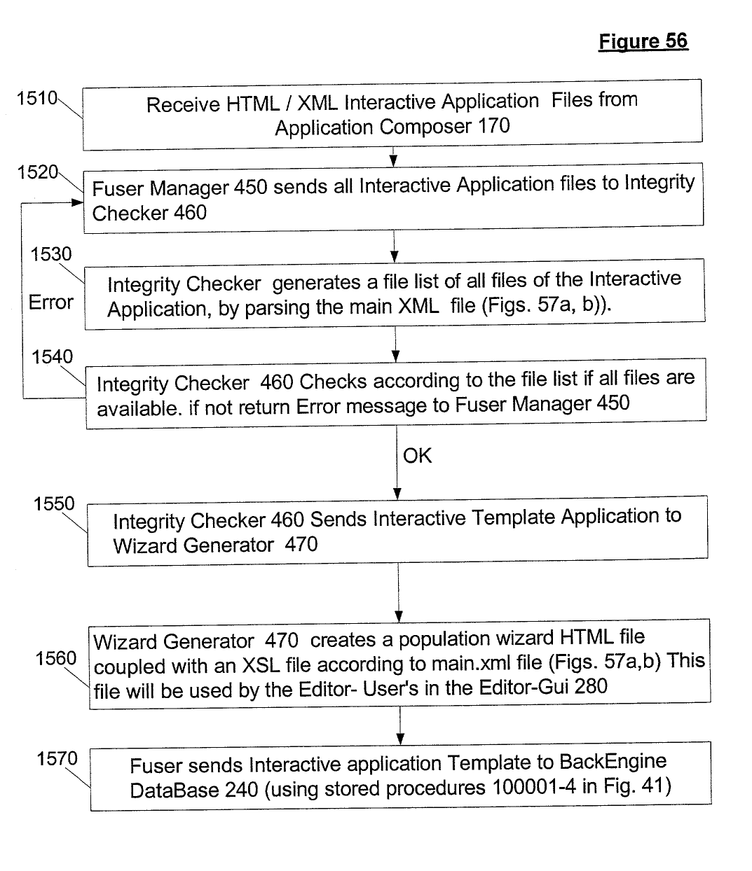

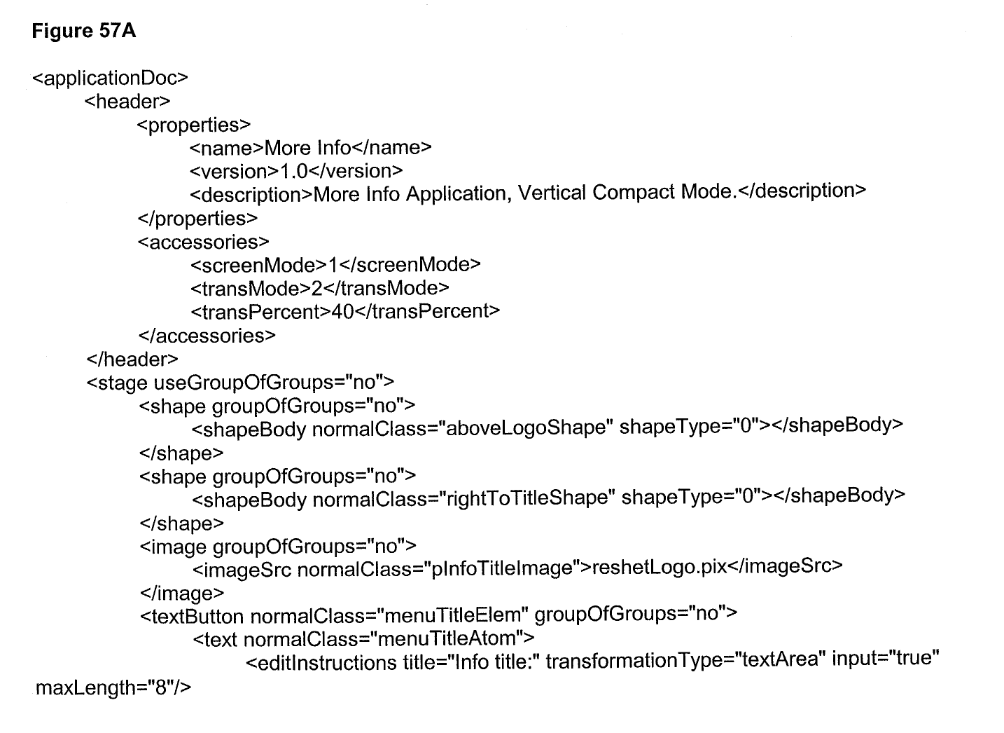

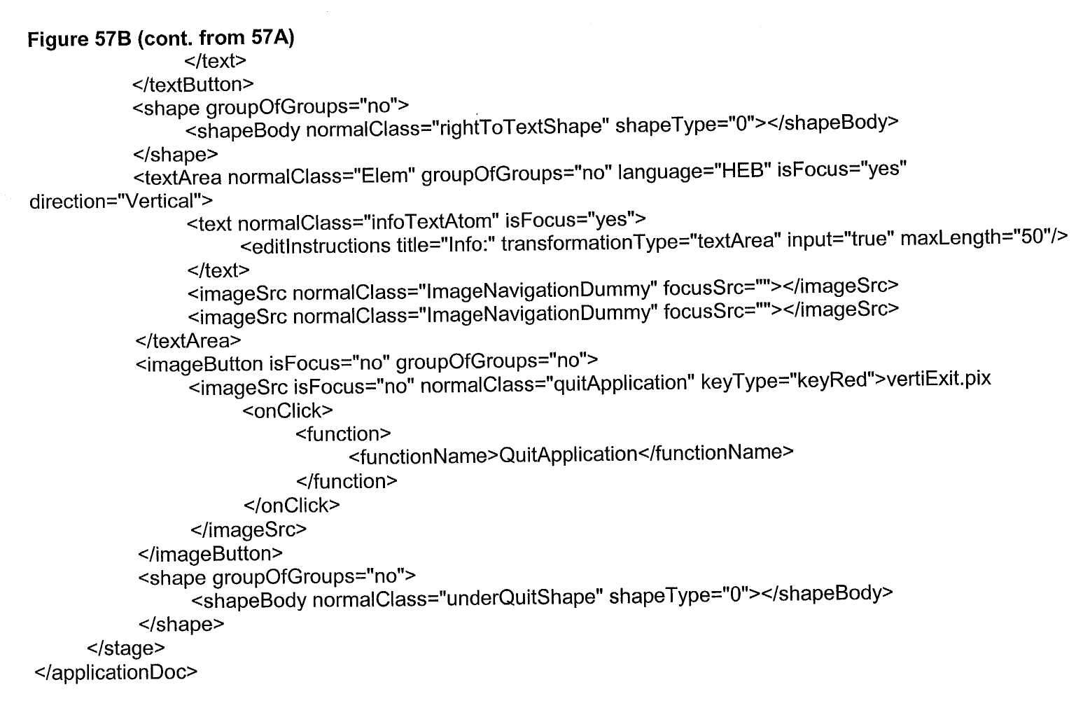

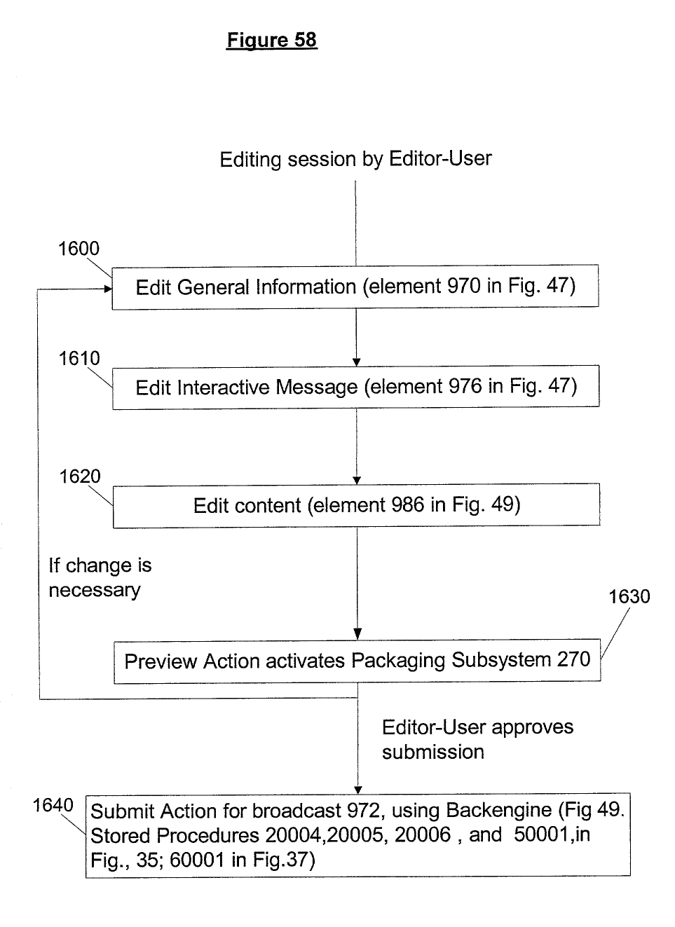

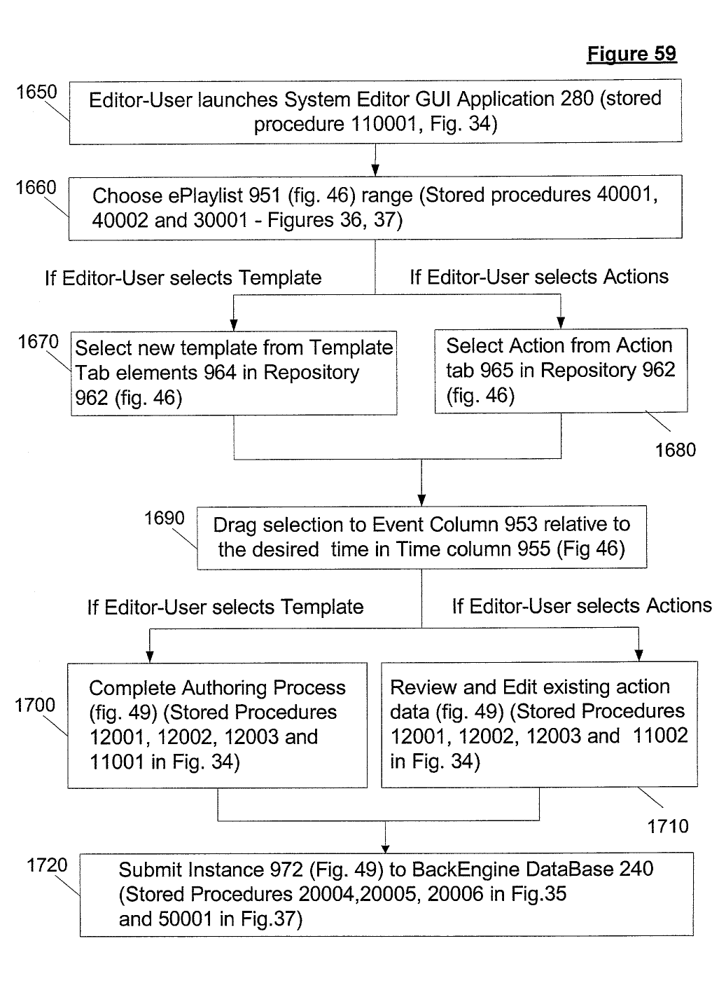

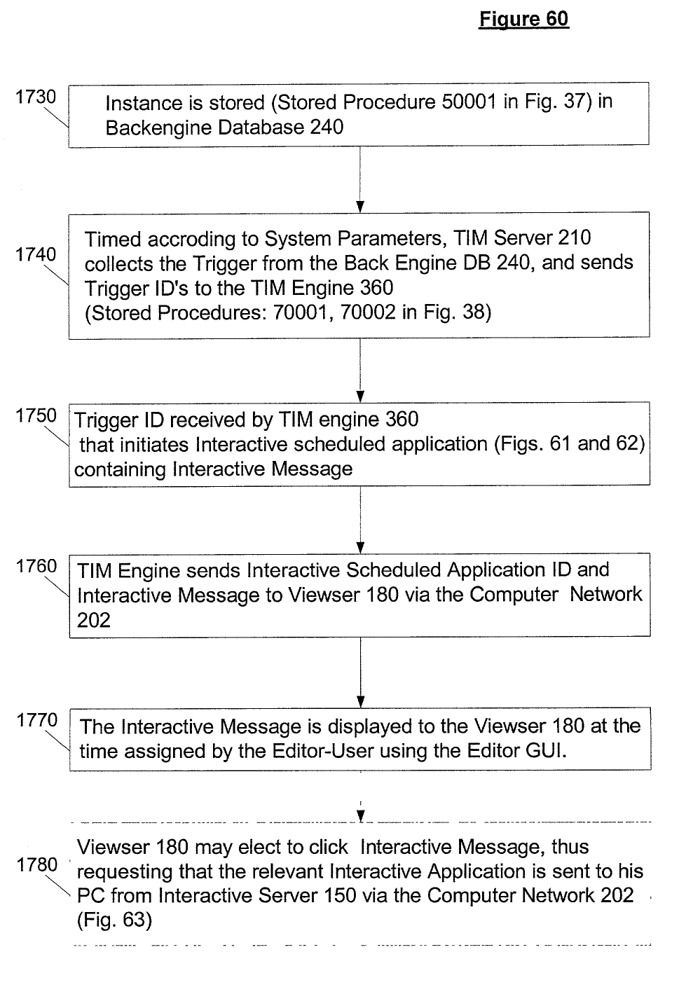

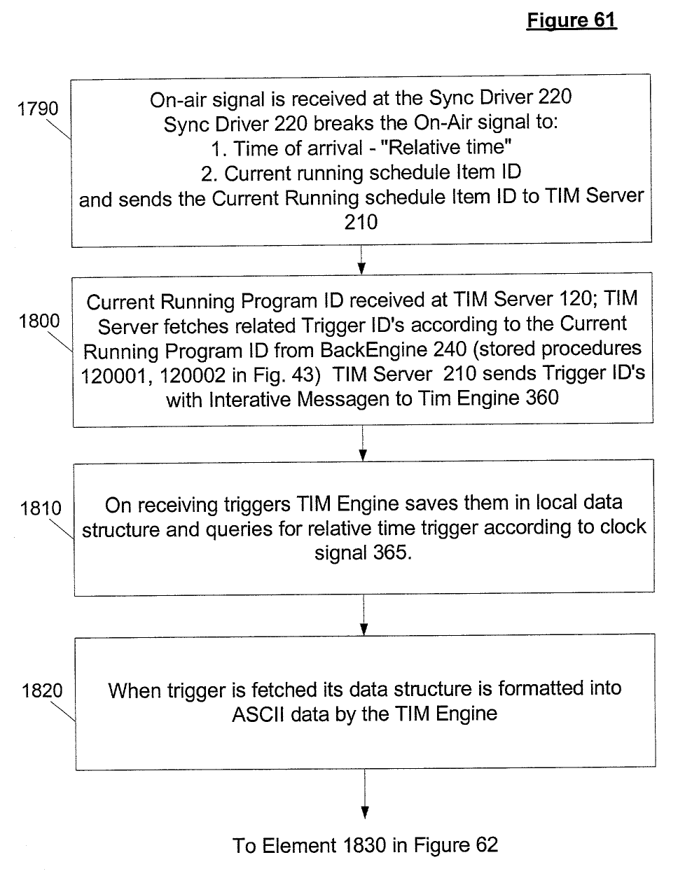

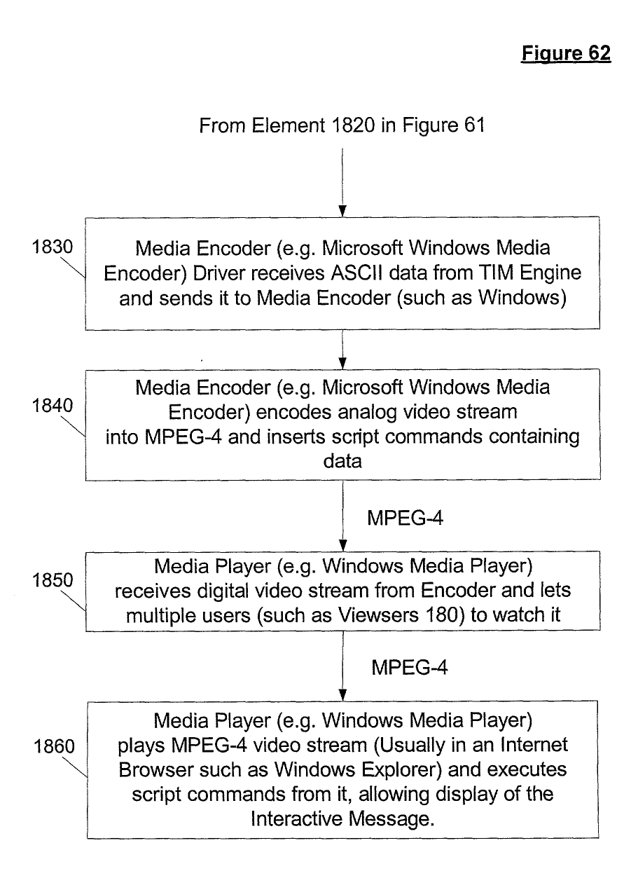

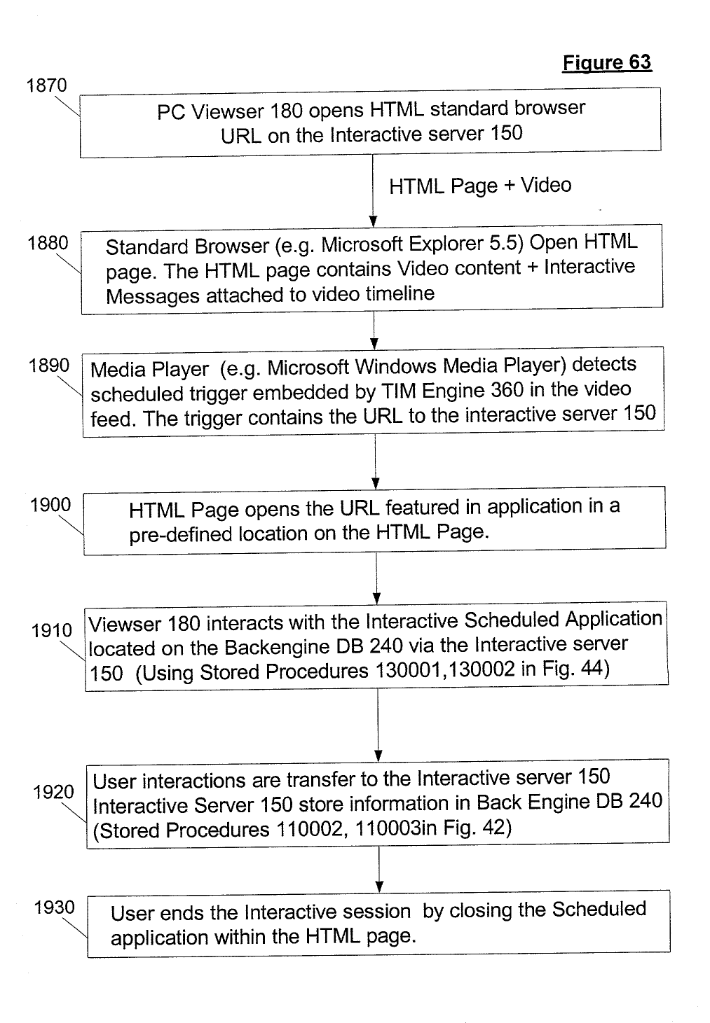

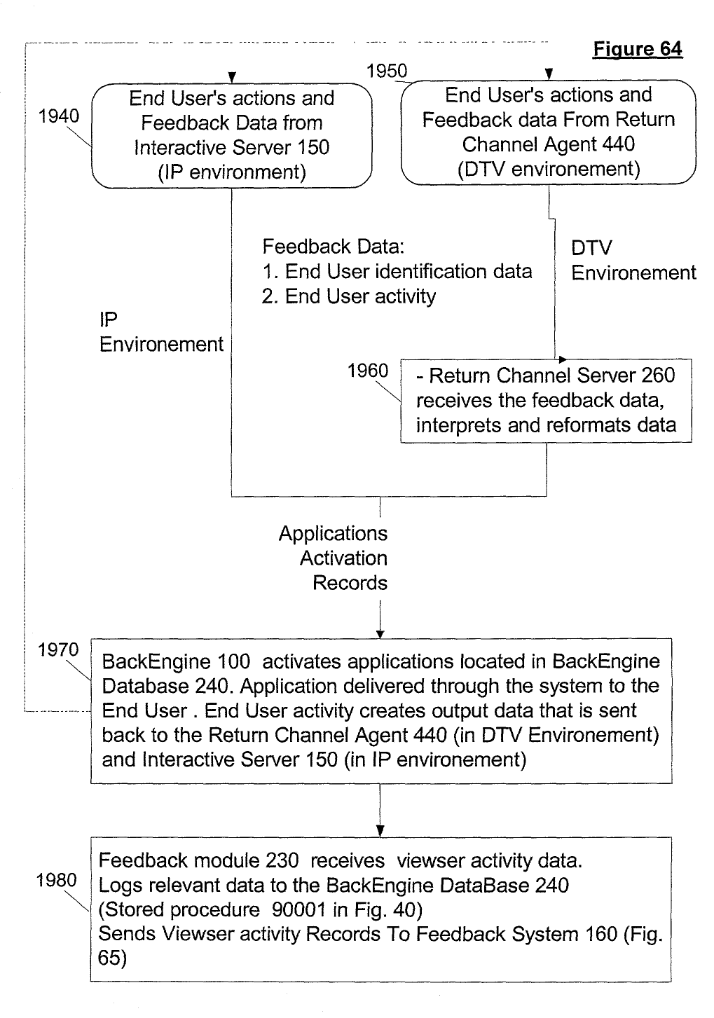

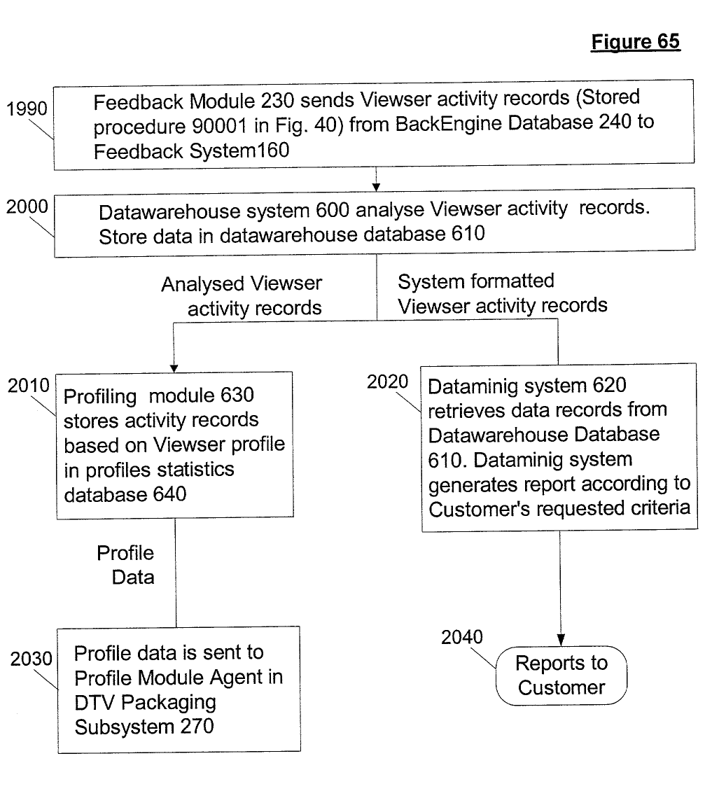

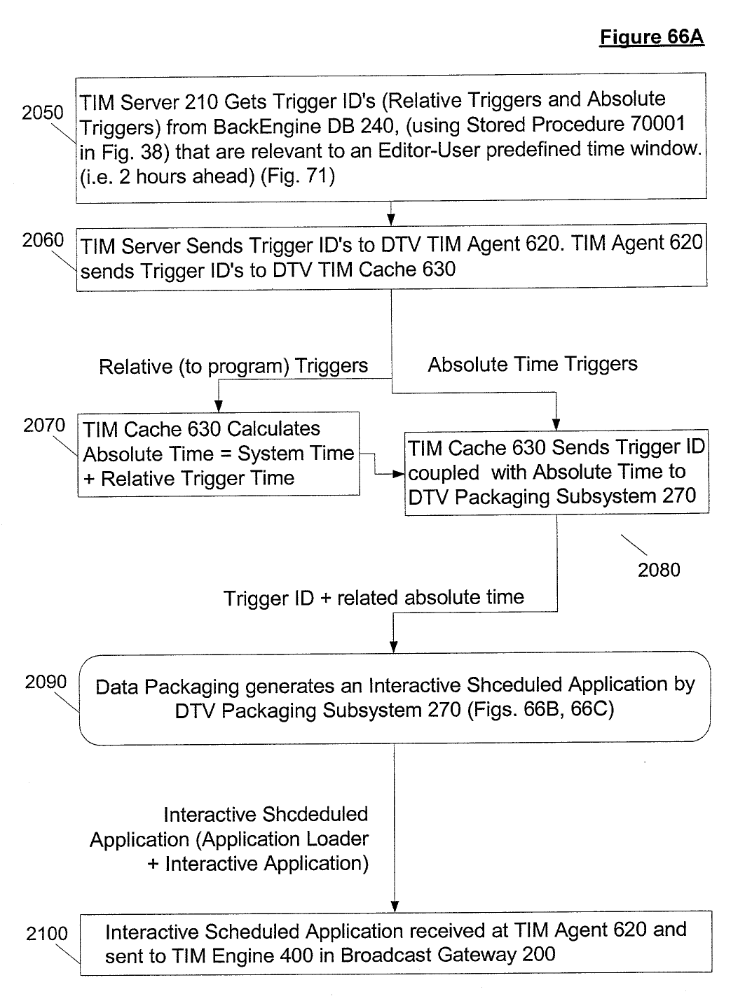

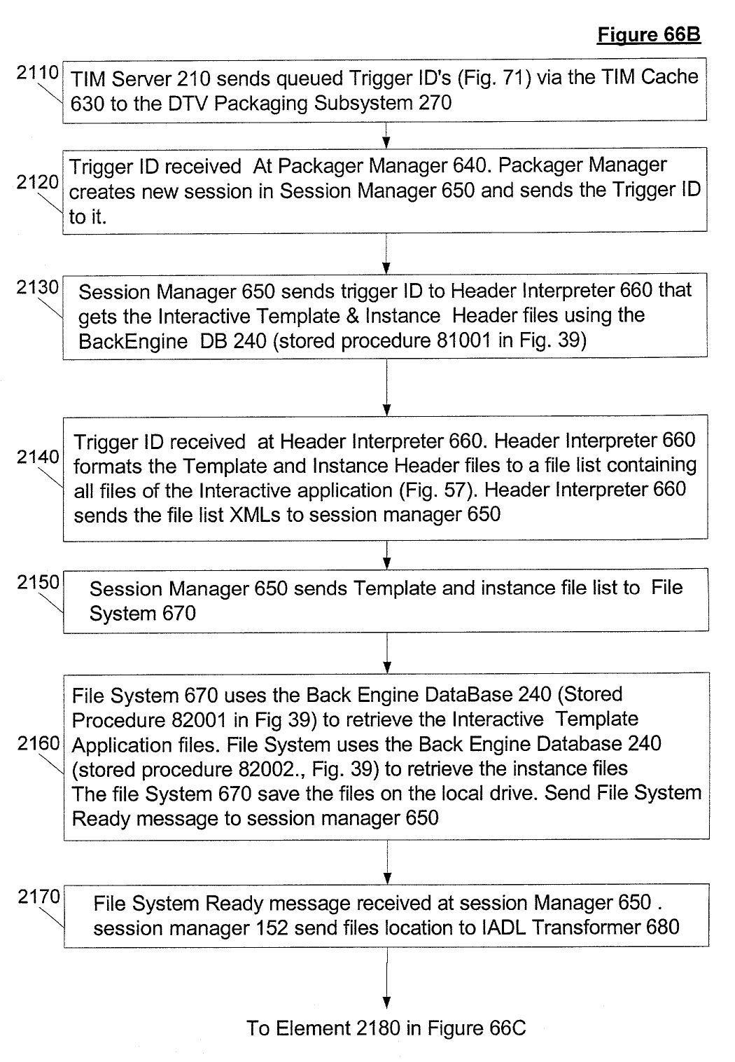

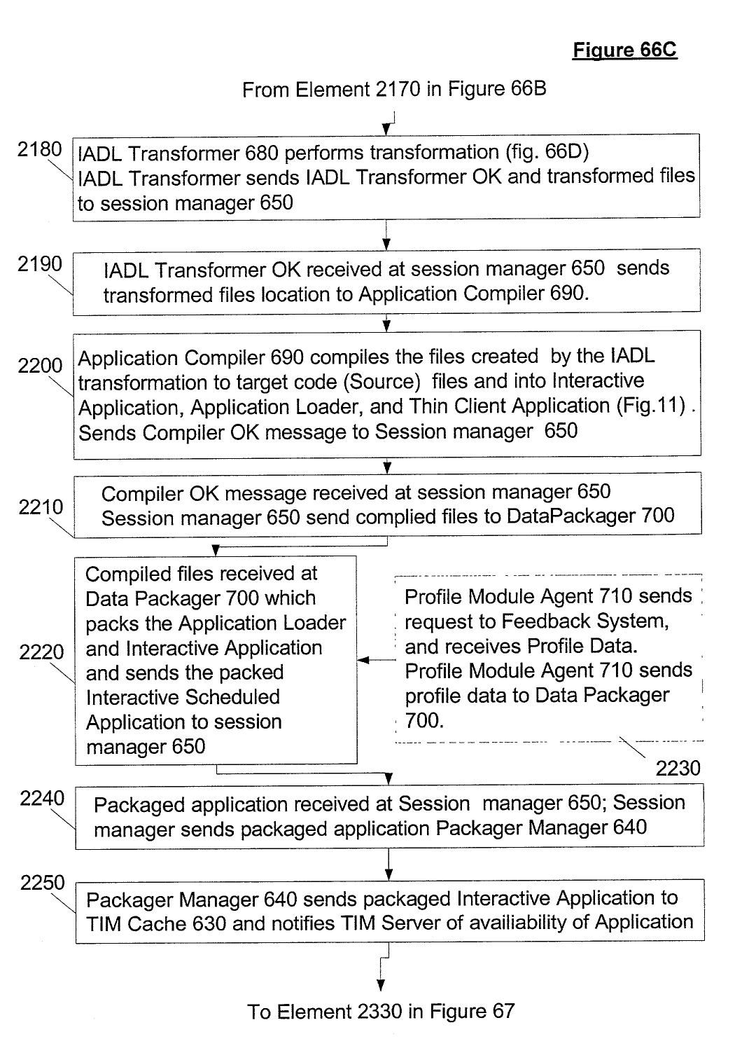

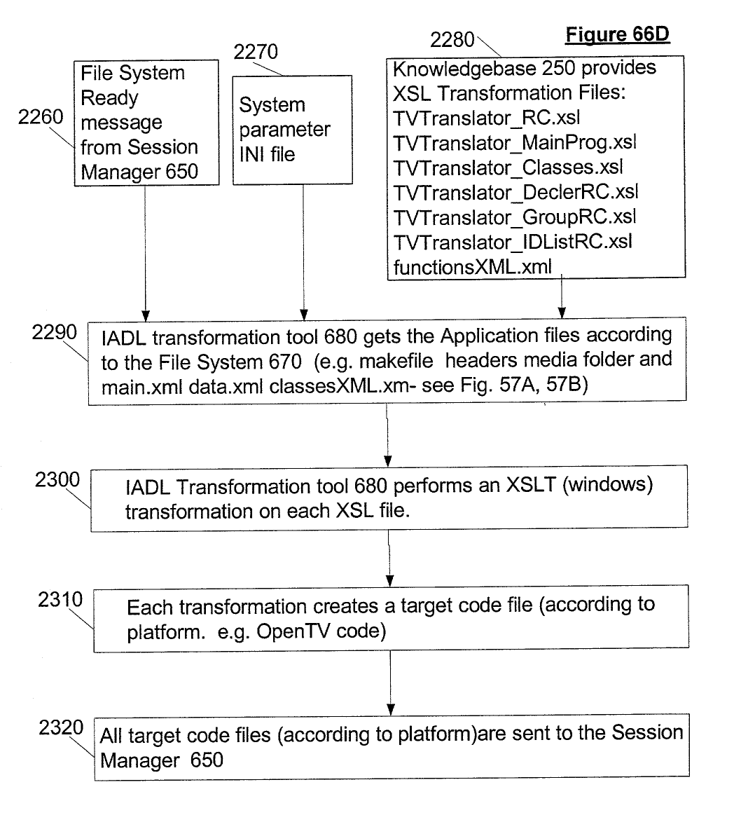

FIGS. 57A-57B, taken together, form an example of a main.XML file that describes the syntax of any interactive application file generated by the application composer 170.

FIG. 58 is a simplified flowchart illustration of a preferred method whereby the editor GUI 280 in BackEngine 100 of FIGS. 1 and 4 perform a first part of the interactive scheduled application generation step 1040 of FIG. 51, corresponding to content injection step 1190 in FIG. 53A.

FIG. 59 is a simplified flowchart illustration of a preferred method whereby the editor GUI 280 in BackEngine 100 of FIGS. 1 and 4 perform a second part of the interactive scheduled application generation step 1040 of FIG. 51, corresponding to assignment to timeline step 1210 in FIG. 53A.

FIG. 60 is a simplified flowchart illustration of a preferred method whereby the BackEngine of FIGS. 1 and 4 performs the interactive scheduled application step 1044 of FIG. 51.

FIG. 61 is a simplified flowchart illustration of a preferred method whereby the BackEngine 100 of FIGS. 1 and 4 performs the on-air signal receiving step 1046 of FIG. 51.

FIG. 62 is a simplified flowchart illustration of a preferred method whereby the IP broadcast gateway 201 of FIGS. 1 and 7 performs the interactive scheduled application broadcasting step 1050 of FIG. 51.

FIG. 63 is a simplified flowchart illustration of a preferred method whereby the viewser 180 uses his PC to generate a viewser response which is subsequently processed by the system of the present invention in steps 1060 and 1070 of FIG. 51. The interface described by the flowchart of FIGS. 62 and 63 operates in a suitable environment which typically includes the following components: a browser such as Netscape Explorer, a media player such as Windows Media Player, an operating system such as Windows XP, and a suitable communication driver to the network such as the 3Com Type M Modem.

Referring again to FIG. 2, the destination of the sequence of scheduled interactive applications is a population of television systems including a conventional television set, a conventional set-top box such as a Digibox set-top box marketed by Pace Micro Technology, Victoria Road, Saltaire, Shipley, West Yorkshire BD183LF, UK, and suitable middleware running in the set-top box, such as OpenTV middleware marketed by OPENTV Corp. 401 East Middlefield Road, Mountain View Calif. 94043, USA. Each scheduled interactive application arriving at each television system's set-top box typically includes a “thin-client” wrapper program wrapped around interactive application logic. Preferably, the sequence of scheduled interactive applications is forwarded to the population of television systems via an external broadcast operator equipped with a suitable forwarding mechanism such as data carousel software e.g. OpenStreamer marketed by OpenTV. When the scheduled interactive application arrives at the set-top box the set-top box typically initially interacts with the “thin-client” wrapper program rather than with the interactive application logic. The “thin-client” wrapper program activates the interactive application and manages its communication with its environment as described in FIG. 11.

FIG. 64 is a simplified flowchart illustration of a preferred method whereby the BackEngine 100 of FIGS. 1 and 4 performs the viewser response processing step 1070 of FIG. 51.

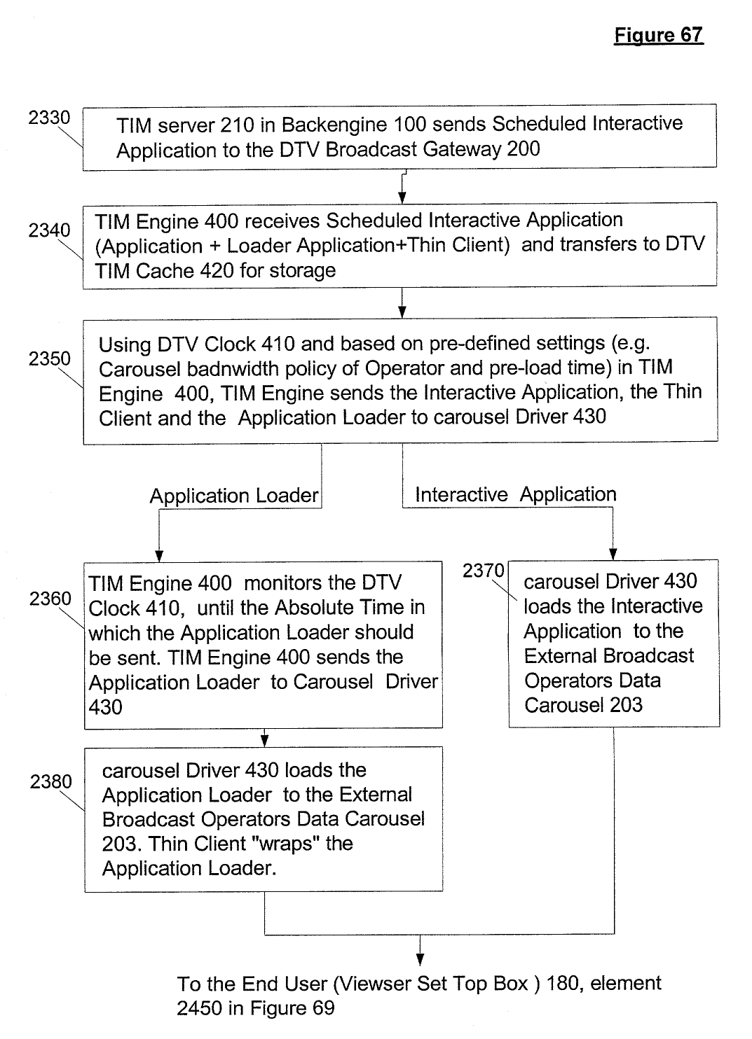

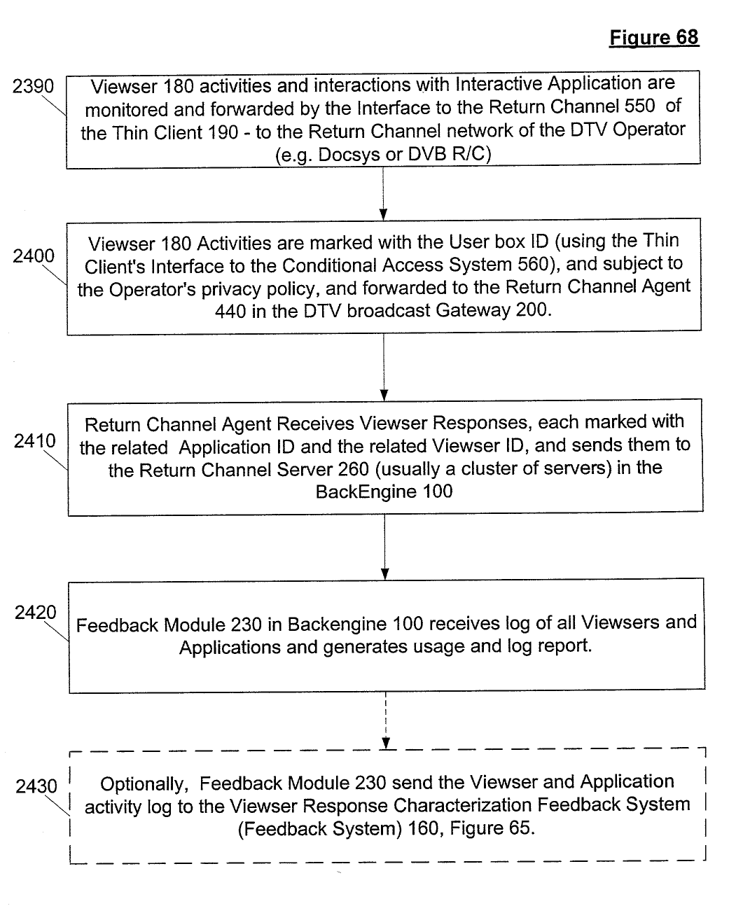

FIG. 65 is a simplified flowchart illustration of a preferred method whereby the feedback system 160 of FIGS. 1 and 12 performs the viewser response statistics reporting step 1080 of FIG. 51.

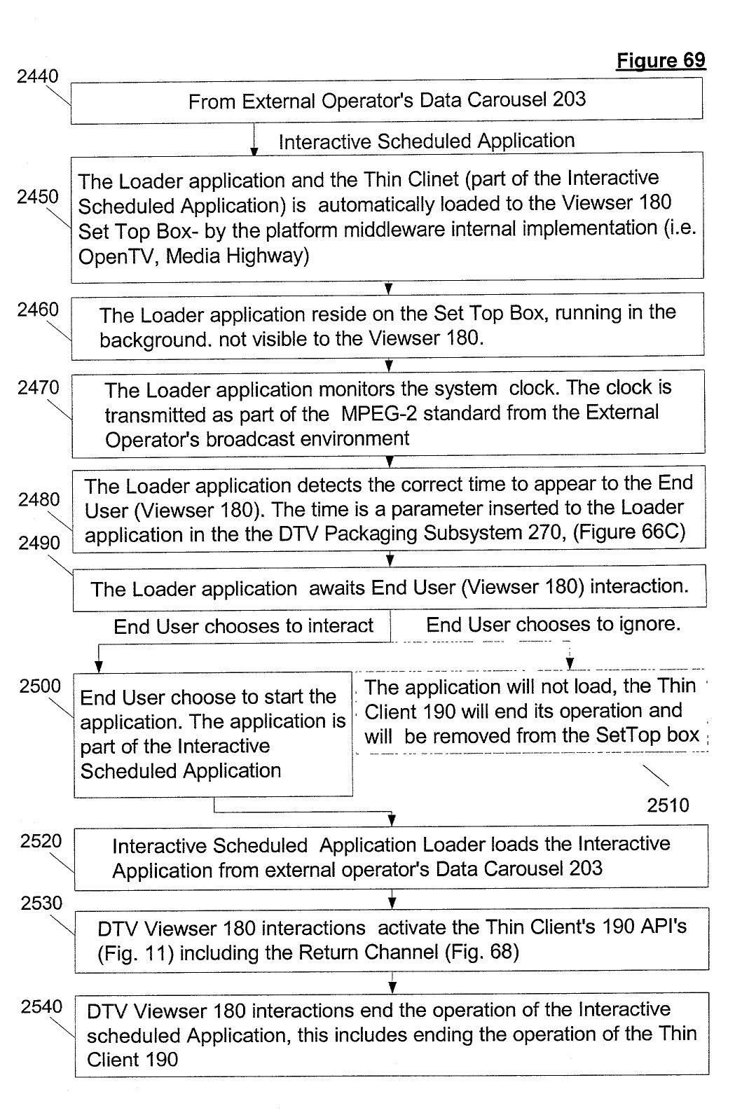

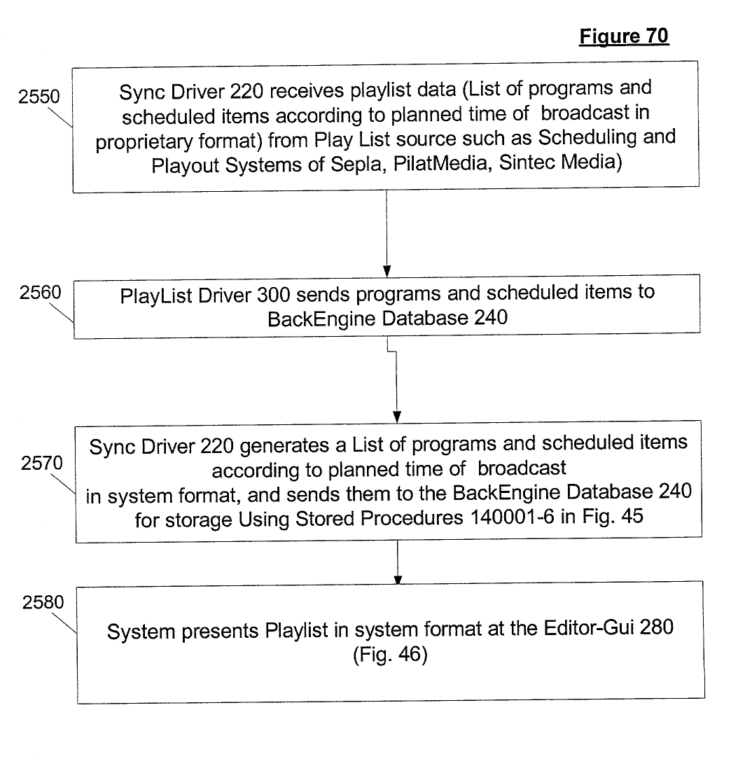

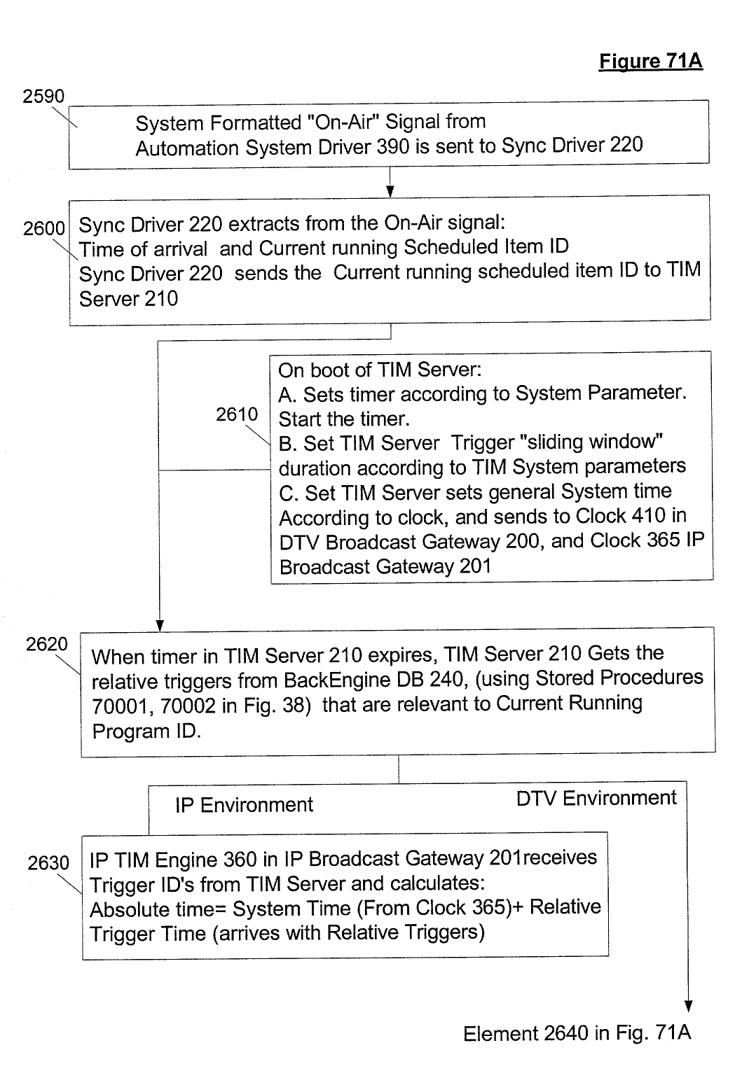

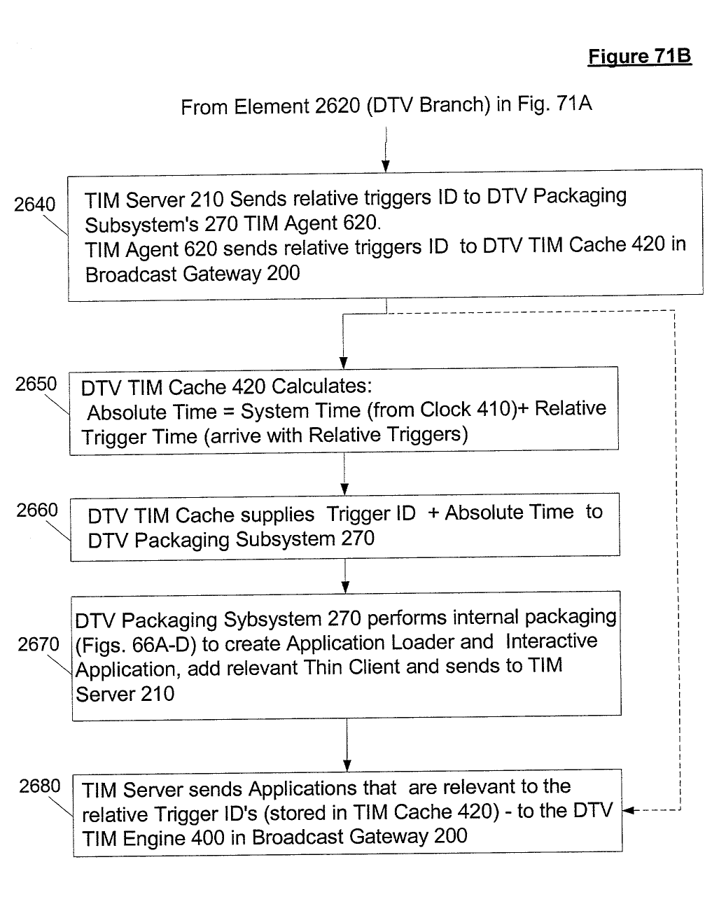

FIG. 66A is a simplified flowchart illustration of a preferred method whereby the BackEngine of FIGS. 2 and 4 performs the interactive scheduled application sending step 1124 of FIG. 52.

FIGS. 66B-66C, taken together, form a simplified flowchart illustration of a preferred method whereby the DTV packaging subsystem 270 of FIGS. 4 and 13 performs the DTV packaging step in the method of FIG. 66A, thereby to generate a packaged instance.

FIG. 66D is a simplified flowchart illustration of a preferred method of operation for the IADL transformer 680 of FIG. 13.

FIG. 67 is a simplified flowchart illustration of a preferred method whereby the DTV broadcast gateway 200 of FIGS. 2 and 8 performs the interactive scheduled application broadcasting step 1130 of FIG. 51.

FIG. 68 is a simplified flowchart illustration of a preferred method whereby the DTV broadcast gateway 200 of FIGS. 2 and 8 performs the viewser response receiving step 1140 of FIG. 52.

FIG. 69 is a simplified flowchart illustration of a preferred method whereby the viewser uses interactive application digital TV interface software typically residing within his set-top box according to a preferred embodiment of the present invention, to generate a viewser response which is subsequently processed by the system of the present invention in steps 1140 and 1150 of FIG. 52.

FIG. 70 is a simplified flowchart illustration of a preferred method whereby the sync driver 220 of FIG. 4 performs the playlist processing step of FIG. 53A whereby the playlist is prepared for display by GUI 280 of FIG. 4.

FIGS. 71A-71B, taken together, form a simplified flowchart illustration of a preferred method whereby the trigger insertion mechanism server 210 of FIG. 4 performs the interactive scheduled application generation step of FIG. 53B.

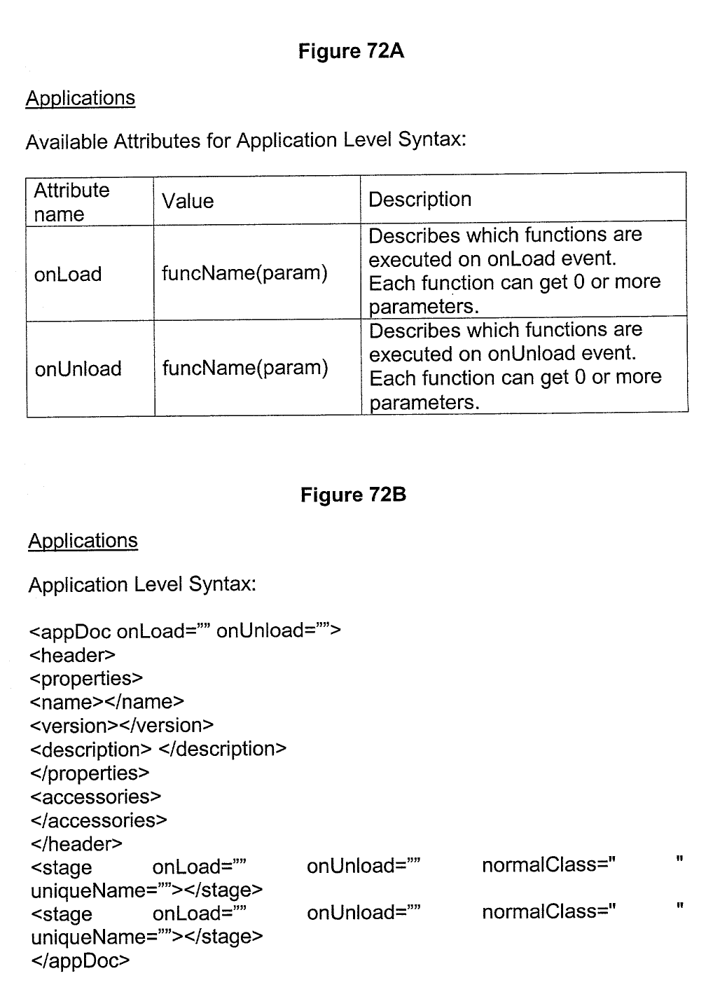

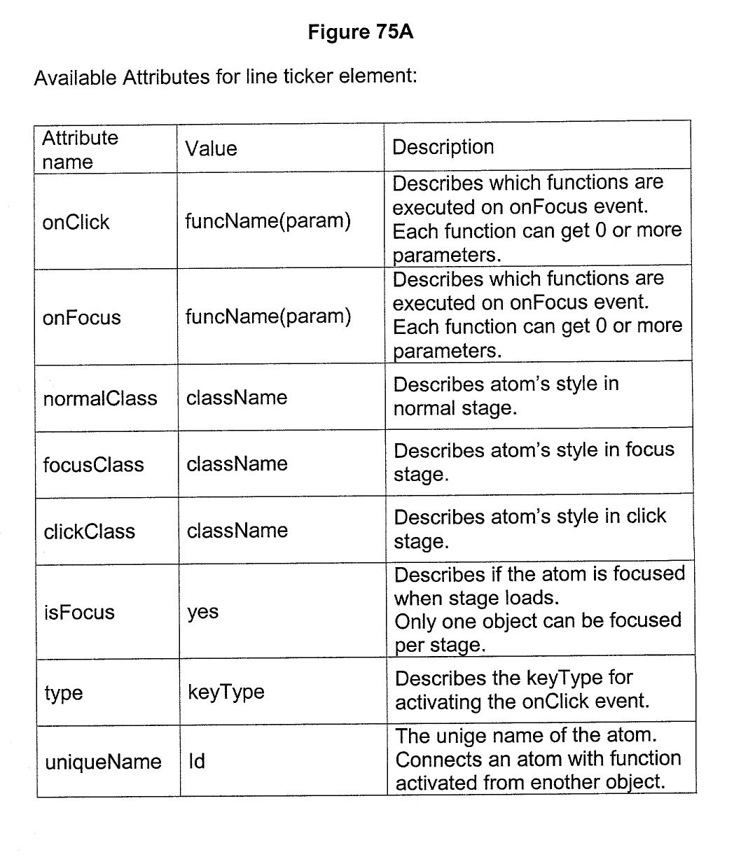

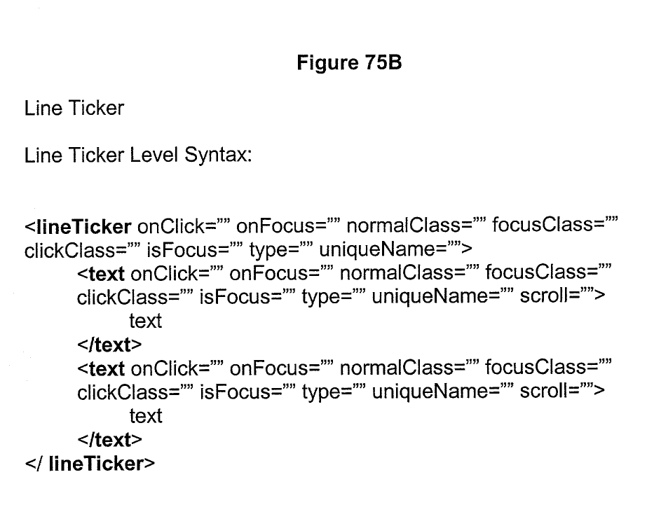

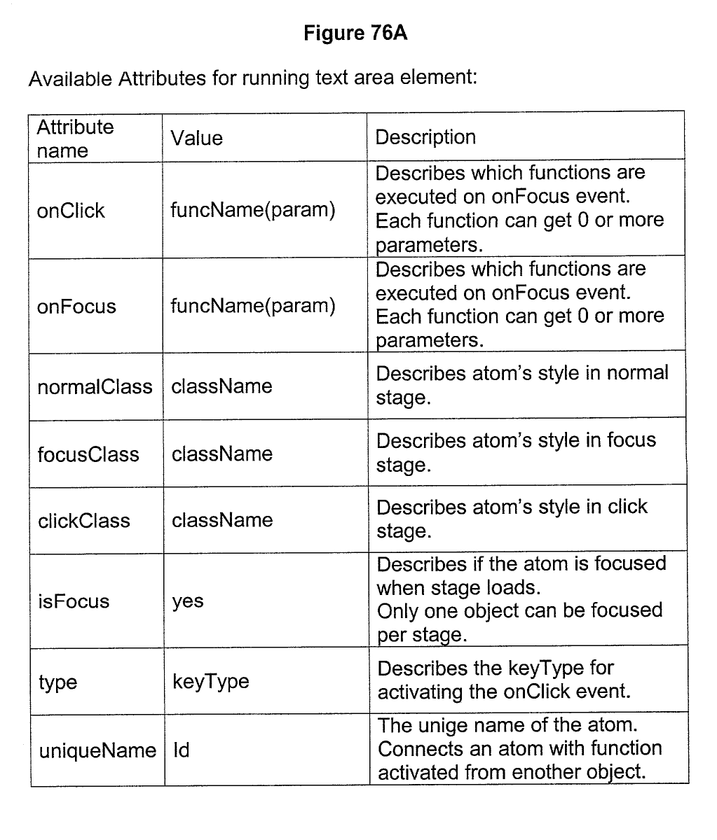

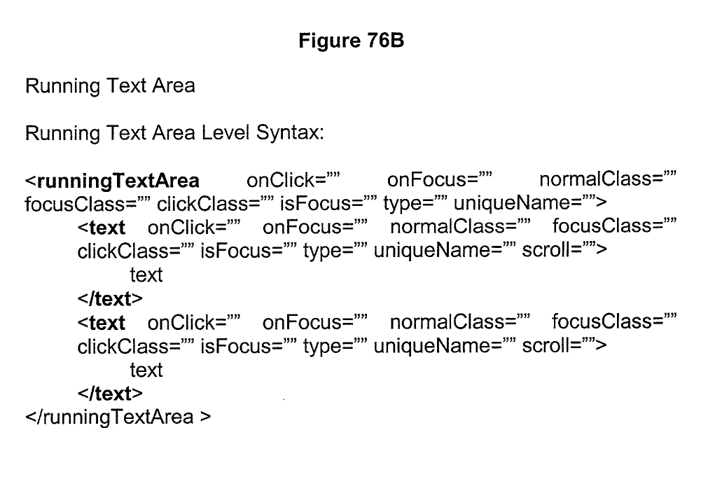

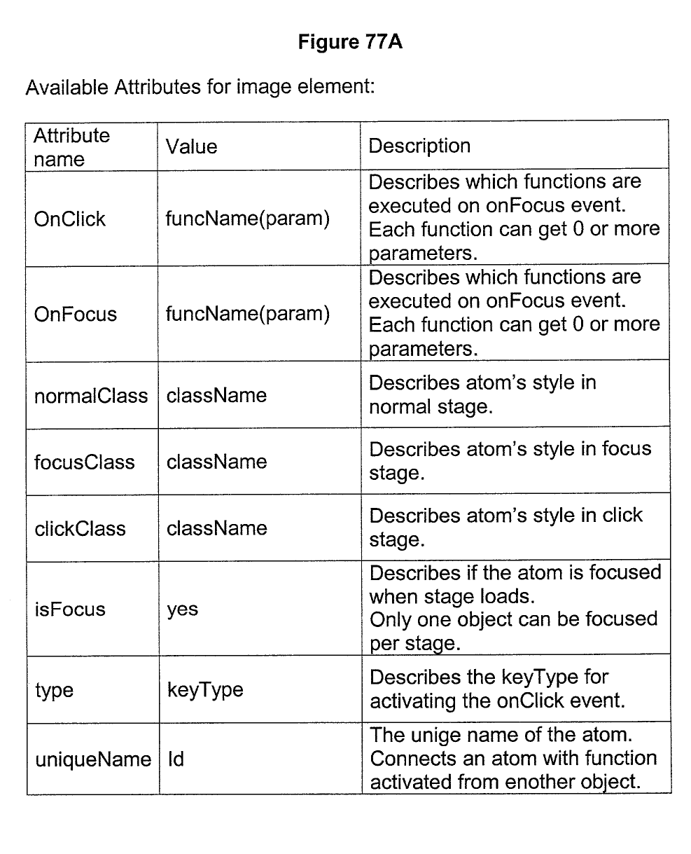

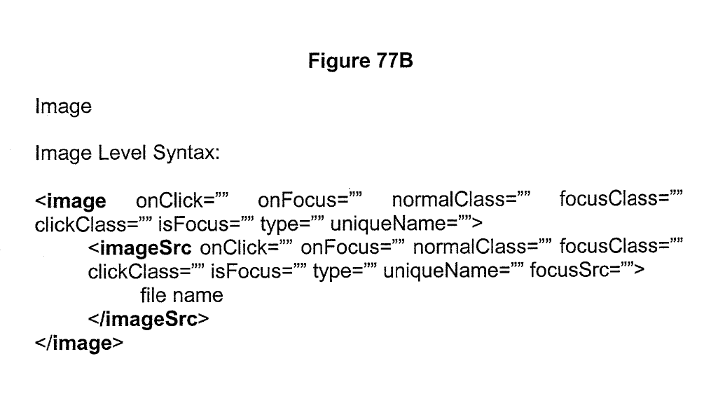

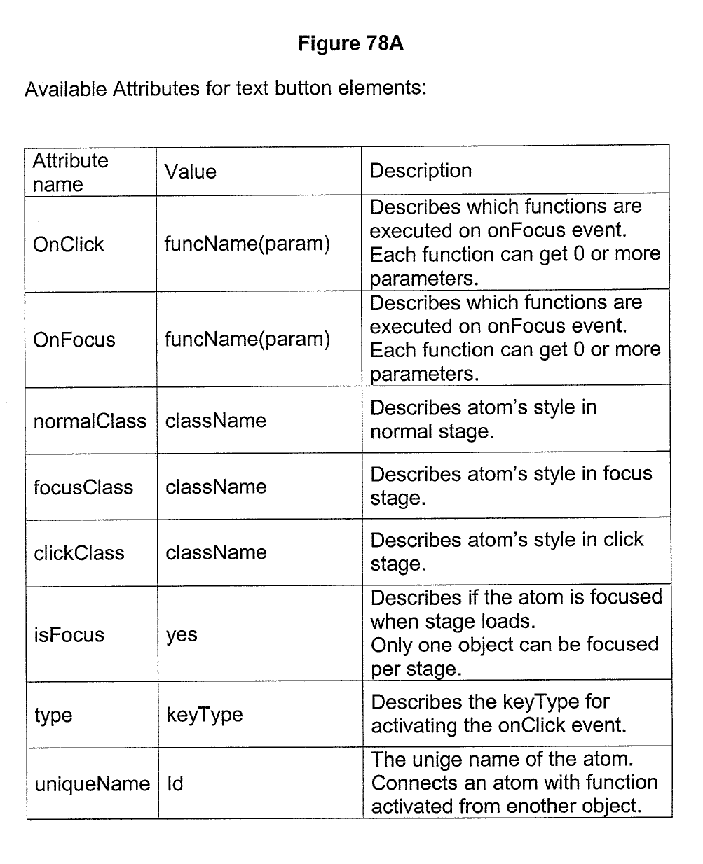

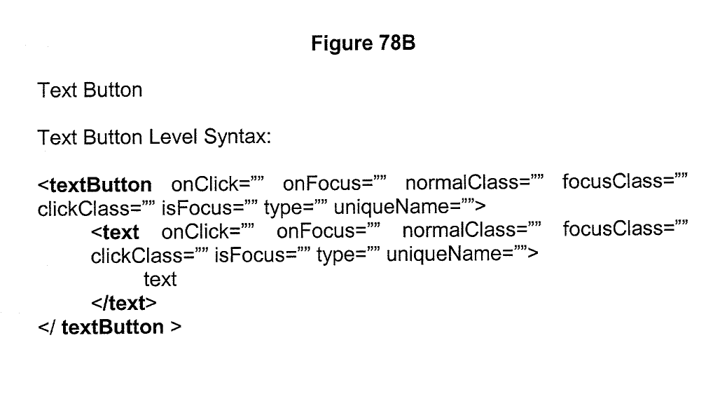

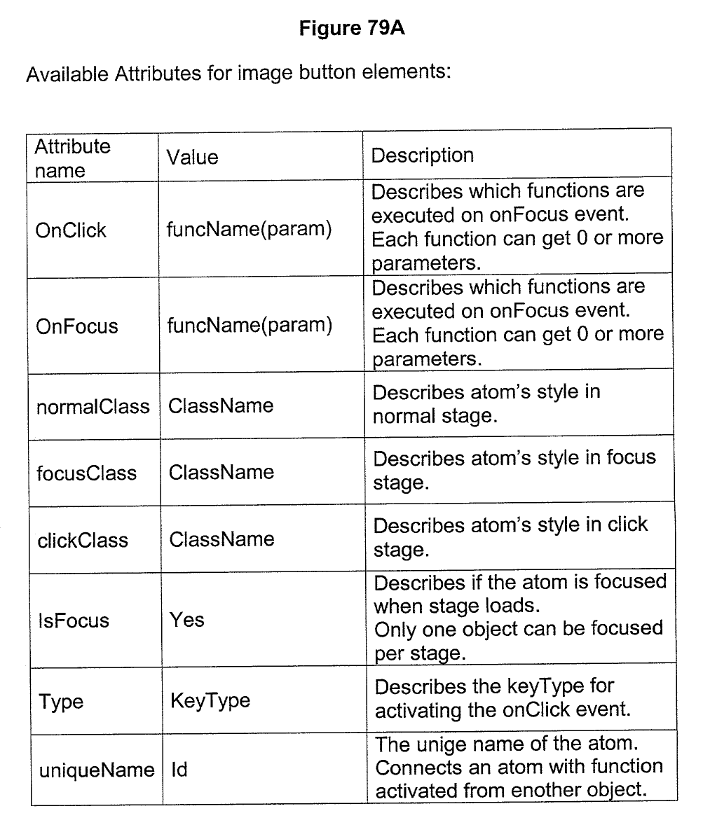

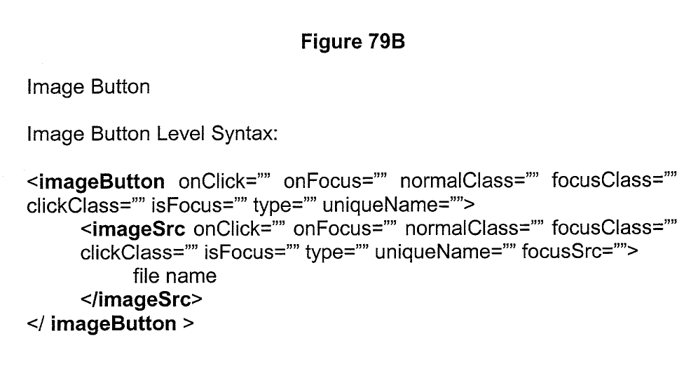

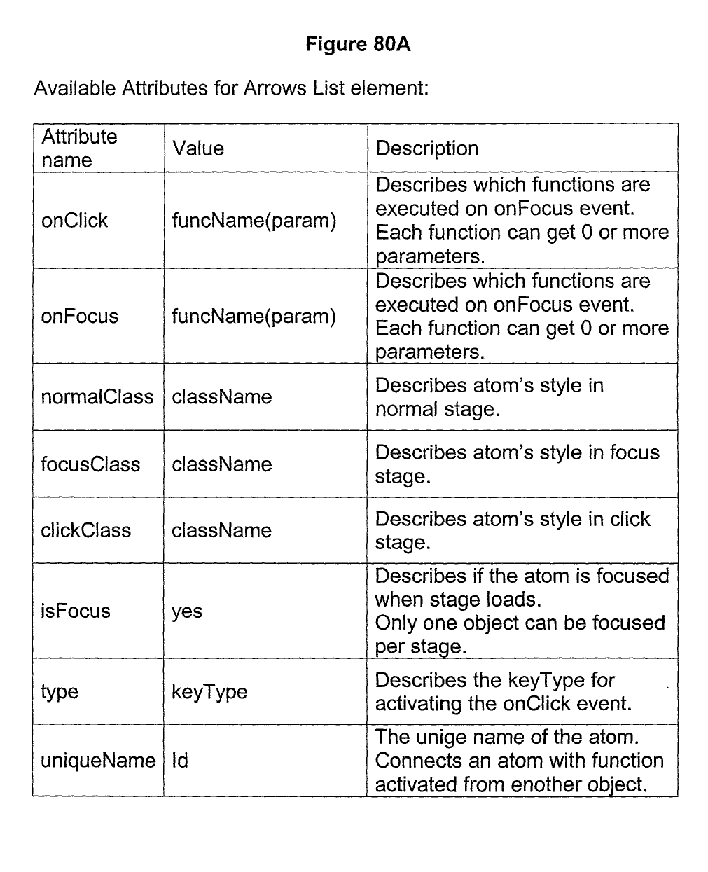

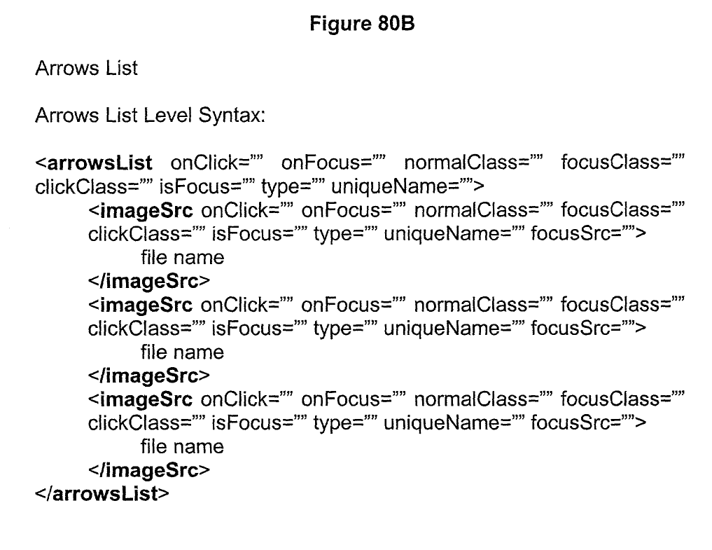

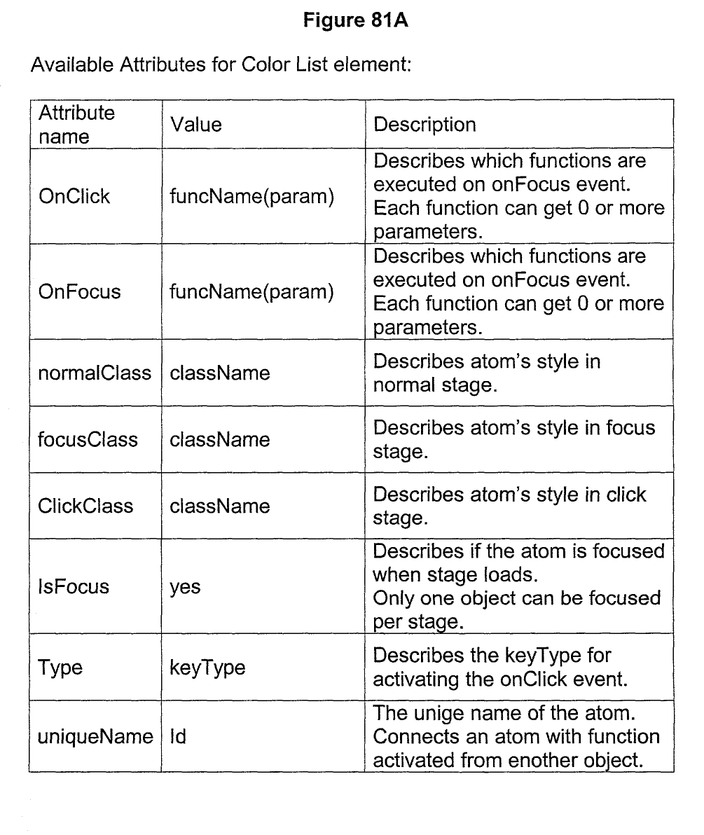

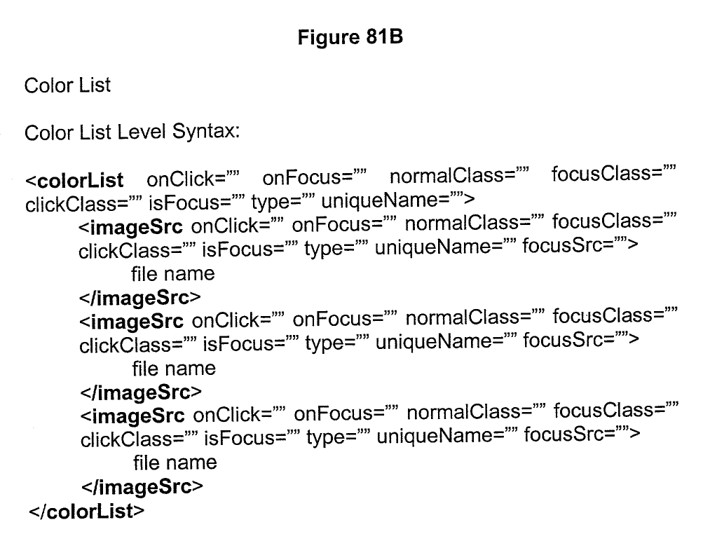

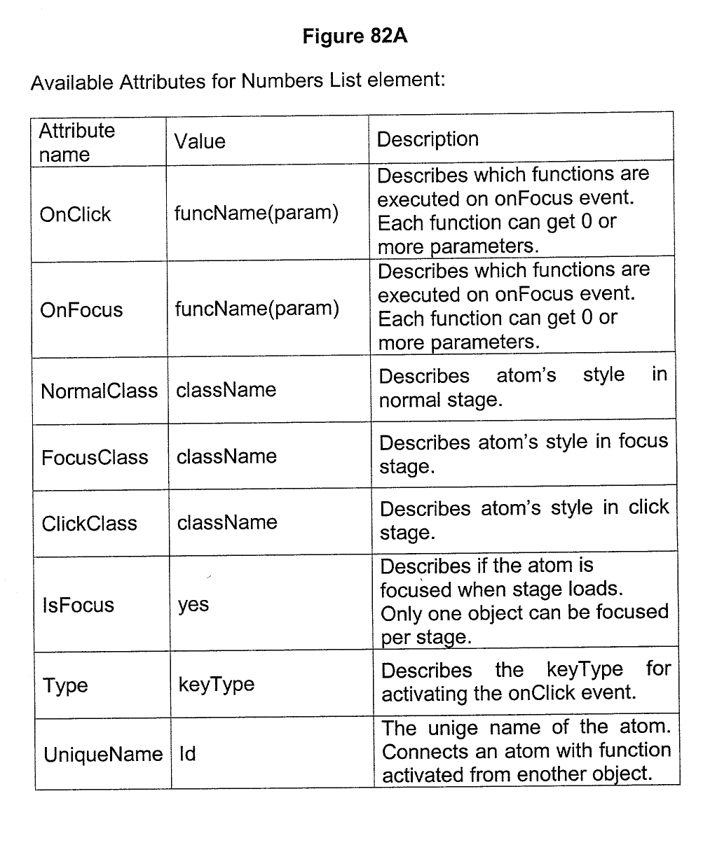

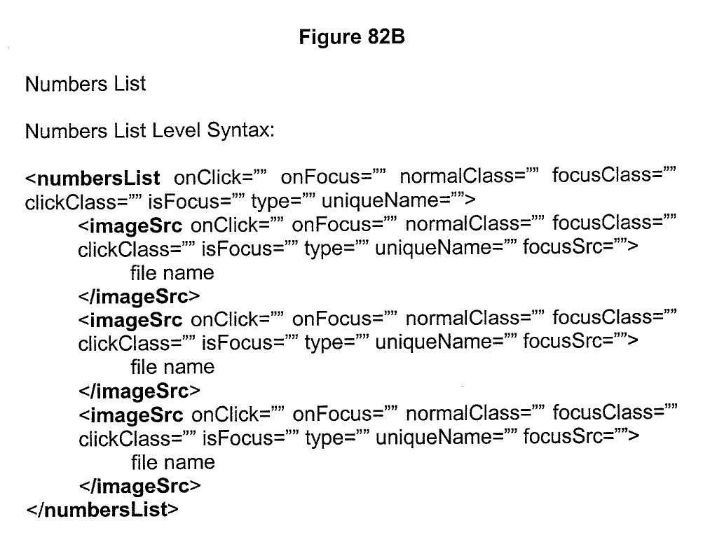

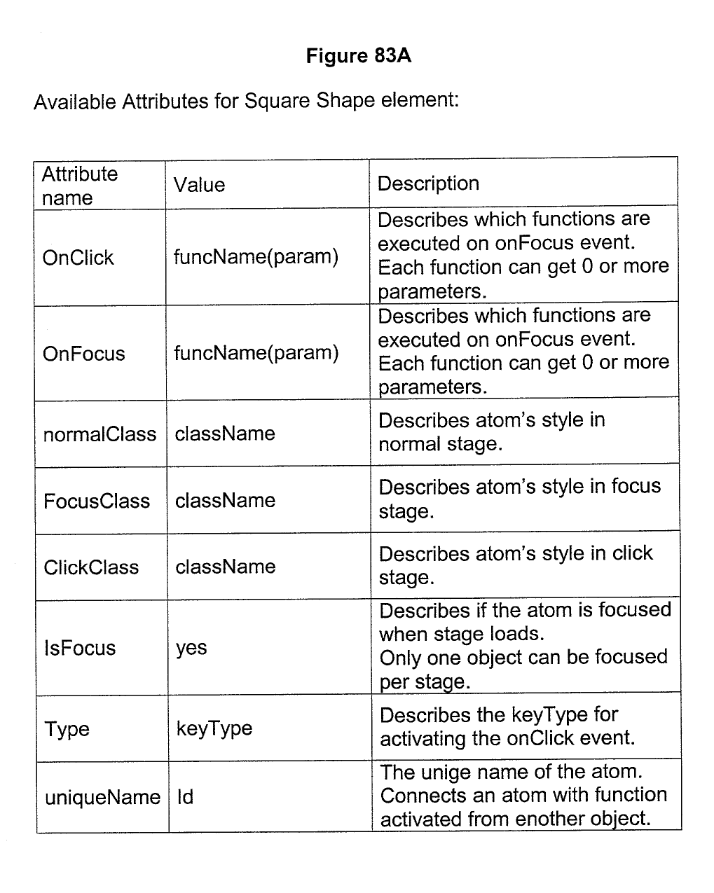

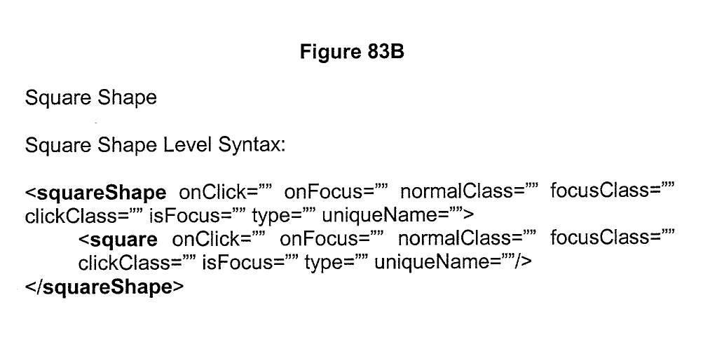

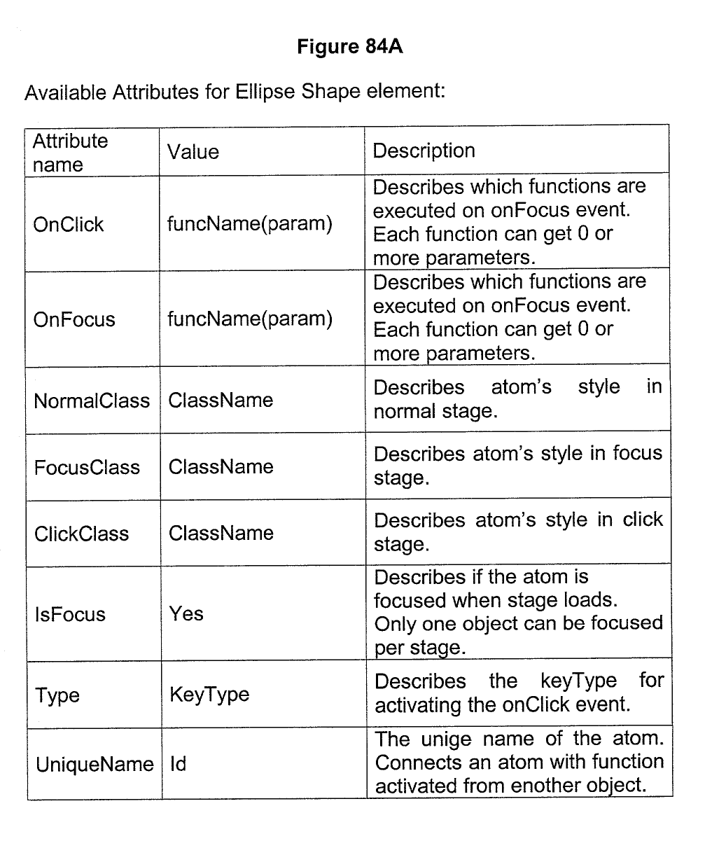

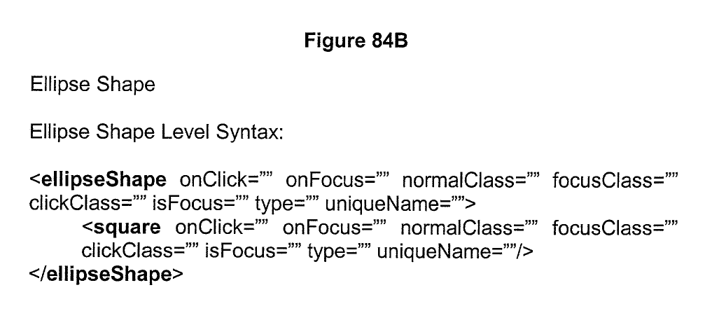

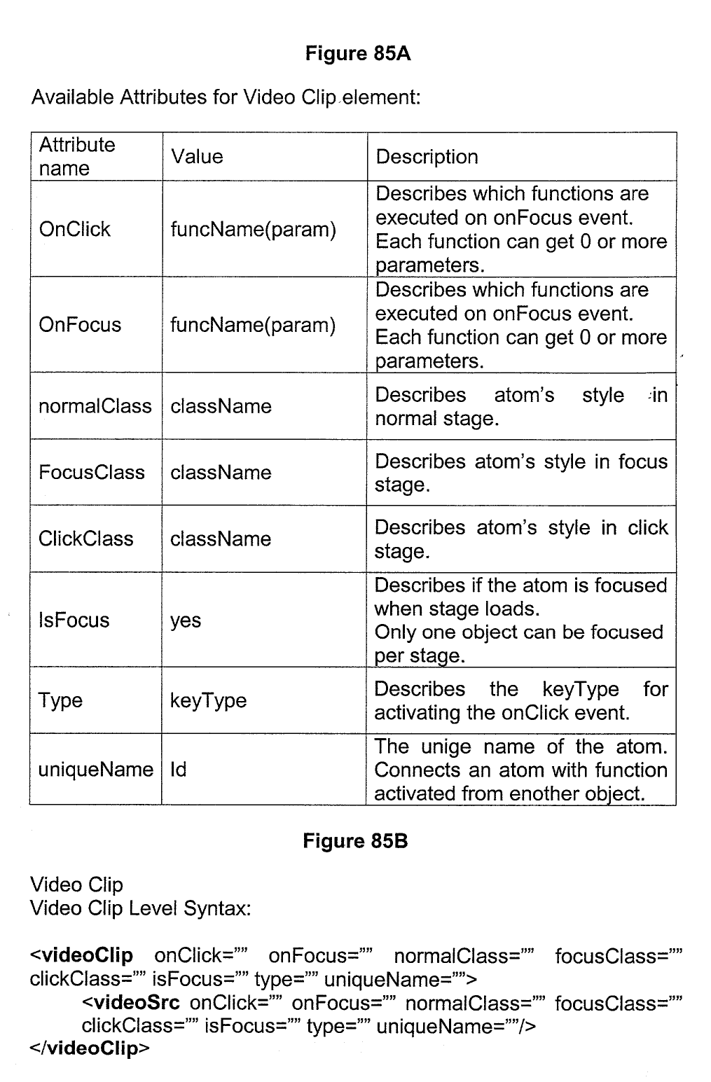

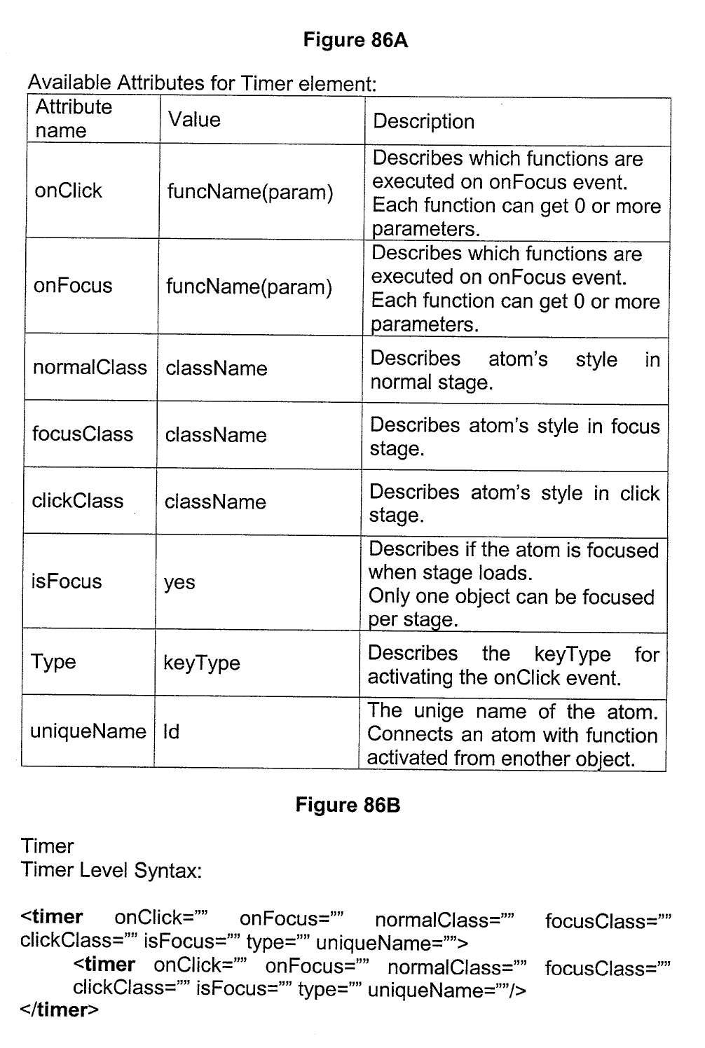

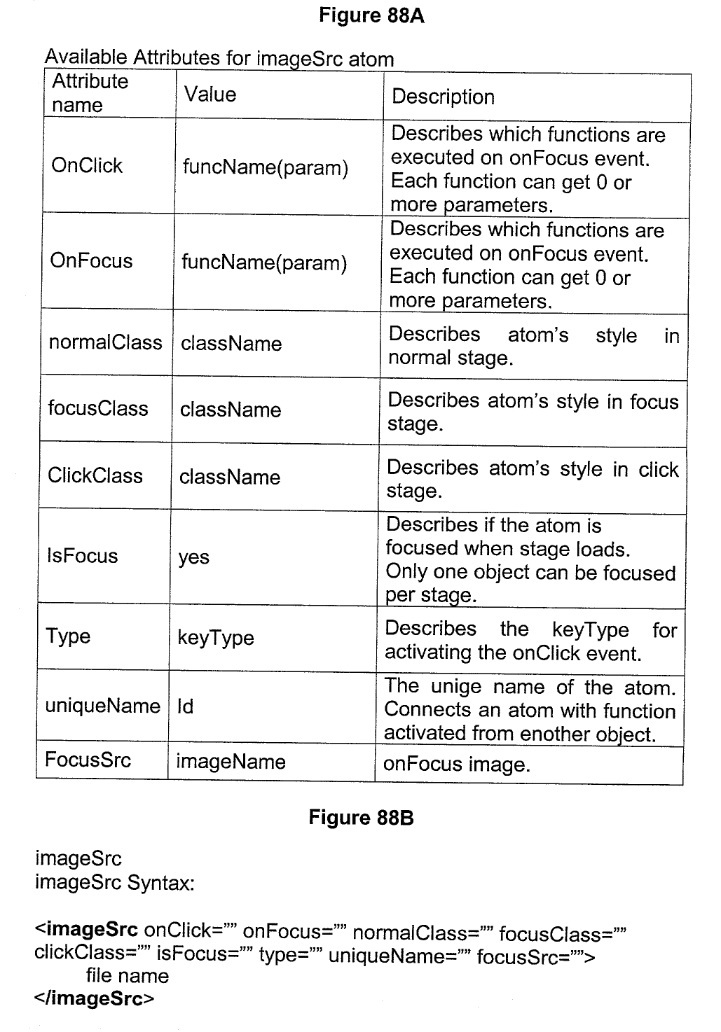

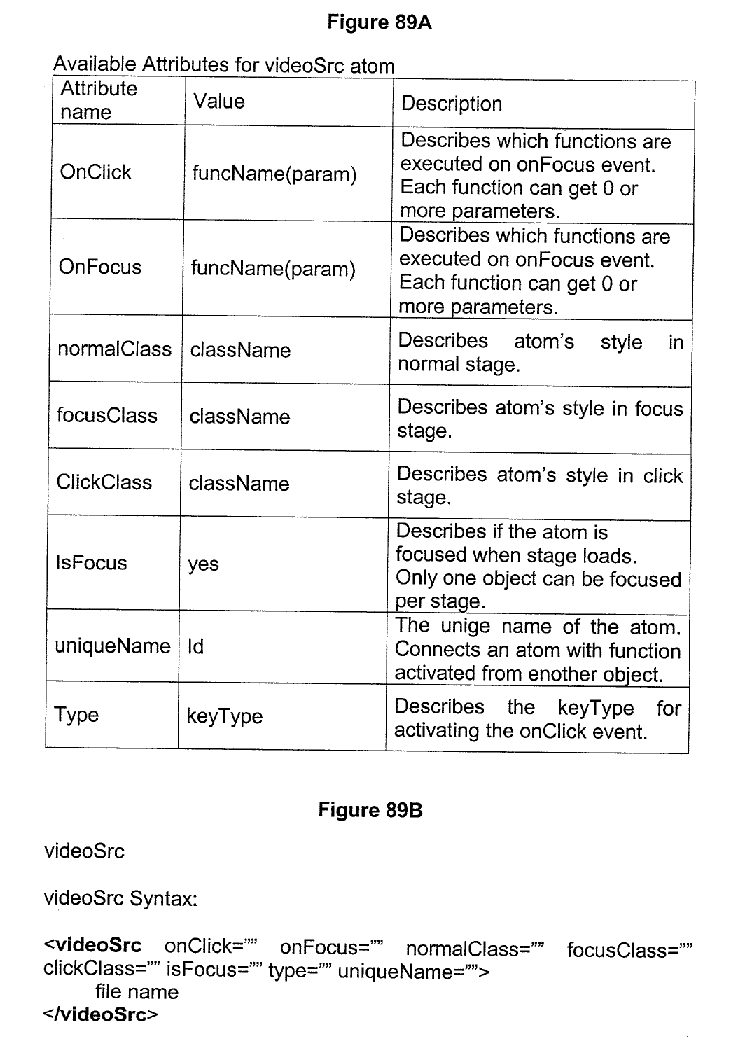

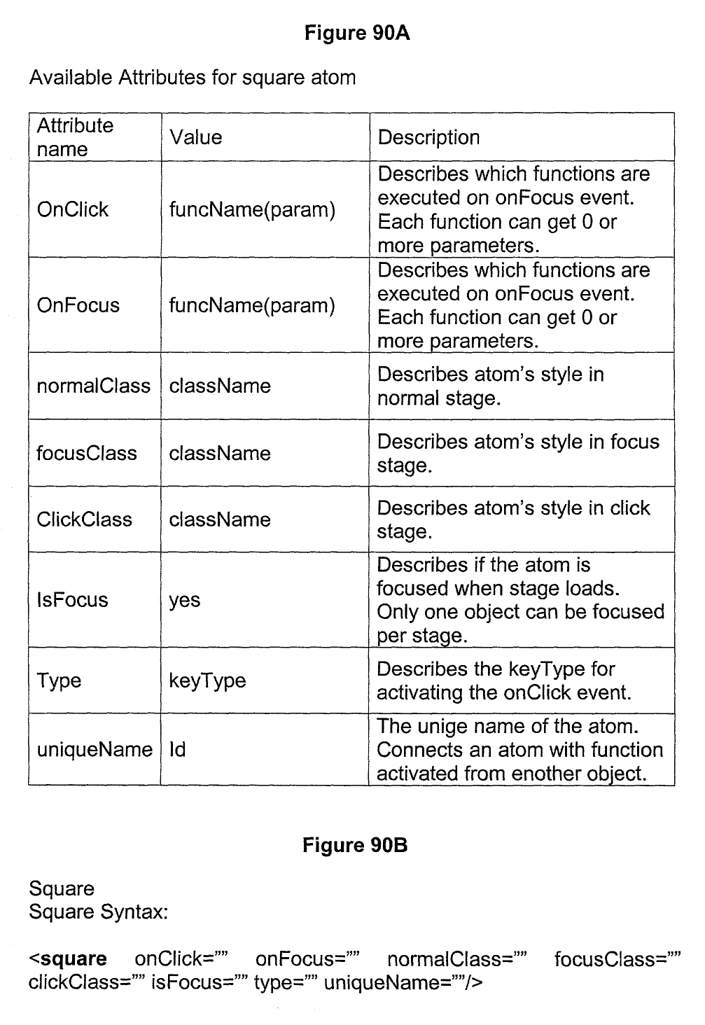

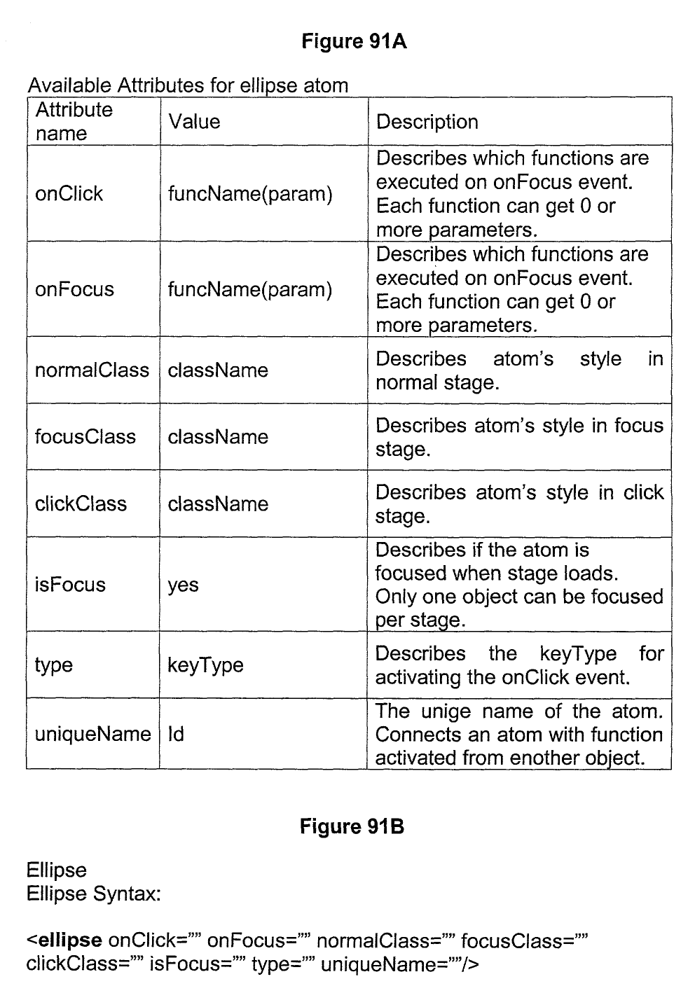

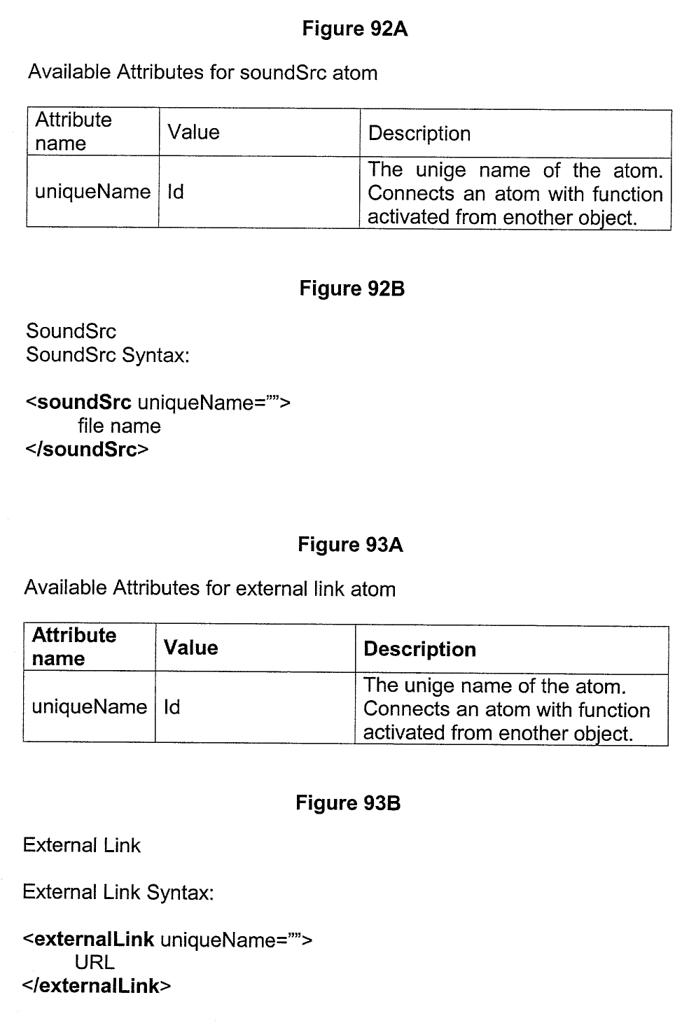

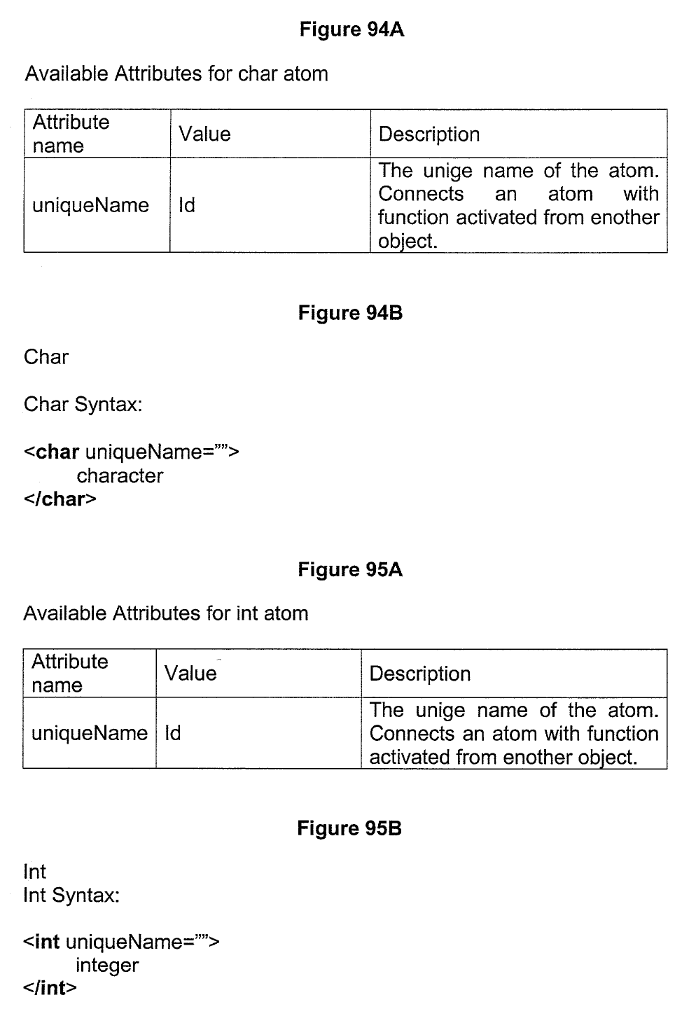

A preferred language for defining interactive application templates is now described with reference to FIGS. 72A-95B. This language or core syntax is termed herein IADL (Interactive Application Definition Language). IADL may be used for defining the logic and behavior of actions in the system of the present invention. It is a syntax that may be used to commonly describe the business logic of applications, thus enabling multi-platform display.

IADL preferably comprises a flexible development environment for the creation of interactive applications. IADL is typically targeted at network operators, multi service operators (MSO's) and independent application developers. IADL preferably provides ease of use and platform portability. IADL preferably provides the developer with familiar and easy to use building blocks called Elements and a Web like development environment. IADL typically operates in accordance with a CODE (Create Once Display Everywhere) mode.

IADL is typically based on the following four logic layers:

a. Atoms: basic building blocks. Examples of Atoms: “text”, “image”, “sound”.

b. Elements: A group of Atoms with a defined functionality forms an Element—an easy to use object that is designed to execute a familiar functionality. Examples of Elements: “running text”, “list”.

c. Stages: Screens for TV which define the appearance of elements on screens and functionality for screen level. Example: “stage” detects contradictions in use of the digital TV's remote control buttons.

d. Application: Contains the flow (logic) of the screens and functionality in application level. Example: The function may know what Elements can be reused in the application in order to save bandwidth and memory

FIG. 72A is a table describing two IADL application-level commands having a common syntax described in FIG. 72B.

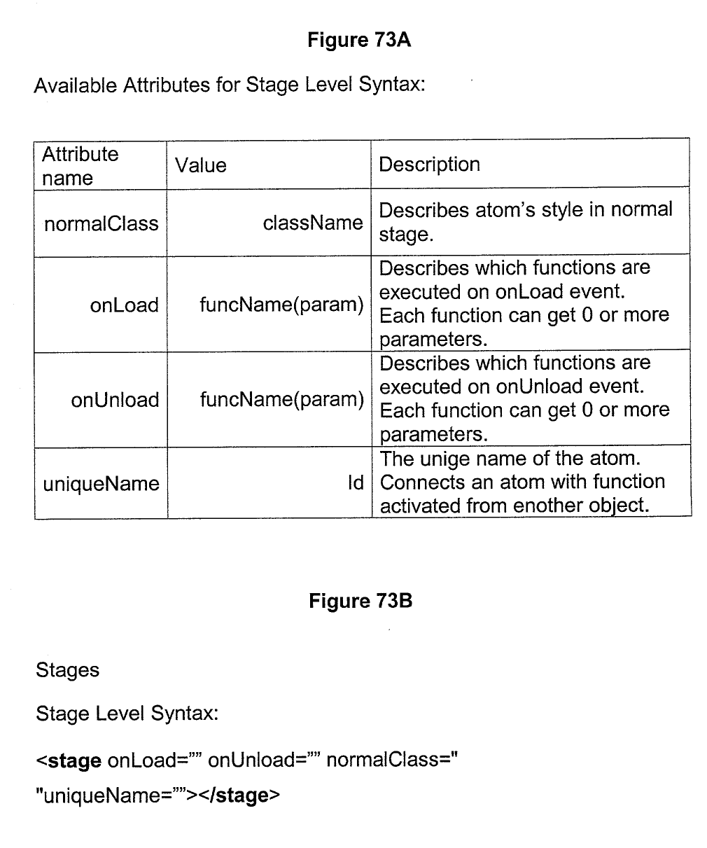

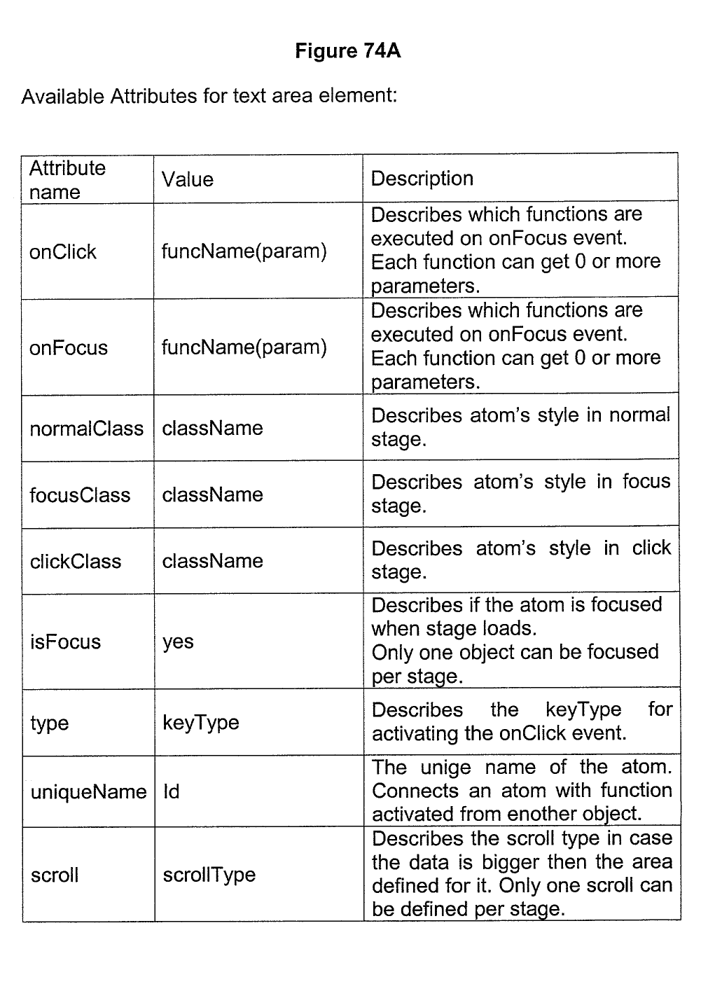

FIG. 73A is a table describing four IADL stage-level commands having a common syntax described in FIG. 73B.

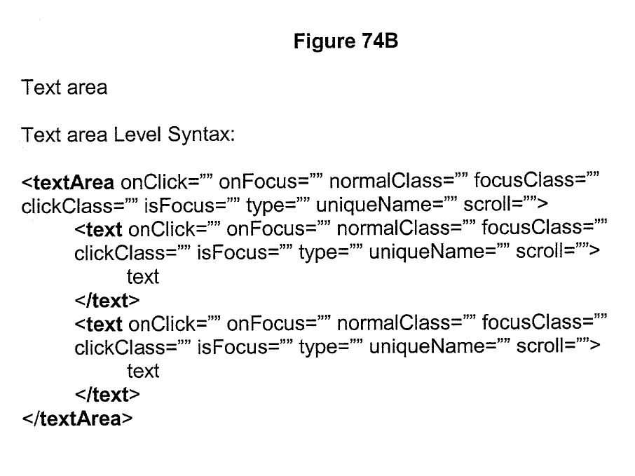

FIGS. 74A, 75A, 76A, 77A, 78A, 78A, 79A, 80A, 81A, 82A, 83A, 84A, 85A and 86A are tables, each row of which describes an element-level IADL command wherein the commands in each such table have a common syntax as described in FIGS. 74B, 75B, 76B, 77B, 78B, 78B, 79B, 80B, 81B, 82B, 83B, 84B, 85B and 86B respectively, and

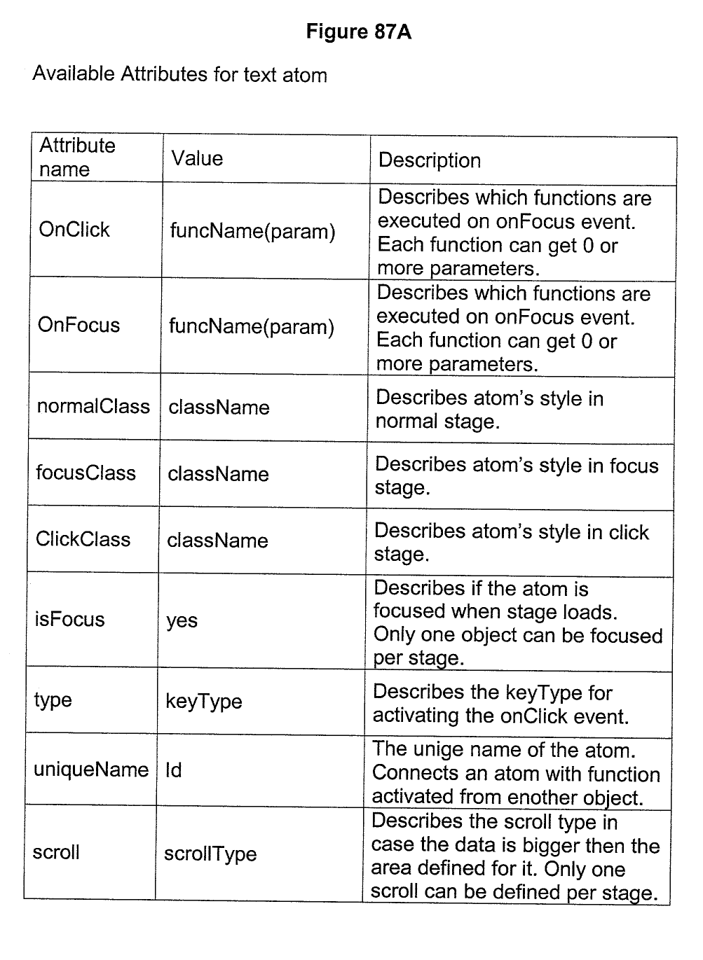

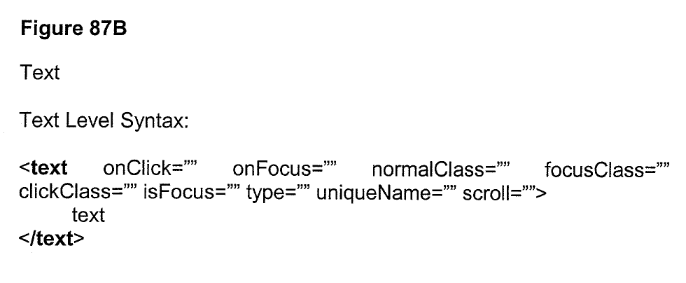

FIGS. 87A, 88A, 89A, 90A, 91A, 92A, 93A, 94A and 95A are tables, each row of which describes an atom-level IADL command wherein the commands in each such table have a common syntax as described in FIGS. 87B, 88B, 89B, 90B, 91B, 92B, 93B, 94B and 95B respectively.

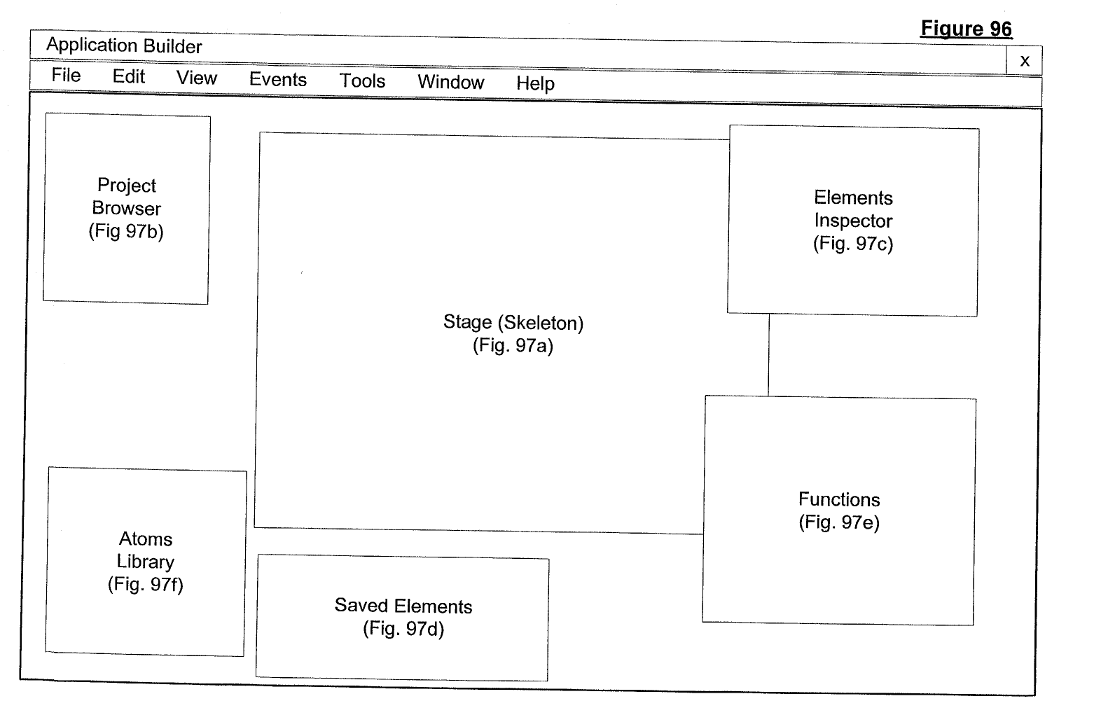

FIG. 96 is a simplified pictorial illustration of a first screen display generated by the Application Builder 320 and its GUI 330 (FIG. 6) when performing an example workflow as described in FIG. 55. The Application Builder is a preferred tool for the creation of Interactive Application templates.

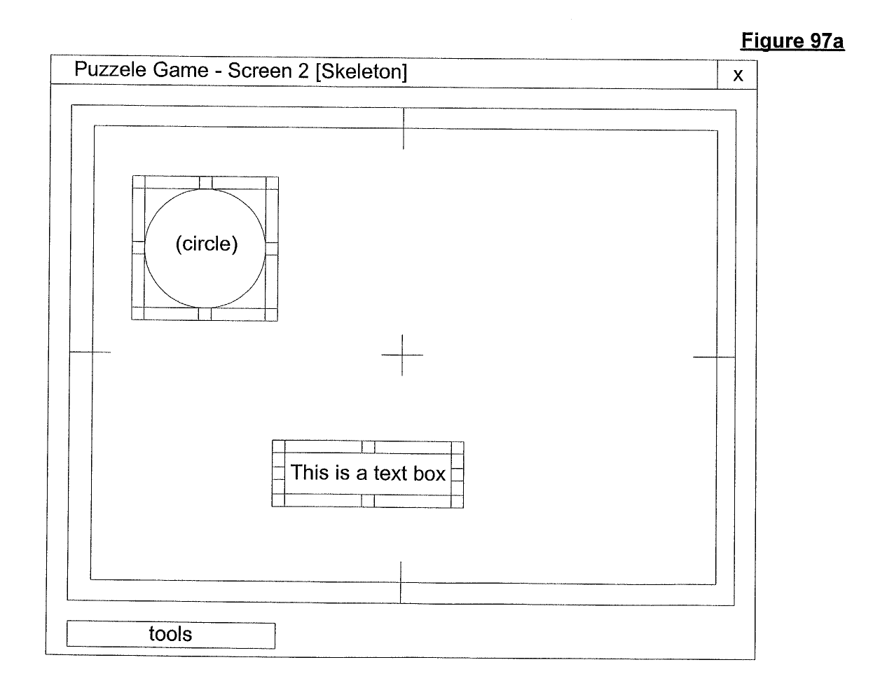

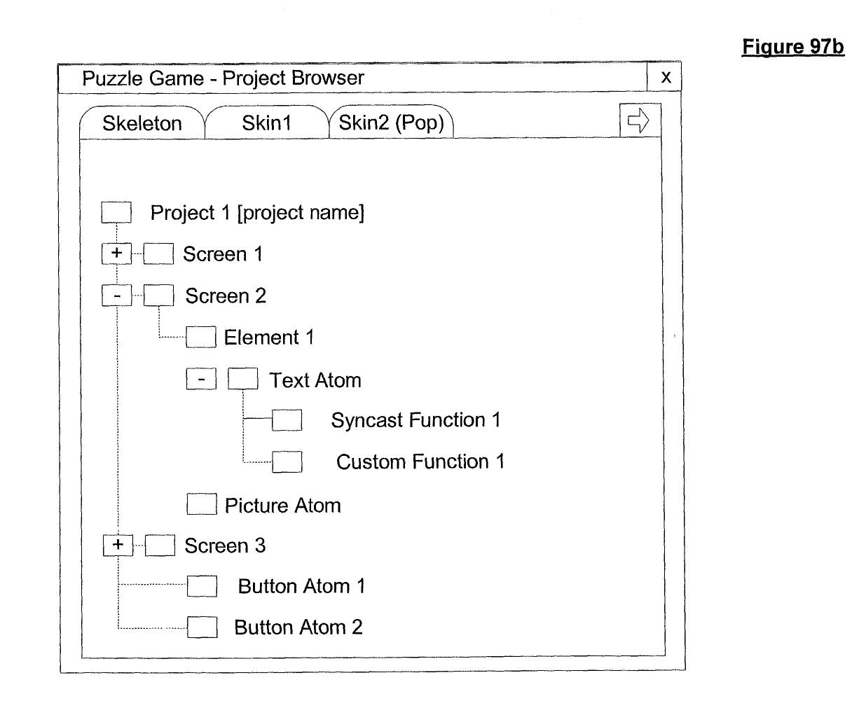

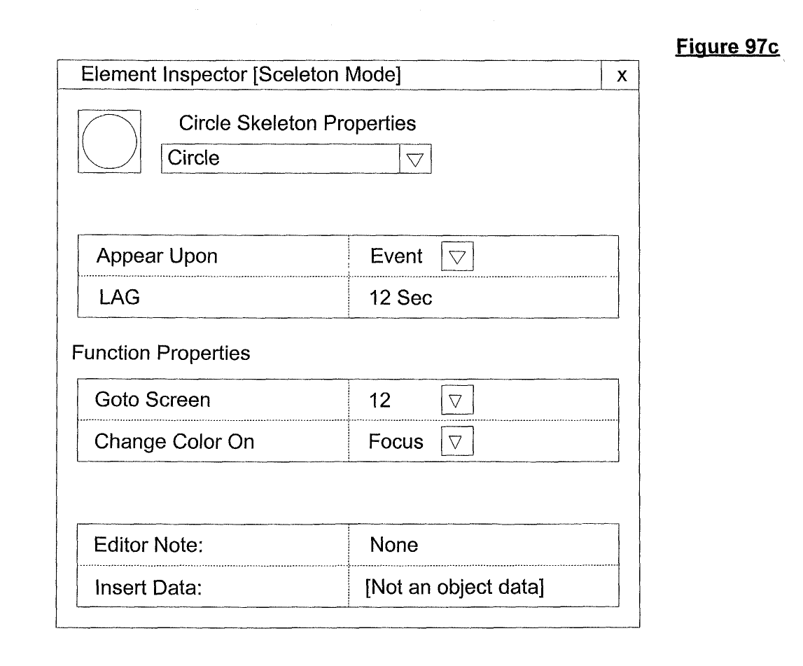

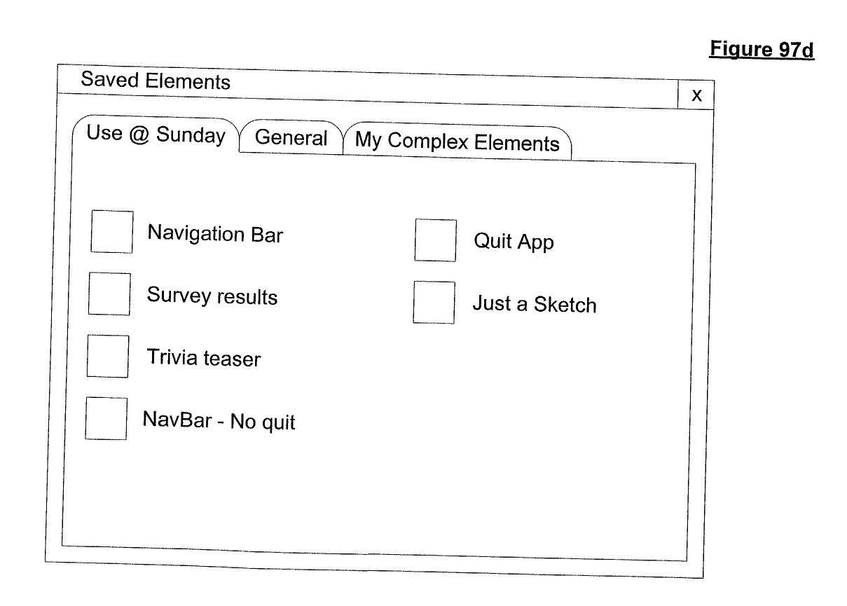

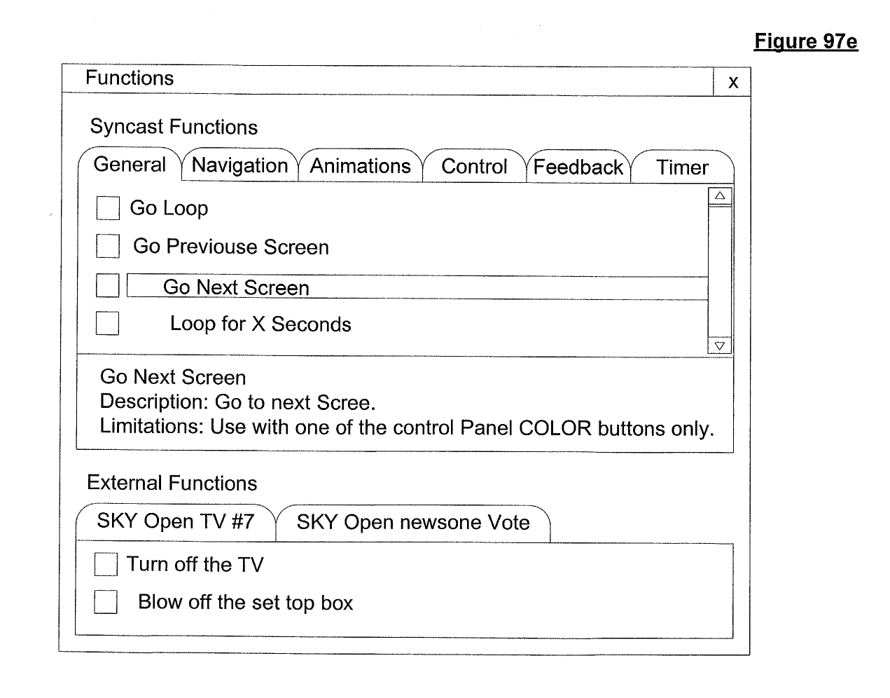

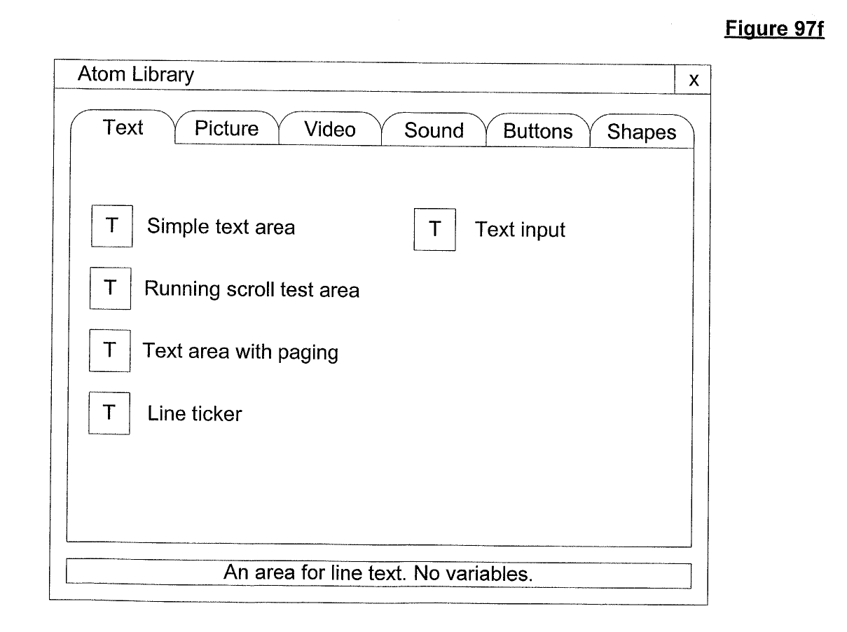

FIGS. 97A-97F are simplified pictorial illustrations of the stage(skeleton), project browser, elements inspector, saved elements, functions and atoms library windows, respectively, in the screen display of FIG. 96.

Forming part of a set of tools preferably provided in accordance with the present invention, Application Builder 320 and its GUI 330 perform an initial portion of the application creation process. Once an application template has been created by the Application Builder 320 and its GUI 330, the template may be stored in the BackEngine Database 240 and may be populated with information by the editor-user using the Editor-GUI 280.

The Application Builder 320 is preferably operative to selectably open, save and modify Application Builder 320 projects. An Application Builder 320 project can be published to an Editor Suite. A published application typically comprises the following components: the application code, typically targeted to a specified iTV platform, one or more application skins, and a population Wizard, for use in an Editor Suite. The application is typically defined on paper by its author (briefing), after which both the programmer and the designer work on it together. The programmer is typically first to use the application builder, creating a working mock-up of the application (skeleton). In parallel, the designer works with external design tools such as Adobe's Photoshop, on the application design. After the skeleton has been created, the designer typically imports the graphic, and builds the application's first (or single) skin. Preferably this interactive authoring flow is a two-way-flow.

One application may contain several, different, skins. Since the process of the skeleton creation may be complex, including debugging and testing, the client may wish to re-use application skeletons as much as they can, and adapt them to different TV shows. For example, a survey about an item from the evening news could easily become a survey about an item from a sports broadcast because although the two applications might look entirely different, they may share the same logic. The system give the designer the ability to create new skins for an existing application without the need to communicate directly with the programmer who created the application.

Therefore, the “skeleton” and the “skin” are typically separated into two different, independent entities. This allows maximum freedom in the creation process, i.e. a designer can pickup an existing skeleton and create a new skin for it without any assistance from the programmer, and a programmer can create a new application using only the default skin. However, a skin can typically be applied only to the application it has been created for.

The Application Builder 320 automatically discerns the distinction between Skeleton and Skin elements. For instance, if an author imports a custom library that contains both visual elements (pictures) and logic elements (functions), The application builder can display each one of their properties in a relevant tab and save them in the relevant entity. In case the skeleton has been locked, logic object placements are typically forbidden.

It is appreciated that according to a preferred embodiment of the present invention, the modular interactive application generation system shown and described herein in FIGS. 1 and 2 and onward is operative to facilitate generation of interactive applications which are modular in at least one and preferably all of the following senses:

a. At least some interactive applications initially exist as a template which is modular in the sense that any suitable interactive content can be injected into the template to generate a plurality of different content-specific interactive applications from a single modular content-independent interactive application predecessor.

b. At least some interactive applications exist in a time independent form, termed herein “action” form, which is modular in the sense that each such action can be associated with any of a plurality of time-points along a timeline, to generate a plurality of different time-synchronized interactive applications, termed herein “instances”, from a single modular time-independent interactive application predecessor;

c. At least some interactive applications exist in platform-agnostic form, such as “IADL format” shown and described herein, which is modular in the sense that each such platform-agnostic interactive application can be platform-specifically packaged to establish compatibility with a plurality of different interactive broadcasting platforms (such as OpenTV, MediaHighway, and Liberate). Thereby, a plurality of different platform-specific interactive applications are generated from a single modular platform-agnostic interactive application predecessor.

The database manager associated with BackEngine database 240 in FIG. 4 is operative to perform a variety of interactive application data processing operations also termed herein “database stored procedures”. In the illustrated embodiment, these are implemented as Oracle “stored procedures”.

It is appreciated that at least three modes of associating interactive items with a timeline are afforded by the system of the present invention: off-line editing mode, immediate-broadcast editing mode and real-time editing mode. The off-line editing mode is used for pre-recorded programs such as commercial programs, the system preferably allows the editor-user to view the interactive item he has generated and temporally associated with the playlist, in conjunction with the concurrently running program.

IADL (interactive application definition language) is an example of a suitable language for writing template applications for wizard editing. A client can generate his own template using the IADL language described herein or any other suitable interactive application definition language.

A content editor or editor may generate content using the system of the present invention. This content is automatically processed by the system in order to adapt it for viewing on a television screen or computer screen or small-screen display devices such as cellular communication devices or any display device whose characteristics are known to the system.

The TV knowledgebase of the present invention is preferably read by a transformer inside the broadcast gateway which converts IADL to a target device-understandable language.

An example process of planning, creating, editing, broadcasting and monitoring the results of Survey-type Interactive Applications, is now described. The survey-type interactive applications are to be presented to a plurality of end-users, at a precise assigned timing reflecting context-linking to the video content that is broadcast live or broadcast off-tape. Context linking is typically performed by a human operator termed the editor-user, in conjunction with the editor GUI 280 (FIG. 46) shown and described herein. In off-tape broadcasting, context linking is typically performed off-line whereas in live broadcasting, context linking is performed on-line.

In this example, the end-users receive and interact with the context-linked interactive application on two of a plurality of end-user devices encompassed within the scope of the present invention: A Television set running within a digital TV network, and a Personal Computer running within an Internet Protocol Network.

The entities involved in the process typically comprise a broadcaster, an operator and viewsers as described in detail herein.

Channel 1 (The Broadcaster): A content packaging entity responsible for broadcasting a sequence of programs, typically video programs, including editorial programs and advertisement programs. Persons involved in the broadcasting process, in Channel 1, may include:

Editor-in-Chief: Makes final interactive and video content decisions

Interactive Designer: Designs the look and graphics (“skin”, i.e. visual wrap) of the interactive application.

Interactive Programmer: programs the interactive application template typically using the application composer 170 and IADL (interactive application definition language whose syntax is represented in FIGS. 72-95) shown and described herein.

Editor-User: Enters changeable content data to the Interactive Application Template and links the resulting interactive application to a specific time-point in the video program broadcast schedule.

WebJockey Editor-User: Usually operates in Channel 1's control room. Monitors the system described herein using the editor GUI 280. Able to inject interactive applications into a video program stream using the editor GUI, particularly if the video program stream is being aired live.

CableSatCo (the Operator): An entity engaged in the business of providing a network that delivers televised content including interactive content to a plurality of end-users. Usually hosts the broadcasting mechanism (“headend”) for both the video and the interactive programming. In this example CableSatCo. provides the content on both the digital television network and the broadband Internet network. In case of Digital TV the Operator usually provides each viewser in the viewser population it serves with a Set-Top Box which typically comprises a compatible device able to retrieve from a received videostream, and to display on the viewser's TV set, the video and interactive content sent by the operator. The Set-Top box and the headend are equipped with middleware and data broadcasting software and hardware using suitable matching technologies such as OpenTV.

PC Viewser (Jill): An end-user using her Personal Computer, featuring an Internet connection, a web browser (such as Microsoft Internet Explorer) and a Media Player software (such as Microsoft Windows Media Player) to view and interact with the content provided by the CableSatCo.

DTV Viewser (Jack): An end-user using his Digital TV set, Set-Top Box and remote control to view and interact with the content provided by the CableSatCo.

An example of a sequence of events culminating in production of a video sequence including interactive elements in accordance with a preferred embodiment of the present invention is now described:

Monday 9:00 AM:

The Editor-in-Chief at Channel 1 prepares a creative brief (step 1400 in FIG. 55) typically comprising a single page which may specify that three interactive applications should be prepared and synchronized to Wednesday evening's 7 PM -9 PM programming slot, and may further specify that the interactive application should include the following three elements:

a. an off-line “musician” survey allowing viewsers to select their favorite musician, to be aired during a teenager show featuring music video clips—scheduled to air Wednesday 7:00 PM. The teenager show is to be followed, in the schedule by an open slot at 7:45 PM in which a song by the musician favored by the largest number of viewsers will be aired.

b. an off-line commercial “car” survey encouraging viewsers to select their favorite car and thereby become eligible to participate in a lottery, the commercial survey to be aired in the course of a car commercial to be aired during the teenager show, at 7:30:30 PM.

c. a live newscast showing a political debate from the parliament starting at 8:00 PM, the debate to be overlaid with an on-line “political” survey question to be determined on-line by the web jockey editor-user as a function of the content of the live debate.

The two off-line Survey applications may be prepared and assigned to the ePlaylist 953 (FIG. 46) by the Editor-user 24 hours prior to the scheduled broadcast. The on-line “political” survey application may be prepared in the first few minutes after the show begins, and is typically ready to broadcast approximately 5 minutes later. Once the on-line survey application is ready to broadcast, the WebJockey Editor-User may insert the application into broadcast, in real-time, according to the events occurring in the live broadcast of the news-cast—in order to create an impression of context-relevancy.

Monday 10:00 AM:

The Interactive designer and the programmer receive the creative brief and prepare a application logic tree (step 1410, FIG. 55) for use as basis for all three of the planned surveys. The logic tree contains a field for a survey question, a plurality of possible answer fields e.g. 4 answer fields, and a “see results” button for immediate generation of current results. The designer sets off to create six sets of graphic files (“skins”), a file for PC viewing of each of the three surveys and a file for DTV viewing of each of the three surveys. The programmer engages in constructing the “skeleton” or logic of the survey application using the application builder 320 (FIGS. 96 and 97), and generating code such as the one described in FIGS. 57A-57B. The “skeleton” can be used for all three surveys, both for PC and DTV viewsers.

Monday 5:00 PM:

The programmer receives the graphic files from the designer, and after approval of the Editor-in-Chief, assembles and creates three templates for the three surveys respectively (step 1440, FIG. 55). The three templates preferably leave a degree of freedom in content selection such that they are somewhat flexible. Alternatively, a single template may be generated in which case, preferably, the skin is selected from within the template. The programmer also creates a wizard (step 1450, FIG. 55) which, once attached to the logic, allows the editor to incorporate desired content into the specific scheduled interactive application.

Monday 6:00 PM:

The programmer previews the application and tests it with each of the six “skins” prepared by the designer (step 1470, FIG. 55.) The programmer then exports (step 1500, FIG. 55) the application to the Fuser 110 (FIG. 9). The fuser automatically stores the template application and its relevant “skins” in the BackEngine Database 240.

Tuesday 9:00 AM:

The Editor-User reviews the creative brief and begins an editing session at the Editor-GUI 280 workstation which typically includes the following operations:

The Editor User points the displayed schedule 952 (FIG. 46) to Wednesday between 7:00 and 9:00 PM, and the planned playlist is automatically displayed in the ePlaylist window 954 (FIGS. 46 and 70). The Editor User Opens the repository 962 (FIG. 46) and searches using the view selection box 967 (FIG. 46) in the repository window, for the musician Survey application.

The Editor-User then drags the musician survey template to 30 seconds past the planned beginning of the broadcast, i.e. 7:00:30 PM. The point dragged to generates a visible trigger (elements 957 and 958 in FIG. 46) and a wizard window pops up (FIG. 47) and allows the editor to enter the following survey content data in accordance with the process described in FIGS. 58 and 59: a suitable opener such as “select the performer of the day”, names and pictures of 4 performers, and additional information on their latest release.

The Editor-user previews the application, and sends a query to the feedback module 230 (FIG. 64) to display the results of this survey at 7:15 PM at the WebJockey Editor-GUI workstation. The Editor-User then submits the interaction (step 1210, FIG. 53A), automatically registering an instance in the BackEngine Database 240 (FIG. 60.)

The Editor User then repeats the above steps, starting from template dragging, however this time, the template is dragged to a different temporal location e.g. 7:35:00 PM, thereby to generate an additional survey, this time titled “select the worst artist of the day”, from the same musician survey template.

Tuesday 11:00 AM:

The Editor User receives content and graphic materials from an advertising agency whose client is the Compact Car manufacturer. These materials are to be used for a commercial to be aired at exactly 07:30:30 PM on Wednesday. The Editor-User then enters the data to the car survey template application, and uses a suitable survey question such as: “which car is the best value for your money—enter your choice and you may win a prize!”. A query is generated and forwarded to the feedback system 160 (FIGS. 12 and 65)—asking the feedback system to forward to the advertiser a report, e.g. a named report, of all viewsers that have elected to answer the survey.

The editor-user assigns the Action (interactive application with content) to the beginning of the commercial in the ePlaylist, and preferably specifies a duration e.g. of 1 minute (element 984, FIG. 48) for the display of the question to the viewsers, after which the question disappears from the screen.

According to the placement agreement between the advertising agency and Channel 1, this commercial is planned to be aired 24 times during the following week, so the Editor User specifies in the recurrence window (element 981 in FIG. 48) that each time the commercial airs, the interactive application will be aired as well.

Tuesday 6:00 PM:

The Editor-in-Chief previews (elements 988, 989 in FIG. 50) all applications created by the Editor-User (in this case, the two musician surveys (“best” and “worst”, and the car survey) and confirms, using confirm button 983 (FIG. 48), the “best musician” and “car” surveys but rejects the “worst musician” survey. The PC applications are now stored in the Interactive Server 150 (FIGS. 10 and 60), ready to be sent. The DTV applications are now stored as instances with reference to all resource files, waiting to be packaged and compiled.

Wednesday 6:30 PM:

The TIM Server 210 receives an instruction to send the approved instances i.e. in the present example the “best musician” and “car” survey instances, to the DTV Packaging Subsystem (FIGS. 13 and 66A), where both survey instances are compiled (FIGS. 66B-66D) and sent via a TCP/IP dedicated line to the DTV broadcast Gateway 200 residing at CableSatCo's Headend location. The two DTV Interactive Scheduled Applications are then sent to the CableSatCo's data carousel 203 (FIGS. 2 and 67).

Wednesday 7:00 PM:

An on-air signal is received by the system for the teenage show (FIGS. 61 and 62 for IP to PC and FIG. 67 for DTV.) The on-air signal shows that there has been a delay of 1 second compared to the planned time of broadcast of the teenage show. The TIM Engine (element 360, FIG. 7 and element 400, FIG. 8) then computes this delay and sends the trigger command (FIGS. 71A-71B) one second later than the planned airing time defined in the clock (element 365 in FIGS. 7 and 410 in FIG. 8).

Wednesday 07:00:31 PM:

Jill and Jack, the PC viewser and the DTV viewser, both watching the video programming, receive an interactive message and an application loader respectively. They both decide to interact (FIGS. 63 and 68-69 for PC and DTV respectively.

Jill, the PC viewser, clicks with the mouse on the interactive message, activating an IP session with the survey application residing at the Interactive Server 150. She then answers the question and sends her input to the system.

Jack, the DTV Viewser clicks a Red button on the remote control (confirming he wanted to participate in the survey) and uses the arrows and select keys in the remote control to vote. His input is registered in CableSatCo's network and sent to the Return Channel server 260 (see FIG. 68) and to the Feedback Module 230 of the system.

Wednesday 07:15:00 PM: Jack and Jill's (and other viewsers') inputs are presented in the report generated by the feedback module. The Video Producer in charge of the control room, loads the relevant winning piece from the video server and airs this democratic selection made by the people.

Wednesday 07:30:30 PM:

The “car” survey application is aired exactly as the commercial begins, despite a delay of 10 seconds in the planned time. This is because the On-air signal is responsible to notify the entire system (FIGS. 71A-71B) for this delay, ensuring precise synchronization of the display of the interactive message (IP) and the application loader (DTV) to the start time of the commercial.

Jack and Jill's clicks to answer the survey result are registered in the Feedback Module and a report is generated for the advertiser.

Wednesday 08:00:00 PM:

The WebJockey Editor-User is following the live broadcast of the parliamentary debate. It turns out that the topic of the debate is the country's anti-racism policy. Joe, a speaker representing an extremist party requests permission to make a sensational statement. While the house debates whether to let him speak, the WebJockey Editor User, anticipating that Joe will be allowed to speak, prepares a quick action using the political Survey template application, using the following hastily worded question: “Do you support Joe's statement?”. The statement itself, of course, has not yet been made and therefore has not yet been aired. The WebJockey Editor User also preferably fills in 4 possible answers: “Very Much So!” “Somewhat . . . ” “Disagree” and “No opinion”. Alternatively, the answers may have been predetermined in the wizard. The application content generated by the WebJockey Editor User is saved as an action in the BackEngine Database and represented in the Actions tab (element 965, FIG. 46) in the repository window.

Wednesday 08:07:25 PM:

As soon as Joe rises to begin his statement, the WebJockey Editor-User chooses “insert immediate event” from the Events menu (element 961 in FIG. 46), and activates submission of the action for broadcast, thereby creating an instance for immediate delivery to viewsers. This creates an impression of a real-time response to events occurring in the video feed. Preferably, the wizard logic dictates that the survey results are immediately displayed to all viewsers.

A preferred software implementation of the invention is now described, based on the attached CD-ROM Appendix A. To Install and Run:

1) Provide a computer terminal, such as an Intel-based Pentium III 550 Mhz computer, 256 Mbyte RAM, 40 Gigabyte Hard Disk, configured with the Microsoft Windows 2000 Server operating system;

2) Unhex the computer listing 41655OB1.HEX on CD-ROM No. 1 using HEX IT V1.8 or greater by John Augustine, 3129 Earl St., Laureldale, Pa. 19605 creating file 41655OB1.ZIP;

3) Decompress the file 41655OB1.ZIP using WINZIP version 6.2 or greater, extracting all files into their respective directories utilizing the WINZIP version 6.2 option “Use folder names”.

4) Unhex the computer listing 41655OB2.HEX on CD-ROM No. 2 using HEX IT VI.8 or greater by John Augustine, 3129 Earl St., Laureldale, Pa. 19605 creating file 41655OB2.ZIP;

5) Decompress the file 41655OB2.ZIP using WINZIP version 6.2 or greater, extracting all files into their respective directories utilizing the WINZIP version 6.2 option “Use folder names”.

6) Syncast B-TIM Server (APPLICATION SERVER) installation

(a) Install MDAC version 2.6, Syncast Logger, Syncast Database Access and Syncast Notification Agent commercially available from IP Planet, 7 Rival Street, 6th floor, Tel Aviv, Israel.

b) Copy SYNCTIMS.EXE and MNCEVENTS.DLL which are available from the respective folders created in steps 3 and 5 above to c:\syncast\bin.

c) Copy SYNCTIMS.INI which are available from the respective folders created in steps 4 and 5 above to C:\syncast\ini.

d) Register SYNCTIMS.EXE as Service.

7) Syncast COM/DCOM TIM Server Driver (APPLICATION SERVER) installation

a) Provide a computer terminal, such as an Intel-based Pentium III 550 Mhz computer, 256 Mbyte RAM, 40 Gigabyte Hard Disk, configured with the Microsoft Windows 2000 Server operating system;

b) Initiate steps 2 through 5 on the computer terminal referenced in step 7a

c) Copy TIMSDCOM.DLL and SYNCTIMA.EXE which are available from the respective folders created in step 7b above to c:\syncast\bin.

d) Copy SYNCTIMS.INI which are available from the respective folders created in step 7b above to C:\syncast\ini .

e) Register TIMSDCOM.DLL using regsvr32.

f) Register SYNCTIMA.EXE as COM Server using “\RegServer” flag.

8) Syncast NTF TIM Server Driver (APPLICATION SERVER) installation

a) Provide a computer terminal, such as an Intel-based Pentium III 550 Mhz computer, 256 Mbyte RAM, 40 Gigabyte Hard Disk, configured with the Microsoft Windows 2000 Server operating system;

b) Initiate steps 2 through 5 on the computer terminal referenced in step 8a

c) Install Syncast Notification Agent commercially available from IP Planet, 7 Rival Street, 6th floor, Tel Aviv, Israel.

d) Copy TIMSNTFA.DLL which is available from the respective folders created in step 8b above to c:\syncast\bin.

e) Copy SYNCTIMS.INI which are available from the respective folders created in step 8b above to C:\syncast\bin.

f) Register TIMSNTFA.DLL using regsvr32.

9) Syncast B-TIM Agent (iTV SERVER) installation

a) Provide a computer terminal, such as an Intel-based Pentium III 550 Mhz computer, 256 Mbyte RAM, 40 Gigabyte Hard Disk, configured with the Microsoft Windows 2000 Server operating system;

b) Initiate steps 2 through 5 on the computer terminal referenced in step 9a

c) Install MDAC version 2.6, Syncast Logger and Syncast Notification Agent commercially available from IP Planet, 7 Rival Street, 6th floor, Tel Aviv, Israel.

d) Copy SYNCTIMA.EXE and MNCEVENTS.DLL which are available from the respective folders created in step 9b above to c:\syncast\bin

e) Copy SYNCTIMA.INI which is available from the respective folders created in step 9b above to C:\syncast\ini.

f) Register SYNCTIMA.EXE as Service using “/Service” flag.

10) Syncast Windows Media TIM Engine Driver (WINDOWS MEDIA SERVER) installation

a) Provide a computer terminal, such as an Intel-based Pentium III 550 Mhz computer, 256 Mbyte RAM, 40 Gigabyte Hard Disk, configured with the Microsoft Windows 2000 Server operating system

b) Initiate steps 2 through 5 on the computer terminal referenced in step 10a

c) Copy TIMEWME.DLL which is available from the respective folders created in step 10b above to c:\syncast\bin.

d) Configure SYNCTIMA.INI in c:\syncast\bin as follows:

[TIMEWME]

ENGINE=SYNCENGINE.ENGINE2

e) Register TIMEWME.DLL using regsvr32.

11) Syncast iTV TIM Engine Driver (iTV SERVER)

a) Provide a computer terminal, such as an Intel-based Pentium III 550 Mhz computer, 256 Mbyte RAM, 40 Gigabyte Hard Disk, configured with the Microsoft Windows 2000 Server operating system

b) Initiate steps 2 through 5 on the computer terminal referenced in step 11a

c) Copy TIMEITV.DLL which is available from the respective folders created in step 11b above to c:\syncast\bin.

d) Configure SYNCTIMA.INI in c:\syncast\bin as follows:

[TIMEITV]

ENGINE=ITVENGINE.ENGINE2

MUXDIR=c:\syncast\opentv\mux

e) Register TIMEITV.DLL using regsvr32.

12) Syncast iTV Utils (iTV SERVER) installation

a) Provide a computer terminal, such as an Intel-based Pentium III 550 Mhz computer, 256 Mbyte RAM, 40 Gigabyte Hard Disk, configured with the Microsoft Windows 2000 Server operating system

b) Initiate steps 2 through 5 on the computer terminal referenced in step 12a

c) Copy ITVUTILS.EXE which is available from the respective folders created in step 12b above to c:\syncast\bin

d) Copy ITVUTILS.INI which is available from the respective folders created in step 12b above to c:\syncast\ini

e) Register ITVUTILS.EXE as Service using “/Service” flag from command line.

13) Syncast B-TIM Engine (BROADCASTING_GATEWAY SERVER) installation

a) Provide a computer terminal, such as an Intel-based Pentium III 550 Mhz computer, 256 Mbyte RAM, 40 Gigabyte Hard Disk, configured with the Microsoft Windows 2000 Server operating system

b) Initiate steps 2 through 5 on the computer terminal referenced in step 13a

c) Install Syncast Logger commercially available from IP Planet, 7 Rival Street, 6th floor, Tel Aviv, Israel

d) Copy SYNCENGINE.EXE which is available from the respective folders created in step 13b above to c:\syncast\bin.

e) Copy SYNCENGINE.INI which is available from the respective folders created in step 13b above to c:\syncast\ini.

f) Register SYNCENGINE.EXE as Service using “/Service” flag.

14) Syncast Windows Media Encoder 7 Driver (WINDOWS MEDIA SERVER) installation

a) Provide a computer terminal, such as an Intel-based Pentium III 550 Mhz computer, 256 Mbyte RAM, 40 Gigabyte Hard Disk, configured with the Microsoft Windows 2000 Server operating system

b) Initiate steps 2 through 5 on the computer terminal referenced in step 14a

c) Copy SYNCWM7.DLL which is available from the respective folders created in step 14b above to c:\syncast\bin

d) Register SYNCWM7.DLL using regsvr32.

15) Syncast iTV MUX Driver (BROADCASTING_GATEWAY SERVER) installation

a) Provide a computer terminal, such as an Intel-based Pentium III 550 Mhz computer, 256 Mbyte RAM, 40 Gigabyte Hard Disk, configured with the Microsoft Windows 2000 Server operating system

b) Initiate steps 2 through 5 on the computer terminal referenced in step 15a

c) Copy ITVDRV.DLL which is available from the respective folders created in step 15b above to c:\syncast\bin

d) Copy ITVDRV.CONF which is available from the respective folders created in step 15b above to c:\syncast\ini

e) Register ITVDRV.DLL using regsvr32.

16) Notification Server (APPLICATION SERVER) installation

a) Provide a computer terminal, such as an Intel-based Pentium III 550 Mhz computer, 256 Mbyte RAM, 40 Gigabyte Hard Disk, configured with the Microsoft Windows 2000 Server operating system

b) Initiate steps 2 through 5 on the computer terminal referenced in step 16a

c) Install the following software components available from the respective folders created in step 16b above:

SyncNotifServer.dll

SmartLogger.dll

NotifyServer.ini

CommServer.xml

CommServer.asp

NotifServer.xml

NotifServer.asp

Listener.asp

17) SOAP configuration (APPLICATION SERVER) installation

a) Provide a computer terminal, such as an Intel-based Pentium III 550 Mhz computer, 256 Mbyte RAM, 40 Gigabyte Hard Disk, configured with the Microsoft Windows 2000 Server operating system

b) Initiate steps 2 through 5 on the computer terminal referenced in step 17a

c) Copy .xml and .asp files which are available from the respective folders created in step 17b above to c:\syncast\soap

d) Run SoapVB.exe which is available from the respective folders created in step 17b above to reconfigure .xml and asp files.

e) Create IIS virtual directory that points to folder named SyncSoap. For example: http://user/syncsoap

18) COM+installation (APPLICATION SERVER) installation

a) Provide a computer terminal, such as an Intel-based Pentium III 550 Mhz computer, 256 Mbyte RAM, 40 Gigabyte Hard Disk, configured with the Microsoft Windows 2000 Server operating system

b) Initiate steps 2 through 5 on the computer terminal referenced in step 18a

c) Add new COM+ application named “Syncast Notification Server”.

d) Register the COM+ components of SyncNotigServer.dll in windows 2000 COM+ environment.

e) Make sure that ‘Leave running when idle’ in properties/advanced is checked.

19) Notification Agent (ALL SERVERS AND STATIONS) installation

a) Provide a computer terminal, such as an Intel-based Pentium III 550 Mhz computer, 256 Mbyte RAM, 40 Gigabyte Hard Disk, configured with the Microsoft Windows 2000 Server operating system

b) Initiate steps 2 through 5 on the computer terminal referenced in step 1 9a

c) Install the following files available from the respective folders created in step 19b above:

NtfAgent.dll

SmartLogger.dll

NotifyAgent.ini

CommAgent.xml

CommAgent.asp

Listener.asp

d) SOAP configuration

i) Run SoapVB.exe available from the respective folders created in step 19b above to reconfigure .xml and asp files.

ii) Create IIS virtual directory that points to folder named SyncSoap. For example: http://user/syncsoap

iii) Configure NotifyAgent.ini agent and server URLs.

e) COM+ installation

i) Add new COM+ application named “Syncast Notification Agent”.

ii) Register the COM+ components of NftAgent.dll in Windows 2000 COM+ environment.

iii) Make sure that ‘Leave running when idle’ in properties/advanced is checked.

20) ISAPI Listener Installation

a) Provide a computer terminal, such as an Intel-based Pentium III 550 Mhz computer, 256 Mbyte RAM, 40 Gigabyte Hard Disk, configured with the Microsoft Windows 2000 Server operating system

b) Initiate steps 2 through 5 on the computer terminal referenced in step 20a

c) SOAP files installation:

i) Copy these Soap files available from the respective folders created in step 20b above to a new folder “ISAPI” under “c:\syncast\soap”.

CommAgent.xml

CommAgent.sod

SynNtfListener.xml

SynNtfListener.sod

CommServer.xml

CommServer.sod

NotifServer.xml

OtifServer.sod

Soapisapi.dll

d) run SoapVB.exe available from the respective folders created in step 20b above to reconfigure .xml and sod files

e) IIS (WEB SERVER)

i) Start IIS manager

ii) Select SyncSoap->properties (right mouse button)

iii) Select Virtual directory tab press on ‘Configuration’ button.

iv) Select App Mapping tab and press the ‘Add’ button.

v) In Executable edit box, type: c:\syncast\syncsoap\isapi\soapisapi.dll or browse to the soapisapi.dll file.

vi) In Extension edit box type: .sod (note for the dot before sod)

vii) Select Verbs->Limit to and type POST in the edit box.

viii) Press OK then press Apply.

21) SES installation

a) Provide a computer terminal, such as an Intel-based Pentium III 550 Mhz computer, 256 Mbyte RAM, 40 Gigabyte Hard Disk, configured with the Microsoft Windows 2000 Server operating system

b) Initiate steps 2 through 5 on the computer terminal referenced in step 21 a

c) Install the following software on the computer terminal referenced in step 21a. All are available from the respective vendors mentioned.:

Microsoft IE version 5.5

Micrsoft MS XML 3.0

Microsoft MDAC version 2.6 or later

Oracle client version 8i

d) Run the SES installation file commercially available from IP Planet, 7 Rival Street, 6th floor, Tel Aviv, Israel and is available on appended CD labeled x of y

e) Install Syncdbar.dll available from the respective folders created in step 21b for remote access

f) Install Syncdba.dll available from the respective folders created in step 21b for local access.

g) Open c:\Syncast\ini\syncdef.ini add insert the path for the wizard files.

[PopPath]

IM=http://dblab/App/PopulateIM.asp

App=http://dblab/App/StartEditApp.asp

Prev=http://dblab/FrontEnd/html/Preview.asp

22) Syncast Database installation

a) Provide a computer terminal, such as an Intel-based Pentium III 550 Mhz computer, 512 Mbyte RAM, 40 Gigabyte Hard Disk, configured with the Microsoft Windows Advanced Server operating system

b) Install Oracle 8.1.6 by Oracle. Follow the default installation prompts as specified in the Oracle installation guide.

c) Syncast Database installation:

i) Run the following programs to create users the following respective users (Logs, Mnc, Syncapp and Syncast)

(1) Create_user_logs.sql

(2) Create_user_mnc

(3) Create_user_reports

(4) Create_user_syncast

(5) Create_user_syncapp

(6) create_tablespace.sql

(7) create_role_report.sql

(8) create_role_editor.sql

ii) Connect as logs and run:

(1) create_seq.sql

(2) create_all_tables

(3) create_all_packages

(4) Packages_grants

iii) Connect as Syncapp and run:

(1) srv_seq

(2) create_all_tables

(3) create₁₃ all_packages

(4) packages_grants

iv) Connect as Syncast and run:

(1) create_sequences

(2) create_all_tables

(3) create_all_packages

(4) Packages_grants

(5) tables_grants

v) run_all_data (data files)

A source code useful in implementing a preferred embodiment of the present invention can be derived from Appendix B (CD-ROMS 3 and 4) as follows:

Provide a computer terminal, such as an Intel-based Pentium III 550 Mhz computer, 256 Mbyte RAM, 40 Gigabyte Hard Disk, configured with the Microsoft Windows 2000 Server operating system;

1) Install Microsoft Visual Studio on the computer referenced in step 1

2) Unhex the computer listing 41655SR1.HEX on CD-Rom No. 3 using HEX IT V1.8 or greater by John Augustine, 3129 Earl St., Laureldale, Pa. 19605 creating file 41655SR1.ZIP;

3) Decompress the file 41655SR1.ZIP using WINZIP version 6.2 or greater, extracting all files into their respective directories utilizing the WINZIP version 6.2 option “Use folder names”.

4) Unhex the computer listing 41655SR2.HEX on CD-ROM No. 3 using HEX IT V1.8 or greater by John Augustine, 3129 Earl St., Laureldale, Pa. 19605 creating file 41655SR2.ZIP;

5) Decompress the file 41655SR2.ZIP using WINZIP version 6.2 or greater, extracting all files into their respective directories utilizing the WINZIP version 6.2 option “Use folder names”.

6) Unhex the computer listing 41655SR3.HEX on CD-ROM No. 4 using HEX IT V1.8 or greater by John Augustine, 3129 Earl St., Laureldale, Pa. 19605 creating file 41655SR2.ZIP;

7) Decompress the file 41655SR3.ZIP using WINZIP version 6.2 or greater, extracting all files into their respective directories utilizing the WINZIP version 6.2 option “Use folder names”.

8) Unhex the computer listing 41655SR4.HEX on CD-ROM No. 4 using HEX IT V1.8 or greater by John Augustine, 3129 Earl St., Laureldale, Pa. 19605 creating file 41655SR2.ZIP;

Decompress the file 41655SR4.ZIP using WINZIP version 6.2 or greater, extracting all files into their respective directories utilizing the WINZIP version 6.2 option “Use folder names”.

It is appreciated that the software components of the present invention may, if desired, be implemented in ROM (read-only memory) form. The software components may, generally, be implemented in hardware, if desired, using conventional techniques.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited to what has been particularly shown and described hereinabove. Rather, the scope of the present invention is defined only by the claims that follow:

1. A system for generating interactive television programs comprising:
an interactive item scheduler operative to generate an interactive item schedule for incorporation into at least one television program, the interactive item schedule comprising a first plurality of interactive items each associated with a time-stamp; and
an interactive television program integrator operative to incorporate said first plurality of interactive items into at least one television program in accordance with said schedule.

2. A system according to claim 1 wherein said interactive television program integrator is operative to receive, for each individual one of at least one television programs, an on-air signal indicating, in real-time, the time at which broadcast of the individual television program began.

3. A system according to claim 1 wherein said interactive television program integrator is also operative to receive, in advance of broadcast, from an external source, a playlist comprising a second plurality of television programs to be broadcast and to generate, off-line, an output instruction to a broadcasting facility describing how to incorporate said first plurality of interactive items into said second plurality of television programs in accordance with said schedule.

4. A system according to claim 3 and also comprising an interactive television GUI operative to generate a graphic display of the playlist and of a library of interactive items and to accept an editor-user's input associating an individual interactive item from the library with a temporal location on the playlist.

5. A system according to claim 4 wherein the graphic display also comprises a video window which, responsive to a user's indication of a temporal location on the playlist, presents a portion of a program associated with said temporal location.

6. A system according to claim 5 wherein the video window, responsive to an editor-user's input associating an individual interactive item from the library with a temporal location on the playlist, presents a portion of a program associated with said temporal location and, concurrently, the portion of the individual interactive item associated with said temporal location.

7. A system according to claim 1 wherein said interactive television program integrator is operative to display said first plurality of interactive items concurrently with a corresponding first plurality of portions of at least one television program in accordance with said schedule.

8. A system according to claim 7 wherein said interactive television program integrator is operative to superimpose at least one of said first plurality of interactive items onto at least one of the corresponding first plurality of portions of at least one television program in accordance with said schedule.

9. A system according to claim 1 wherein said interactive item scheduler comprises an interactive item generator operative to generate at least one interactive item for inclusion in the interactive item schedule.

10. A system according to claim 9 wherein said interactive item generator comprises a library of empty interactive item templates and a template filling user interface operative to accept, from an editor-user, interactive content to fill an editor-user-selected one of the interactive item templates.

11. A system according to claim 10 and also comprising a repository for filled interactive item templates thereby to enable an editor-user to fill templates off-line for real time incorporation into at least one television program.

12. A system according to claim 1 wherein at least one time-stamp for at least one individual interactive item comprises an absolute time for broadcast of the individual interactive item.

13. A system according to claim 1 wherein at least one time-stamp for at least one individual interactive item comprises a time for broadcast of the individual interactive item, relative to an on-air signal to be received which will indicate the time at which broadcast of an individual television program began.

14. A methodology for providing enhanced television type content to a plurality of disparate displays comprising:
providing television type content;
enhancing said television type content in a display-independent manner to provide enhanced display-independent interactive television type content; and
providing a plurality of display specific additions to said enhanced display-independent television type content.

15. A methodology for providing enhanced television type content to a plurality of disparate displays according to claim 14 and also comprising broadcasting said enhanced display-independent television type content with at least one display specific addition.

16. A methodology for providing enhanced television type content to a plurality of disparate displays according to claim 15 and also comprising:
receiving and displaying, at a given one of said plurality of disparate displays, said enhanced display-independent television type content with at least one display specific addition.

17. A system for authoring and broadcasting of interactive content, the system comprising:
creation of interactive content by non-programmers including at least one of the following editing functions:
drag-and-drop function for incorporation of interactive content into a program schedule;
wizard-based content creation for interactive content; and
editing-level synchronization with broadcasting events including a synchronization information display for the non-programmer interactive content creator.

18. Interactive content screen display apparatus comprising:
a first video area portion displaying a video broadcast;
a second interactive portion displaying interactive content selected by a viewer; and
a third pushed interrupt portion, which cannot be overridden by the viewer, displaying interrupting interactive content pushed by an interactive content provider,
and wherein the second interactive portion cannot be overridden by the interactive content provider.

19. A system for conveying interactive content to a plurality of user terminals having different characteristics, the system comprising:
an interactive content generator; and
a plurality of user-terminal specific compilers operative to compile interactive content generated by the interactive content generator so as to adapt said interactive content for use by a corresponding one of said user terminals,
thereby to provide interactive content generated by said interactive content generator to all of said plurality of user terminals despite their different characteristics.

20. A system according to claim 19 wherein the user terminals differ with respect to at least one of the following types of terminal characteristics:
user terminal operating system characteristics
user terminal output characteristics
user terminal input characteristics.

21. A system according to claim 19 wherein said interactive content generator comprises:
a library of templates, each template being operative to prompt a content editor to fill the template with specific content, thereby to generate a template instance comprising an action.

22. A system according to claim 21 wherein each template is operative to prompt the content editor to define a template instance trigger thereby to generate an assigned action.

23. An interactive content generation system comprising:
an interactive content template repository storing a plurality of templates for interactive content items; and
a template filling interface allowing a user to select, view and fill in a template from among said plurality of templates.
